(19) United States
(12) Patent Application Publication
(10) Pub. No.: US 2009/0095322 A1
(43) Pub. Date: Apr. 16, 2009

(54) Container cleaning device, container cleaning method, and tank

(76) Inventors: Yoshitaka Wakao, Aichi (JP); Masashi Murate, Aichi (JP)

Correspondence Address: KENYON & KENYON LLP, 1500 K STREET N.W., SUITE 700, WASHINGTON, DC, 20005, US

(21) Appl. No.: 11/919,905

(22) PCT Filed: Apr. 18, 2006
(86) PCT No.: PCT/JP2006/308491

§ 371 Date: Nov. 5, 2007

(30) Foreign Application Priority Data
May 13, 2005 (JP) 2005-140874
May 13, 2005 (JP) 2005-141261
May 23, 2005 (JP) 2005-149777

(51) Int. Cl. B08B 9/093; B08B 9/42

(52) U.S. Cl. 134/8; 134/167 R; 134/144; 134/95.2; 134/22.18; 134/58 R; 134/135; 134/22.1

(57) ABSTRACT

A cleaning device and a cleaning method for a container capable of continuously performing a cleaning treatment, and a tank. The cleaning device includes a jetting member which jets a fluid in the container; a movement unit which relatively moves the jetting member along an axial direction of the container with respect to the container so that the jetting member is inserted into the container from a mouth part of the container; and a switching unit which switches the jetting member from one function to another function. The switching unit switches a nozzle for a cleaning liquid, a nozzle for blowing and a nozzle for drying in order.

### TECHNICAL FIELD

The present invention relates to a cleaning device and a cleaning method for a container for cleaning the inside of a container such as a tank, and a tank.

### BACKGROUND ART

Heretofore, as a cleaning device for a container having a mouth part, a device has broadly been known in which an inner wall of the container is cleaned with a cleaning liquid and compressed air jetted from nozzles (e.g., see Patent Documents 1 to 7). In a cleaning device disclosed in Patent Document 1 in which the container is a gas tank, the mouth part of the gas tank is directed downwards, and a nozzle for cleaning is manually inserted into the gas tank from the mouth part thereof. After the cleaning liquid is jetted from the nozzle for cleaning, a nitrogen gas is injected into the gas tank to dry the inside of the gas tank. The nozzle that performs cleaning and drying treatments in this manner is formed into a cylindrical shape having a constant diameter from a tip end side to a base portion side thereof.

[Patent Document 1] Japanese Patent Application Laid-Open No. 9-38611 (Page 3)

[Patent Document 2] Japanese Patent Application Laid-Open No. 5-138139

[Patent Document 3] Japanese Patent Application Laid-Open No. 2003-366039

[Patent Document 4] Japanese Patent Application Laid-Open No. 9-248537

[Patent Document 5] Japanese Patent Application Laid-Open No. 6-7758

[Patent Document 6] Japanese Patent Application Laid-Open No. 2003-181404

[Patent Document 7] Japanese Patent Application Laid-Open No. 7-16554 (Page 2 and FIG. 1)

### DISCLOSURE OF THE INVENTION

In such a conventional cleaning device, insertion of a nozzle for cleaning into a gas tank and injection of a nitrogen gas for drying are performed with a manual operation. Therefore, it has been difficult to continuously perform a series of treatments.

Moreover, in a case where a container is an FRP-made tank or the like, a mouth part of the container is sometimes provided with an annular protruding portion which protrudes so as to turn back into the container. However, in the conventional cleaning device, the container having this type of protruding portion is not considered. Therefore, for example, in the cleaning device disclosed in Patent Document 1, cleaning waste water resides so as to surround the protruding portion, and jetting from the nozzle for cleaning to this portion might be hampered. Therefore, an operation of removing the cleaning waste water from the gas tank is required, and a series of treatments are not easily continuously performed.

Furthermore, in a shape of a container such as the gas tank having a diameter of the mouth part smaller than that of a trunk portion of a container main body, even if the nozzle is inserted into the container, a comparatively large distance is provided between an inner surface of the trunk portion and the nozzle. Therefore, even if a cleaning liquid or a drying gas is jetted from the nozzle, these fluids do not reach the inner surface of the trunk portion, cleaning and drying are insufficiently performed, and the operation thus easily becomes complicated.

Moreover, the nozzle of the cleaning device described in Patent Document 7 jets one fluid, that is, the cleaning liquid or air in only one direction regardless of a positional relation between the nozzle and the inside of the container. Therefore, a dead angle is sometimes formed which is not reached by the fluid jetted from the nozzle, depending on a shape of the inside of the container. In consequence, a cleaning unevenness, a draining unevenness and the like are caused, a drying time is lengthened, and efficiency of a series of treatments thus deteriorates.

An object of the present invention is to provide a cleaning device and a cleaning method for a container capable of continuously performing treatments of the container, and a tank.

Moreover, another object of the present invention is to provide a cleaning device and a cleaning method for a container capable of appropriately treating the inside of the container.

To achieve the above object, a cleaning device for a container according to a first aspect of the present invention comprises a jetting member which jets a fluid in the container; a movement unit which moves the jetting member with respect to the container so that the jetting member is inserted into the container from a mouth part of the container; and a switching unit which switches from the jetting member from one function to another function.

According to this constitution, the movement unit can move the jetting member with respect to the container to insert the jetting member into the container. When the switching unit switches from one function to another function, for example, a fluid different from the first jetted fluid can be jetted into the container. In consequence, the treatment of the inside of the container can continuously be performed.

Preferably, the jetting member has a first nozzle which jets a first fluid and a second nozzle which jets a second fluid, and the switching unit switches from the first nozzle to the second nozzle to switch to another function.

According to this constitution, since two nozzles are independently separated, the fluid suitable for the treatment can be jetted. The two nozzles can be switched to easily switch to another function.

More preferably, the switching unit serves as a part of the movement unit. The unit extracts the first nozzle from the mouth part of the container, and then inserts the second nozzle into the container from the mouth part of the container to switch from the function to the other function.

According to this constitution, either the first nozzle or the second nozzle is inserted into the container during the treatment. In consequence, diameters of the first and second nozzles can comparatively be enlarged, and the fluid suitable for the treatment can be jetted. One of the first and second nozzles can avoid an influence of the fluid jetted from the other nozzle of the first and second nozzles.

Preferably, the first nozzle is one of a nozzle for a cleaning fluid which jets the cleaning fluid, a nozzle for removing the cleaning fluid which jets a fluid to remove the cleaning fluid from an inner wall of the container and a nozzle for drying which jets hot air to dry the inner wall of the container.

According to this constitution, with the nozzle for the cleaning fluid, dirt and the like of the inner wall of the container can be removed. With the nozzle for removing the cleaning fluid, if the cleaning fluid is, for example, a liquid, the inner wall of the container is drained. With the nozzle for drying, if the cleaning fluid is, for example, the liquid, moisture and water content are removed from the inner wall of the container.

Alternatively, it is preferable that the jetting member further has a third nozzle which jets a third fluid, the switching unit switches the first nozzle, the second nozzle and the third nozzle in order during the cleaning treatment of the container (during a series of treatments of the container), the first nozzle is a nozzle for a cleaning fluid which jets the cleaning fluid, the second nozzle is a nozzle for removing the cleaning fluid which jets a fluid to remove the cleaning fluid from an inner wall of the container, and the third nozzle is a nozzle for drying which jets hot air to dry the inner wall of the container.

According to this constitution, the cleaning of the inner wall of the container, for example, the draining of the inner wall of the container and the drying of the inner wall of the container can continuously be performed in order.

Preferably, nozzles or jetting ports which jet fluids different from each other to the inner wall of the container may relatively be moved with respect to the inner wall by a common movement unit. In consequence, the whole constitution can be simplified.

Moreover, from another viewpoint, according to a preferable mode of the present invention, the jetting member may comprise a single nozzle which jets a plurality of types of fluids, and the switching unit may switch the type of the fluid to be jetted from the nozzle to switch other function.

According to this constitution, the fluid which flows through the nozzle can be switched to switch from the jetting member having the function to the jetting member having the other function. Since the jetting member comprises the single nozzle, the number of components can be reduced.

In this case, it is preferable that the plurality of types of fluids include at least one of a cleaning fluid, a fluid to remove the cleaning fluid from the inner wall of the container, and hot air to dry the inside of the container.

Moreover, from still another viewpoint, according to a preferable mode of the present invention, the jetting member is configured to jet at least one fluid of a cleaning fluid and hot air, and the cleaning device for the container may further comprise a regulation unit which regulates a temperature of the at least one fluid in accordance with a characteristic of a material of an inner wall of the container.

According to this constitution, for example, in a case where the container is made of a resin, a high-temperature gas can be avoided as a fluid to be jetted to inhibit deterioration of the inner wall of the container. For example, when the cleaning fluid is set at a predetermined temperature, the inner wall of the container can be preheated while being cleaned. Therefore, a subsequent drying time can be reduced.

To achieve the above object, a cleaning device for a container of a second aspect of the present invention is a cleaning device for a container in which the container including a protruding portion provided at a mouth part of the container and protruding into the container is cleaned, comprising: a support unit to support the container in a state in which the mouth part is opened downwards and in which an axial direction of the container is tilted from a vertical direction; a rotation unit which rotates the container supported by the support unit around an axis of the container; and a jetting member which is inserted into the container from the mouth part and which jets a fluid in the container in synchronization with the rotation unit.

According to this constitution, the container is tilted. Therefore, in a case where the fluid jetted in the container is a liquid, the liquid might reside between the protruding portion and the inner wall of the container in a concentrated manner. In this case, the jetting member can directly jet the fluid to a portion of the container where the liquid does not reside. Since the rotation unit rotates the container, a portion where the liquid resides can be moved. In consequence, the jetting member can evenly jet the fluid in the container. Even the container provided with the protruding portion in this manner can appropriately be treated, and a series of treatments can continuously be performed without positively performing an operation of removing a waste liquid from the container. It is to be noted that it is preferable that the support unit supports the container so as to open the mouth part obliquely downwards.

Preferably, the cleaning device for the container further comprises a movement unit which relatively moves the jetting member along the axial direction of the container with respect to the container supported by the support unit.

According to this constitution, the movement unit can insert the jetting member into the container from the mouth part of the container. For example, the movement unit may relatively move the jetting member with respect to the container during the treatment.

Preferably, it is preferable that the jetting member includes at least one of a nozzle for a cleaning fluid which jets the cleaning fluid, a nozzle for removing the cleaning fluid which jets a fluid to remove the cleaning fluid from an inner wall of the container and a nozzle for drying which jets hot air to dry the inner wall of the container. In this case, it is preferable that the cleaning device for the container further comprises a switching unit which switches the nozzle for the cleaning fluid, the nozzle for removing the cleaning fluid and the nozzle for drying in order during a cleaning treatment of the container (during a series of treatments of the container).

According to these constitutions, cleaning of the inner wall of the container, for example, draining of the inner wall of the container and drying of the inner wall of the container can continuously be performed in order.

To achieve the above object, a cleaning device for a container of a third aspect of the present invention comprises a jetting member which is inserted into a container from a mouth part of the container and which jets a fluid in the container; and a regulation unit which regulates a temperature of the fluid in accordance with a characteristic of a material of the container.

According to this constitution, for example, in a case where the container is made of a resin, a high-temperature gas can be avoided as a fluid to be jetted to inhibit deterioration of the container. In consequence, the treatment suitable for the characteristic of the material of the container can be performed.

To achieve the above object, a cleaning method for a container according to the first aspect of the present invention comprises a first jetting step of jetting a first fluid from the jetting member inserted into the container from a mouth part of the container; a switching step of driving a switching unit after the first jetting step to change a fluid to be jetted from the jetting member to a second fluid; and a second jetting step of jetting the second fluid from the jetting member after the switching step.

In consequence, after jetting the first fluid in the container, the jetting member prepared for the jetting of the second fluid by driving the switching unit successively jets the second fluid in the container. Therefore, the inside of the container can continuously be treated.

Preferably, the jetting member has separate nozzles for use in the first jetting step and the second jetting step, respectively.

According to this constitution, the fluids suitable for the first and second jetting steps can be jetted.

To achieve the above object, according to a second aspect of the present invention, a cleaning method for a container including a protruding portion provided at a mouth part of the container. The protruding portion protrudes into the container. The method comprises a rotation step of rotating the container in an axial direction of the container in a tilt state in which the mouth part is opened downwards; and a jetting step of jetting a fluid from a jetting member inserted into the container during the rotation step.

In consequence, in the same manner as in the cleaning device for the container according to the present invention described above, even when the fluid jetted into the container is a liquid, the liquid which might reside between the protruding portion and the inner wall of the container successively moves by the rotation of the container. In consequence, the jetting member can jet the fluid into the container without any unevenness, and the treatment can continuously be performed. It is to be noted that it is preferable that the tilt state of the container is a state in which the mouth part opens obliquely downwards.

Preferably, the jetting step is performed while moving positions of jetting ports of the jetting member along the axial direction.

Preferably, the jetting step has a cleaning step in which a cleaning liquid is used as the fluid to be jetted by the jetting member, and a spraying step in which a gas is used as the fluid to be jetted by the jetting member after the cleaning step.

To achieve the above object, a tank of the present invention is cleaned using the cleaning method for the container of the present invention described above.

According to this constitution, since the tank can continuously be treated, a throughput of the tank can be improved.

To achieve the other object, a cleaning device for a container of a fourth aspect of the present invention is a cleaning device for a container, comprising: a treatment member which performs a predetermined treatment in the container, the treatment member being inserted into the container from a mouth part of the container and configured to perform the predetermined treatment in accordance with a shape of the inside of the container.

According to this constitution, since the treatment member performs the predetermined treatment in accordance with the shape of the inside of the container, the inside of the container can appropriately be treated.

Here, examples of a mode of such a treatment member roughly include the following two modes. That is, according to the first mode, the treatment member is constituted to be deformed between a first state in which the treatment member is a structure having a diameter smaller than that of the mouth part of the container and a second state in which the treatment member is a structure having a diameter larger than that of the mouth part of the container, and performs the predetermined treatment in the container. According to the second mode, it is preferable that the cleaning device for the container further comprises changing means for changing a jetting directivity of the fluid in accordance with a position of the jetting member in an axial direction of the container. Details of these two modes will be described hereinafter as a cleaning device for a container according to fifth and sixth aspects of the present invention.

To achieve the other object, a cleaning device for a container according to the fifth aspect of the present invention is a cleaning device for a container, comprising: a treatment member which is inserted into the container from a mouth part of the container and which performs a predetermined treatment in the container, the treatment member being configured to be deformed between a first state in which the treatment member is a structure having a diameter smaller than that of the mouth part of the container and a second state in which the treatment member is a structure having a diameter larger than that of the mouth part of the container, and performs the predetermined treatment in the container.

According to this constitution, when the treatment member is brought into the first state, the treatment member can be inserted into the container from the mouth part of the container. When the treatment member is brought into the second state in the container, the diameter of the treatment member can be set to be larger than the first state (the diameter of the mouth part of the container). In consequence, the treatment member can perform the predetermined treatment close to an inner surface of the container, the inside of the container can appropriately be treated, and operability of the device can be improved.

Preferably, the diameter of the mouth part of the container is smaller than that of a container main body constituting the inside of the container. Examples of this type of container include a tank for a fuel gas mounted on a fuel power system.

Preferably, the treatment member has an operating section which performs the predetermined treatment of an inner surface of the container, and the treatment member is deformed so that the operating section comes close to the inner surface of the container in the second state.

According to this constitution, since the operating section can come close to the inner surface of the container, a treatment function of the operating section with respect to the inner surface of the container can be improved.

Moreover, from another viewpoint, according to a preferable mode of the present invention, the treatment member may have an operating section which performs the predetermined treatment of an inner surface of the container; and a base portion which movably supports the operating section, and the treatment member may be deformed between the first state and the second state in a case where the operating section is movably supported on the base portion as a support point.

Preferably, the operating section is constituted so that a position of the operating section in a diametric direction of the container main body constituting the inside of the container or a diametric direction of the mouth part of the container is regulated.

According to this constitution, the position of the operating section can be regulated in accordance with a shape of the container. In consequence, a distance between the operating section and the inner surface of the container can be set to a desired distance in accordance with a characteristic of the treatment performed by the operating section, and an operation efficiency of the treatment member can be improved.

Preferably, the predetermined treatment is at least one of a cleaning treatment of jetting a fluid for cleaning in the container, a blowing treatment of jetting a fluid for blowing in the container, a drying treatment of jetting a fluid for drying in the container, a wiping treatment of wiping the inner surface of the container, a permeation inhibiting treatment of spraying a gas permeation inhibitor to the inner surface of the container, and a suction treatment of sucking residuals from the container.

According to this constitution, various types of jetted fluid such as a fluid for cleaning, a fluid for blowing and a fluid for drying can be allowed to collide with the inner surface of the container, and the cleaning treatment, the blowing treatment or the drying treatment can appropriately be performed. For example, when the permeation inhibiting treatment is performed, permeation of a gas from the container can be inhibited. This permeation inhibiting treatment is especially preferable for a container made of a resin, and this treatment can be performed by the cleaning device for the container.

Preferably, the cleaning device for the container further comprises a suction mechanism which is connected to the treatment member to perform the wiping treatment and which applies a suction force to the treatment member.

According to this constitution, for example, while wiping off the liquid of the inner surface of the container with the treatment member, the wiped liquid can be sucked as required. In consequence, without changing the treatment member, the inner surface of the container can continuously be wiped.

Preferably, the treatment member which performs the cleaning treatment, the blowing treatment or the drying treatment has a jetting direction of the fluid which tilts below a plane crossing the axial direction of the container at right angles.

According to this constitution, since the jetted fluid can form a spiral flow, a function of a treatment such as the cleaning treatment can be improved.

Preferably, the treatment member which performs the suction treatment is configured to suck the residuals along the inner surface of the container. More preferably, the inner surface of the container is an inner surface of at least one of opposite end portions of the container.

According to these constitutions, since the treatment member sucks the residuals along the inner surface of the container, the residuals can securely be removed from the container.

Preferably, the cleaning device for the container further comprises a movement mechanism which relatively moves the treatment member with respect to the container in the axial direction of the container. Preferably, the cleaning device for the container may further comprise a rotation mechanism which relatively rotates the treatment member with respect to the container around an axis of the container, and further comprise a support mechanism to support the container in a state in which the mouth part of the container is opened downwards.

According to these constitutions, for example, the movement mechanism can insert the treatment member into the container from the mouth part of the container, or relatively move the treatment member with respect to the container during the predetermined treatment. According to the support mechanism, for example, when the fluid for use in the treatment member is a liquid, the used liquid can be discharged from the mouth part of the container by use of gravity.

To achieve the above object, a cleaning method for a container according to the third aspect of the present invention uses a treatment member having an operating section to perform a predetermined treatment of an inner surface of the container. The method includes an insertion step of inserting the treatment member provided with the folded operating section into the container from a mouth part of the container; an expansion step of expanding the operating section after the insertion step; and a treatment step of allowing the operating section to perform the predetermined treatment of the inner surface of the container after the expansion step.

According to this method, the treatment member provided with the folded operating section is inserted into the container from the mouth part of the container, and then the operating section is expanded before start of the treatment. Since the operating section is expanded, the predetermined treatment can be performed by the operating section close to the inner surface of the container. In consequence, operability of the treatment of the inner surface of the container can be improved.

Preferably, the expansion step is performed by expanding the operating section so that the operating section comes close to the inner surface of the container.

In consequence, since the operating section is allowed to come close to the inner surface of the container, the treatment function of the operating section with respect to the inner surface of the container can further be improved.

Preferably, the predetermined treatment is at least one of a cleaning treatment of jetting a fluid for cleaning in the container, a blowing treatment of jetting a fluid for blowing in the container, a drying treatment of jetting a fluid for drying in the container, a wiping treatment of wiping the inner surface of the container, a permeation inhibiting treatment of spraying a gas permeation inhibitor to the inner surface of the container and a suction treatment of sucking residuals from the container.

Preferably, the treatment step performs the predetermined treatment including at least the cleaning treatment, the drying treatment and the permeation inhibiting treatment in order.

In consequence, after cleaning and drying the inside of the container, the gas permeation inhibitor is sprayed to the inner surface of the container. Since the permeation inhibiting treatment is continuously performed subsequently to the cleaning and drying of the container, equipments and steps can be simplified.

Moreover, from another viewpoint of the present invention, the treatment step may simultaneously perform the blowing treatment and the suction treatment.

In consequence, matters attached to the inside of the container, blown off by the blowing treatment, are sucked as required. In consequence, a tact time required for a series of treatments with respect to the container can be reduced.

To achieve the other object, a cleaning device for a container according to a sixth aspect of the present invention is a cleaning device for a container in which a fluid is jetted to clean the inside of the container, comprising a jetting member which is inserted into the container from a mouth part of the container and which jets the fluid in the container; and changing means for changing a jetting directivity of the fluid in accordance with a position of the jetting member in an axial direction of the container.

According to this constitution, in consideration of the position of the jetting member in the container, a direction in which the fluid is jetted by the jetting member can be changed. In consequence, the inside of the container can evenly be cleaned without generating any dead angle in the container.

Preferably, the fluid to be jetted by the jetting member is at least one of a fluid for cleaning, a fluid for blowing and a fluid for drying.

According to this constitution, a cleaning unevenness in the container can be suppressed with a cleaning fluid such as a cleaning liquid and, for example, a draining unevenness in the container can be suppressed with a blowing fluid such as a compressed gas. A drying unevenness can be suppressed and a drying time can be reduced with a drying fluid such as hot air.

Preferably, the changing means has an actuator which changes the jetting directivity with respect to the jetting member.

According to this constitution, the jetting directivity can appropriately be changed by driving the actuator.

More preferably, the changing means has detection means for detecting a position of the jetting member in the axial direction of the container, and the actuator sets an operation amount based on a detection result of the detection means.

According to this constitution, since the actuator sets the operation amount based on the detection result of the position of the jetting member, the jetting directivity can further appropriately be changed.

Preferably, the jetting member has at least two jetting ports having different jetting directivities, and the actuator switches the at least two jetting ports to change the jetting directivity.

According to this constitution, the jetting directivity can be changed with a simple constitution of the switching of the jetting ports. The jetting member itself does not have to be moved in a direction other than the axial direction.

From another viewpoint of the present invention, the cleaning device for the container further comprises supplying means for supplying the fluid to the jetting member, and the changing means may have switching means which is incorporated in the jetting member and which switches the jetting directivity in accordance with a pressure of the fluid to be supplied by the supplying means.

According to this constitution, the pressure of the fluid to be supplied to the jetting member can be regulated to appropriately change the jetting directivity by the switching means incorporated in the jetting member.

From another viewpoint of the present invention, the changing means may have a contact portion which comes in contact with an end portion of the inside of the container; and switching means which is incorporated in the jetting member and which brings the contact portion into contact with the end portion of the inside of the container to switch the jetting directivity.

According to this constitution, when the contact portion is brought into contact with the end portion of the inside of the container, the jetting directivity can appropriately be changed by the switching means. That is, the jetting directivity can mechanically and structurally be changed appropriately.

In this case, it is preferable that the jetting member has at least two jetting ports having different jetting directivities and that the switching means switches the at least two jetting ports to switch the jetting directivity.

According to this constitution, the jetting directivity can be changed with a simple constitution of the switching of the jetting ports in the same manner as described above.

Moreover, from still another viewpoint of the present invention, the jetting member may have at least two jetting ports having different jetting directivities, and at least two channels which supply the fluids to the at least two jetting ports, respectively, independently of each other, and the changing means may have switching means for switching the at least two channels in accordance with a position of the jetting member in the axial direction of the container.

According to this constitution, the channel to supply the fluid can be switched by the switching means to switch the jetting ports. In consequence, the jetting directivity of the jetting member can appropriately be changed.

Preferably, the at least two jetting ports are formed on at least a tip end surface of the jetting member and a peripheral surface of a tip end portion of the jetting member.

According to this constitution, the jetting ports having different jetting directivities can easily be formed, and the jetting ports can be formed in the vicinity of each other.

Furthermore, from a further viewpoint, the changing means may have detection means for detecting a position of the jetting member in the axial direction of the container; and switching means for switching the jetting directivity based on a detection result of the detection means.

According to this constitution, since the switching means switches the jetting directivity based on the detection result of the position of the jetting member, the jetting directivity can appropriately be changed.

Preferably, the changing means changes the jetting directivity so that the jetting member has different jetting directivities in a case where the jetting member is positioned close to at least one of opposite end portions of the container and a case where the jetting member is positioned close to a trunk portion of the container.

For example, when the container has a tank shape, the opposite end portions of the container have a spherical shape. According to the above constitution, the jetting member can appropriately jet the fluid from not only the trunk portion but also the spherical end portion of the container.

Preferably, the cleaning device for the container further comprises support means for setting the container in a state in which the mouth part of the container is directed downwards, the changing means changes the jetting directivity to an upward directivity in a case where the jetting member is opposed to a position of an upper end portion of the container, and the changing means changes the jetting directivity to a directivity in a horizontal direction or slightly below the horizontal direction in a case where the jetting member is opposed to a position of the trunk portion.

According to this constitution, since the mouth part of the container is directed downwards, for example, the jetted cleaning liquid and the like can appropriately be discharged from the mouth part of the container during the cleaning treatment. The jetting directivity can be set in accordance with the position of the jetting member (the position of the upper end portion and the position of the trunk portion) in the container.

Preferably, the device further comprises movement means for relatively moving the jetting member with respect to the container along the axial direction of the container.

According to this constitution, the jetting member can be inserted into the container from the mouth part of the container. While relatively moving the jetting member in the container, the fluid can be jetted in the container.

To achieve the above object, a cleaning method for a container of the fourth aspect of the present invention jets a fluid to clean the inside of the container. The method includes an insertion step of inserting a jetting member into the container from a mouth part of the container; and a jetting step of jetting the fluid from the jetting member in the container after the insertion step, the jetting step being performed while changing a jetting directivity of the fluid in accordance with a position of the jetting member in an axial direction of the container.

In consequence, in consideration of the position of the jetting member in the container, a direction in which the fluid is jetted by the jetting member can be changed. Therefore, the inside of the container can evenly be cleaned without generating any dead angle in the container.

Preferably, the fluid to be jetted by the jetting member is at least one of a fluid for cleaning, a fluid for blowing and a fluid for drying.

The cleaning device for the container according to the first to sixth aspects of the present invention described above is preferable in the following container.

That is, preferably the mouth part of the container is formed in at least one end portion of the container in the axial direction. Preferably, the mouth part of the container is defined by a mouthpiece. Preferably, the container has a resin liner and a reinforcing layer provided on an outer periphery of the resin liner. Preferably, the container has a trunk portion which extends in the axial direction of the container and a pair of end wall portions which extend from opposite end portions of the trunk portion in the axial direction and whose diameters are reduced as compared with the trunk portion. Preferably, the container is a tank in which a combustible gas having a high pressure is stored. It is preferable that the combustible gas is a hydrogen gas or a compressed natural gas.

### BRIEF DESCRIPTION OF THE DRAWINGS

FIG. 1 is a sectional view showing a constitution of a container according to a first embodiment;

FIG. 2 is a system diagram schematically showing a cleaning device for the container according to the first embodiment;

FIG. 3 is a front view of a part of FIG. 2 and is a diagram showing a relation between three nozzles and the container and jetting directivities;

FIG. 4 is a system diagram schematically showing a cleaning device for a container according to a second embodiment;

FIG. 5 is a sectional view showing a constitution of a container according to a third embodiment;

FIG. 6 is a system diagram schematically showing a cleaning device for the container according to the third embodiment;

FIG. 7 is a sectional view schematically showing a relation between a protruding portion of the container and a cleaning liquid in a case where the container is cleaned with the cleaning device for the container according to the third embodiment;

FIG. 8 is a diagram similar to FIG. 7, and is a sectional view schematically showing a relation between a protruding portion of a container and a cleaning liquid in a case where the container is cleaned with a cleaning device of a comparative example;

FIG. 9 is a system diagram schematically showing a cleaning device according to a fourth embodiment;

FIG. 10 is a front view of a part of FIG. 9, and is a diagram showing three treatment members and a container;

FIG. 11 is a flow chart showing a series of treatments to be performed by the cleaning device according to the fourth embodiment;

FIG. 12 is a sectional view showing a relation between a sponge unit and the container according to the fourth embodiment;

FIG. 13 is a sectional view showing a relation between the sponge unit and the container according to the fourth embodiment;

FIG. 14 is a partially enlarged sectional view of the sponge unit shown in FIGS. 12 and 13;

FIG. 15 is a system diagram showing a relation between a nozzle for a cleaning treatment and a container according to a fifth embodiment,

FIG. 16 is a perspective plan view of FIG. 15;

FIG. 17 is a diagram showing jetting directivities of nozzles for a trunk portion of the container according to the fifth embodiment, (A) is a sectional front view, and (B) is a sectional view as viewed from an arrow direction of (A);

FIG. 18 is a diagram showing opening and closing (deformations) of the nozzles according to the fifth embodiment, (A) is a diagram showing a first state in which the nozzles are folded, and (B) is a diagram showing a second state in which the nozzles are expanded;

FIG. 19 is a sectional view showing a relation between a nozzle for a drying treatment and a container according to a sixth embodiment;

FIG. 20 is a perspective plan view of FIG. 19;

FIG. 21 is a diagram showing opening and closing (deformations) of nozzles according to the sixth embodiment, (A) is a diagram showing a first state in which the nozzles are folded, and (B) is a diagram showing a second state in which the nozzles are expanded;

FIG. 22 is a sectional view showing a relation between a spray mechanism for a permeation inhibiting treatment and a container according to a seventh embodiment;

FIG. 23 is a flow chart showing a series of treatments to be performed by a cleaning device according to the seventh embodiment;

FIG. 24 is a diagram showing a draining nozzle for a blowing treatment and a suction nozzle for a suction treatment according to an eighth embodiment, (A) is a side view, and (B) is a sectional view viewed from an arrow direction of (A);

FIG. 25 is a diagram showing a state in which a draining nozzle and a suction nozzle are inserted into a container according to the eighth embodiment, and a flow diagram showing a procedure of a blowing treatment and the suction treatment;

FIG. 26 is a flow diagram subsequent to FIG. 25, and is a diagram showing a state in which the suction nozzle is expanded;

FIG. 27 is a flow diagram subsequent to FIG. 26, and is a diagram showing a state in which a suction port is positioned at a lowermost portion of the container;

FIG. 28 is a flow diagram subsequent to FIG. 27, and is a diagram showing a state in which the draining nozzle is moved in an extraction direction;

FIG. 29 is a flow diagram subsequent to FIG. 28, and is a diagram showing a state in which the draining nozzle reaches a lower end wall portion of the container;

FIG. 30 is a flow diagram subsequent to FIG. 29, and is a diagram showing a final procedure of a blowing treatment and a suction treatment;

FIG. 31 is a diagram showing a suction nozzle for a suction treatment according to a ninth embodiment, (A) is a side view, and (B) is a sectional view viewed from an arrow direction of (A);

FIG. 32 is a system diagram schematically showing a cleaning device for a container according to a tenth embodiment;

FIG. 33 is a diagram showing a jetting directivity in a positional relation between a jetting member and the container according to the tenth embodiment, (A) is a diagram showing the jetting directivity with respect to an upper end wall portion of the container, and (B) is a diagram schematically showing the jetting directivity with respect to a trunk portion or a lower end wall portion of the container;

FIG. 34 is a sectional view showing a constitution of the jetting member according to the tenth embodiment, (A) is a diagram showing the jetting directivity with respect to the upper end wall portion of the container, and (B) is a diagram showing the jetting directivity with respect to the trunk portion or the lower end wall portion of the container;

FIG. 35 is a sectional view showing a constitution of a jetting member according to an eleventh embodiment, (A) is a diagram showing a jetting directivity with respect to an upper end wall portion of a container, and (B) is a diagram showing a jetting directivity with respect to a trunk portion or a lower end wall portion of the container;

FIG. 36 is a sectional view showing a constitution of a jetting member according to a twelfth embodiment, (A) is a diagram showing a jetting directivity with respect to an upper end wall portion of a container, and (B) is a diagram showing a jetting directivity with respect to a trunk portion or a lower end wall portion of the container;

FIG. 37 is a system diagram schematically and mainly showing a blowing mechanism of a cleaning device for a container according to a thirteenth embodiment;

FIG. 37A is an enlarged sectional view of a jetting section of a nozzle;

FIG. 38 is a diagram showing a jetting directivity of a jetting member in a positional relation between the jetting member and the container according to the thirteenth embodiment, (A) is a diagram schematically showing a jetting directivity with respect to an upper end wall portion of the container, (B) is a diagram schematically showing a jetting directivity with respect to a trunk portion of the container, and (C) is a diagram schematically showing a jetting directivity with respect to a lower end wall portion of the container; and

FIG. 39 is a sectional view schematically showing a suction mechanism of a cleaning device for a container according to a fourteenth embodiment.

### BEST MODE FOR CARRYING OUT THE INVENTION

A cleaning device and a cleaning method for a container according to preferable embodiments of the present invention will hereinafter be described with reference to accompanying drawings. This cleaning device cleans the inside of a tank-like container having a mouth part, and a cleaning treatment (e.g., cleaning, draining and drying) can continuously be performed. First, a structure of the container will briefly be described hereinafter, and the cleaning device will then be described in detail. In second and subsequent embodiments, a constitution common to that of a first embodiment will be denoted with the same reference numerals as those of the first embodiment, and detailed description thereof is omitted.

### First Embodiment

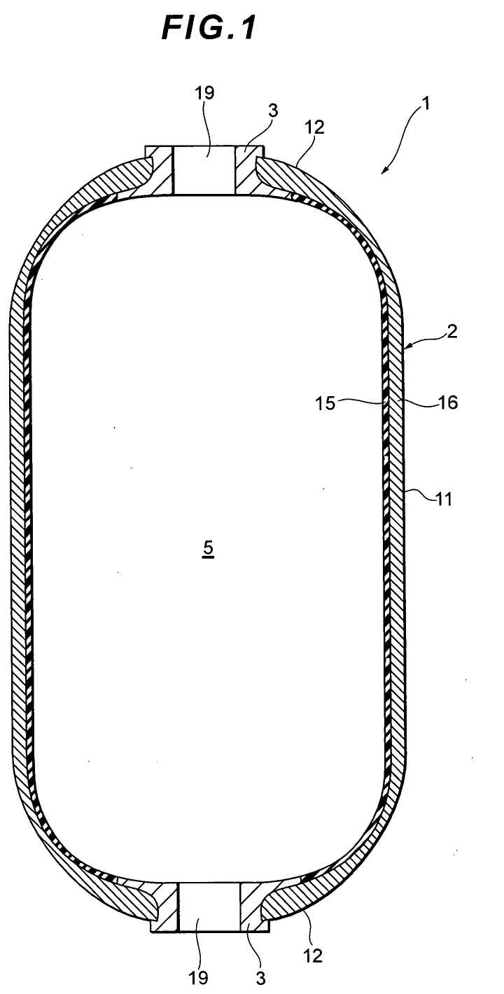

As shown in FIG. 1, a container 1 includes a container main body 2 having a hermetically closed cylindrical shape as a whole, and mouthpieces 3 attached to opposite end portions of the container main body 2 in a longitudinal direction. The inside of the container main body 2 (i.e., an inner part of the container) constitutes a storage space 5 to store various types of fluids such as a gas and a liquid. The container 1 may be filled with a normal-pressure fluid, and may be filled with a fluid having a pressure raised as compared with normal pressure. That is, the container 1 can function as a high-pressure tank.

For example, in a fuel cell system, a pressure of a fuel gas prepared in a high-pressure state is reduced to use the gas in power generation of a fuel cell. The gas container 1 may be applied to storage of a high-pressure combustible fuel gas, and a hydrogen gas, a compressed natural gas (a CNG gas) or the like as the fuel gas may be stored. A pressure of the hydrogen gas stored in the gas container 1 is, for example, 35 MPa or 70 MPa, and a pressure of the CNG gas is, for example, 20 MPa. The container 1 having a tank shape in which the hydrogen gas is stored under the high pressure will hereinafter be described as an example.

The container main body 2 includes a trunk portion 11 substantially having a constant diameter in an axial direction of the main body, and a pair of end wall portions 12, 12 having a diameter reduced as compared with that of the trunk portion 11. The container main body 2 has, for example, a two-layer structure, and the two-layer structure includes a resin liner 15 (an inner shell) having a gas barrier property and a reinforcing layer 16 (an outer shell) arranged on an outer periphery of the liner 15.

The liner 15 is made of a hard resin such as polyethylene, and the liner 15 mainly constitutes an inner wall of the container 1. The reinforcing layer 16 is made of, for example, FRP including a carbon fiber and an epoxy fiber, and this layer is wound so as to cover an outer surface of the liner 15. It is to be noted that the container main body 2 itself may be made of a metal such as an aluminum alloy, the liner 15 may be made of a metal such as aluminum, and the reinforcing layer 16 may be made of a resin.

Each mouthpiece 3 is made of a metal such as stainless steel. The mouthpiece 3 is provided at the center of a semi-spherical end wall portion 12. The mouthpiece 3 has an opening 19 having a diameter (an inner diameter) smaller than an inner diameter of the trunk portion 11, and this opening 19 functions as a mouth part of the container 1, and allows the inside of the container 1 to communicate with the outside. The opening 19 of the mouthpiece 3 is constituted so that, in addition to a functional component such as a valve assembly in which piping line elements such as a valve and a joint are integrally incorporated, a plug and a piping line can be screwed into the opening.

For example, in the container 1 of the fuel cell system, the storage space 105 is connected to an outer gas channel (not shown) via the valve assembly. Further in the container 1, the storage space 5 is filled with a hydrogen gas via the valve assembly and the gas channel. Moreover, for example, the hydrogen gas is discharged from the storage space 5. It is to be noted that the mouthpieces 3 are provided at the opposite end portions of the container 1. However, only one end wall portion 12 may be provided with the mouthpiece 3, and the end wall portion 12 may be constituted as a closed end portion.

Such a container 1 is manufactured through, for example, blow molding, injection molding or the like. To initially fill the manufactured container 1 with the hydrogen gas, the container 1 needs to be cleaned to prevent impurities and foreign matters from being mixed in the hydrogen gas or the like. During not only the manufacturing but also appropriate inspection and the like, the inside of the container 1 is sometimes cleaned. A cleaning device 30 for cleaning the inside of the container 1 will hereinafter be described in detail.

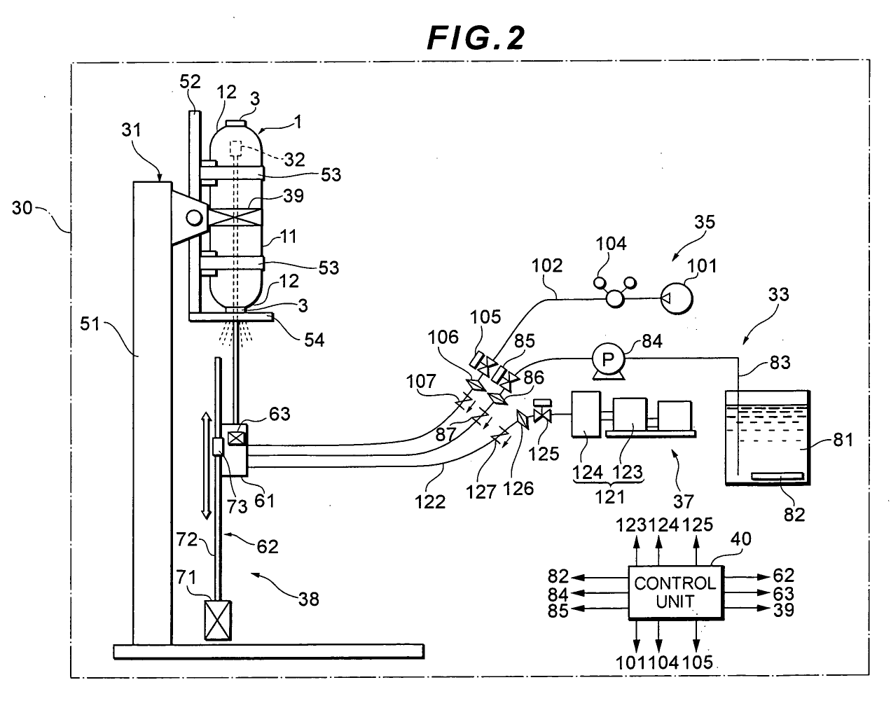

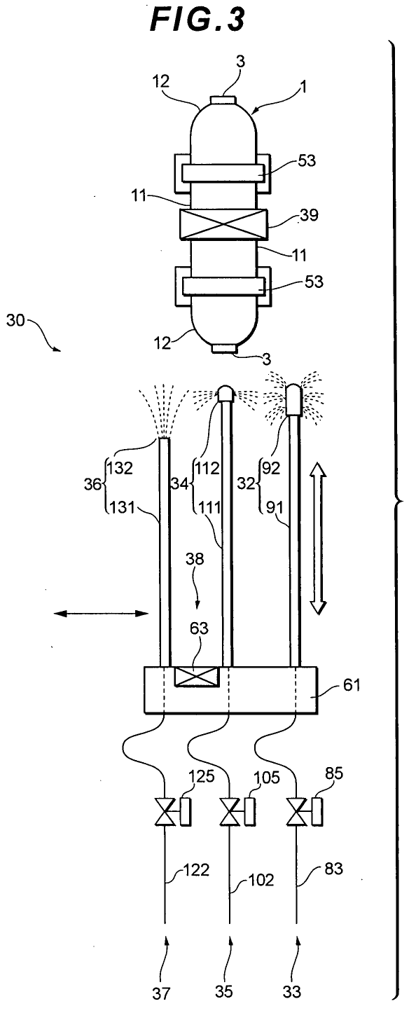

FIG. 2 is a system diagram schematically showing a constitution of the cleaning device 30 in a state in which a cleaning nozzle 32 is inserted into the container 1. FIG. 3 is a schematic front view showing a relation between three nozzles 32, 34 and 36 and the container 1.

The cleaning device 30 executes a series of treatments including cleaning with a cleaning liquid, draining with air blowing and drying with hot air with respect to the inside of the supported container 1. For this purpose, the cleaning device 30 includes a support mechanism 31, a cleaning mechanism 33 having the cleaning nozzle 32, a blowing mechanism 35 having the blowing nozzle 34, and a drying mechanism 37 having the drying nozzle 36. The cleaning device 30 includes a movement mechanism 38 which moves these three nozzles 32, 34 and 36 for a jetting function, a rotation mechanism 39 for rotating the container 1, and a control unit 40 which generally controls these mechanisms (33, 35, 37, 38 and 39). It is to be noted that in the following description, a series of treatments are sometimes referred to as a series of cleaning treatments.

The support mechanism 31 supports the container 1 in a state (an upright state) in which the mouthpiece 3 is directed downwards. During a series of treatments, a plug (not shown) is connected to the upper mouthpiece 3 of the container 1, whereas the lower mouthpiece 3 of the container 1 is opened downwards. An axial direction of the container 1 supported by the support mechanism 31 agrees with a vertical direction.

The support mechanism 31 has a support member 52 supported at an upper portion of a stand 51, a pair of holding mechanisms 53, 53 which are provided at the support member 52 to hold the trunk portion 11 of the container 1 at two upper and lower portions, and a lower plate 54 to which the lower mouthpiece 3 of the container 1 is opposed. The pair of holding mechanisms 53, 53 rotatably hold the container 1 around an axis of the container. The lower plate 54 has a through hole which is substantially as large as or larger than the opening 19 of the mouthpiece 3 at a position corresponding to the mouthpiece 3. A drain liquid of a cleaning liquid stored in the container 1 flows down to the through hole from the opening 19 of the mouthpiece 3, and is stored in a drain pan (not shown) or the like.

The rotation mechanism 39 is disposed, for example, between the pair of holding mechanisms 53, 53, and rotates the container 1 around the axis of the container. In FIGS. 2 and 3, the rotation mechanism 39 is shown in a simplified manner. During the series of treatments, the rotation mechanism 39 drives the container in synchronization with, for example, driving of the cleaning mechanism 33. It is to be noted that the constitution of the rotation mechanism 39 is not limited to the above constitution, and the rotation mechanism 39 may be used in draining and drying treatments during the series of treatments. Moreover, the rotation mechanism 39 does not have to be used during the series of treatments.

The movement mechanism 38 has a support base 61 which supports three nozzles 32, 34 and 36 as jetting members, a Y-axis movement unit 62 which moves the three nozzles 32, 34 and 36 in a vertical direction via the support base 61 and an X-axis movement unit 63 which moves the three nozzles 32, 34 and 36 provided at the support base 61 in a horizontal direction. It is to be noted that the X-axis movement unit 63 is shown in a simplified manner.

Actuators of the Y-axis movement unit 62 and the X-axis movement unit 63 are connected to the control unit 40. The three nozzles 32, 34 and 36 provided at the support base 61 are arranged apart from one another at a predetermined distance so that one arbitrary nozzle of them is inserted into the container 1 and that the remaining two nozzles are positioned outside the container 1.

The Y-axis movement unit 62 includes, for example, a motor 71 as a driving source, a ball screw 72 connected to the motor 71, and a ball nut 73 into which the ball screw 72 is screwed. The ball nut 73 is connected to the support base 61.

When the motor 71 is rotated forwards and backwards, the three nozzles 32, 34 and 36 provided at the support base 61 move up and down in the vertical direction (the axial direction of the container 1) via the ball screw 72 and the ball nut 73. For example, when the support base 61 moves up, the one arbitrary nozzle is inserted into the container 1 from the opening 19 of the mouthpiece 3. On the other hand, when the support base 61 moves down, the nozzle stored in the container 1 is extracted from the container 1 via the opening 19.

It is to be noted that the motor 71 may include another actuator such as an air cylinder. Instead of the ball screw 72 and the ball nut 73, a helical rail may be used, or a rack and pinion constitution may be used. Furthermore, instead of moving the three nozzles 32, 34 and 36, the three nozzles 32, 34 and 36 may be fixedly arranged, and the container 1 may be moved in the axial direction of these nozzles. That is, the Y-axis movement unit 62 may be constituted so as to relatively move the three nozzles 32, 34 and 36 with respect to the container 1 along the axial direction of the container 1, and corresponds to a “movement unit” described in claims of the present invention.

The X-axis movement unit 63 may be constituted in the same manner as in the Y-axis movement unit 62, and detailed description thereof is omitted here. The X-axis movement unit 63 moves the three nozzles 32, 34 and 36 provided at the support base 61, for example, in a direction crossing the axial direction of the container 1 at right angles, and the one arbitrary nozzle can be positioned right under the opening 19 of the mouthpiece 3.

It is to be noted that the X-axis movement unit 63 may be constituted to relatively move the three nozzles 32, 34 and 36 with respect to the container 1 in the direction crossing the axial direction of the container 1 at right angles in the same manner as in a modification of the Y-axis movement unit 62. One support base 61 is disposed. However, needless to say, two or more bases may be arranged so as to individually move the three nozzles 32, 34 and 36.

In consequence, the three nozzles 32, 34 and 36 which jet different fluids to an inner wall surface of the container 1 are relatively moved with respect to the inner wall surface by the common movement mechanism 38. Therefore, the whole constitution of the cleaning device 30 can be simplified.

The cleaning mechanism 33 can allow the cleaning nozzle 32 inserted into the container 1 to jet the cleaning liquid as a fluid for cleaning to wash away attached matters, dirt and the like from the inner wall (a cleaning surface) of the container 1. As the cleaning liquid, water may be used, or an appropriate liquid obtained by dissolving a cleaning agent in water or the like may be used.

The cleaning mechanism 33 has a cleaning tank 81 in which a predetermined amount of cleaning liquid is stored, a heater 82 which heats the cleaning liquid stored in the cleaning tank 81, and a cleaning hose 83 which has one end connected to the inside of the cleaning tank 81.

The heater 82 functions as a regulation unit which is connected to the control unit 40 and which regulates the cleaning liquid at a temperature in accordance with a characteristic of a material of the container 1. The heater 82 regulates the cleaning liquid at a predetermined temperature, for example, 120° C., preferably 70 to 80° C. in accordance with the liner 15 which is the cleaning surface. Since the cleaning liquid regulated at the temperature by the heater 82 is used, an effect of preheating is produced, and a drying time of the container 1 can be reduced. It is to be noted that the cleaning hose 83 may be provided with this type of regulation unit.

The other end of the cleaning hose 83 is connected to a cleaning pipe 91 of the cleaning nozzle 32 at the support base 61. The cleaning hose 83 has flexibility, and is constituted so that the hose can follow a vertical movement and a horizontal movement of the cleaning nozzle 32. On the other hand, the cleaning pipe 91 is formed of a hard material, extends in the axial direction of the container 1 and is formed to be longer than the container 1 in the axial direction.

The cleaning hose 83 is provided with, in order from a cleaning tank 81 side, a pump 84 which feeds the cleaning liquid from the cleaning tank 81 to the cleaning nozzle 32 under pressure, an electromagnetic cutoff valve 85 which opens and closes the cleaning hose 83, a filter 86 which removes impurities from the cleaning liquid fed under pressure, and a check valve 87 which inhibits counterflow of the cleaning liquid. The pump 84 and the cutoff valve 85 are connected to the control unit 40. Since the pressure of the cleaning liquid is raised by the pump 84, the inner wall of the container 1 can be cleaned with the cleaning liquid under high pressure.

The cleaning nozzle 32 includes the cleaning pipe 91 through which the cleaning liquid flows and a jetting section 92 provided at a tip end portion of the cleaning pipe 91. The jetting section 92 is provided at the tip end portion of the cleaning pipe 91 so as to protrude in a diametric direction. The jetting section 92 and the cleaning pipe 91 are constituted so as to pass through the opening 19 of the mouthpiece 3, and a predetermined gap is formed between the cleaning pipe 91 and the mouthpiece 3 in a state in which these components are inserted into the container 1. The used cleaning liquid is discharged from this gap, and stored in the above-mentioned drain pan.

The jetting section 92 has jetting ports (not shown) which communicate with the cleaning pipe 91 and which jet the cleaning liquid to the inner wall of the container 1. Positions of the jetting ports may be set so that any dead angle is not generated at the inner wall of the container 1. For example, a plurality of jetting ports are disposed at an upper portion, an intermediate portion, a lower portion and the like of the jetting section 92, and have a jetting directivity of the cleaning liquid as shown by a dotted line of FIG. 3.

Owing to this radial jetting directivity, the jetting ports can jet the cleaning liquid to the upper and lower end wall portions 12, 12 of the container 1 and the inner wall of the trunk portion 11 to remove dirt and the like attached to the inner wall of the container 1. It is to be noted that this type of jetting section 92 may be constituted in such a self pressure rotation system that the positions of the jetting ports rotate by the pressure of the cleaning liquid, or in such a fixed system that the positions of the jetting ports are unchanged.

The blowing mechanism 35 can jet a compressed gas as a blowing fluid from the blowing nozzle 34 inserted into the container 1 to blow off the remaining cleaning liquid attached to the inner wall of the container 1. That is, the blowing mechanism 35 drains the container 1 to which the cleaning liquid has been attached in a cleaning step as a pre-step. As the compressed gas, an inactive gas such as nitrogen may be used, but compressed air is used in the present embodiment.

The blowing mechanism 35 has a compressor 101 which takes in air to feed the air under pressure to the blowing nozzle 34, and a blowing hose 102 which connects the compressor 101 to the blowing nozzle 34.

The compressor 101 is connected to the control unit 40. The blowing hose 102 is connected to a blowing pipe 111 of the blowing nozzle 34 at the support base 61. The blowing hose 102 has flexibility, and is constituted so as to follow a vertical movement and a horizontal movement of the blowing nozzle 34. The blowing pipe 111 is formed of a hard material, extends in the axial direction of the container 1, and is formed to be longer than the container 1 in the axial direction.

The blowing hose 102 is provided with, in order from a compressor 101 side, a pressure regulator 104 which regulates a pressure of compressed air fed under pressure by the compressor 101, an electromagnetic cutoff valve 105 which opens and closes the blowing hose 102, a filter 106 which removes impurities from the compressed air fed under pressure, and a check valve 107 which inhibits counterflow of the compressed air. The pressure regulator 104 and the cutoff valve 105 are connected to the control unit 40. It is to be noted that the blowing hose 102 may be provided with a regulation unit which regulates a temperature of the compressed air.

The blowing nozzle 34 includes the above-mentioned blowing pipe 111 through which the compressed air flows, and a jetting section 112 provided at a tip end portion of the blowing pipe 111. The jetting section 112 and the blowing pipe 111 are constituted to be capable of passing through the opening 19 of the mouthpiece 3, and a predetermined gap is formed between the blowing pipe 111 and the mouthpiece 3 in a state in which these components are inserted into the container 1. The used cleaning liquid is discharged from this gap to drip downwards.

The jetting section 112 has jetting ports (not shown) which communicate with the blowing pipe 111 and which jet the compressed air to the inner wall of the container 1. Positions of the jetting ports may be set so that any dead angle is not generated at the inner wall of the container 1. For example, a plurality of jetting ports are arranged or scattered over a peripheral surface of a tip end portion of the jetting section 112, and have a jetting directivity slightly below a horizontal direction as shown by a dotted line of FIG. 3. Owing to this conical jetting directivity, the jetting ports jet the compressed air to the end wall portion 12 of the container 1 and the inner wall of the trunk portion 11 to remove the cleaning liquid attached to the inner wall of the container 1 with this air blowing.

The drying mechanism 37 can jet a fluid for drying from the drying nozzle 36 inserted into the container 1 to dry the inner wall and the inside of the container 1. As the fluid for drying, for example, hot air may be used.

The drying mechanism 37 has a hot air generation unit 121 which generates and feeds hot air under pressure to the drying nozzle 36, and a drying hose 122 which connects the hot air generation unit 121 to the drying nozzle 36. The hot air generation unit 121 includes, for example, a compressor 123 capable of feeding a large amount of air under pressure and a heater 124 which heats the air taken in by the compressor 123. The compressor 123 and the heater 124 are connected to the control unit 40.

The heater 124 functions as a regulation unit which regulates the air at a temperature in accordance with the characteristic of the material of the container 1. The heater 124 regulates the air at a predetermined temperature, for example, 120° C., preferably 70 to 80° C. in accordance with the liner 15. It is to be noted that the drying hose 122 may be provided with this type of regulation unit.

The drying hose 122 is connected to a drying pipe 131 of the drying nozzle 36 at the support base 61. The drying hose 122 has flexibility, and is constituted to be capable of following a vertical movement and a horizontal movement of the drying nozzle 36. On the other hand, a drying pipe 131 is formed of a hard material, and extends in the axial direction of the container 1. The drying hose 122 is provided with, in order from a hot air generation unit 121 side, an electromagnetic cutoff valve 125 which opens and closes the drying hose 122, a filter 126 which removes impurities from the blown hot air, and a check valve 127 which inhibits counterflow of the hot air. The cutoff valve 125 is connected to the control unit 40.

The drying nozzle 36 includes the above-mentioned drying pipe 131 through which the hot air flows, and a jetting section 132 provided at a tip end portion of the drying pipe 131. The jetting section 132 and the drying pipe 131 are constituted to be capable of passing through the opening 19 of the mouthpiece 3, and a predetermined gap is formed between the drying pipe 131 and the mouthpiece 3 in a state in which these components are inserted into the container 1. In addition, to blow a large amount of the hot air into the container 1, it is preferable that the drying pipe 131 has a large diameter which is substantially equal to, for example, a diameter of the opening 19 of the mouthpiece 3.

The jetting section 132 has jetting ports (not shown) which communicate with the drying pipe 131 and which jet the hot air into the container 1. The jetting ports may be constituted of tip end openings of the drying pipe 131, and mainly has a jetting directivity of an upward direction as one direction as shown by a dotted line in FIG. 3. The jetting ports during the drying are positioned, for example, at the center in the container 1 without moving up and down, and jet the hot air toward the upper end wall portion 12 of the container 1. In consequence, the hot air also reaches the lower end wall portion 12 from the upper end wall portion 12 along the trunk portion 11 to dry the whole inside of the container 1. It is to be noted that the hot air may be jetted in not only one direction but also multiple directions.

The control unit 40 (ECU) has a CPU, an ROM, an RAM and an input/output interface (which are not shown), and these components are connected to one another via a bus. The control unit 40 successively switches the nozzles 32, 34 and 36 having the jetting functions to jet the fluids in the container 1 in order to continuously perform a series of treatments (cleaning, draining and drying).

Here, a “switching unit” described in the claims of the present invention is a unit which switches from the nozzle having a certain jetting function to the nozzle having another jetting function. In the present embodiment, the “switching unit” mainly corresponds to the Y-axis movement unit 62 and the X-axis movement unit 63 of the movement mechanism 38 and the control unit 40, and conceptually includes constituting units (the cutoff valves 85, 105 and 125, the pump 84, the compressors 101, 123, etc.) provided at the mechanisms 33, and 37 of the jetting functions.

Next, a series of operations to be performed by the cleaning device 30 will be described.

As a preparation stage, the container 1 is rotatably supported by the support mechanism 31 so that the one mouthpiece 3 of the container is directed downwards. The upper mouthpiece 3 of the container 1 is provided with a plug.

In the next cleaning step, the Y-axis movement unit 62 inserts the cleaning nozzle 32 into the container 1 from the opening 19 of the lower mouthpiece 3, and allows the jetting section 92 to be opposed to the vicinity of the upper end wall portion 12. Before and after this step, the heater 82 is driven to heat the cleaning liquid at a predetermined temperature. Subsequently, the cutoff valve 85 is opened to drive the pump 84, and the cleaning liquid is jetted from the jetting section 92. At this time, while the Y-axis movement unit 62 moves the jetting section 92 downwards, the cleaning liquid is jetted to clean the inner wall of the container 1 in order from the upper end wall portion 12, the trunk portion 11 and the lower end wall portion 12. In consequence, the inner wall is evenly cleaned, and the dirt and the like are removed. It is to be noted that the jetting section 92 which is jetting the cleaning liquid may be moved vertically by the Y-axis movement unit 62.

After end of the cleaning step, the cutoff valve 85 is closed. Moreover, the driving of the pump 84 is stopped to stop feeding the liquid to the cleaning nozzle 32. After extracting the cleaning nozzle 32 from the container 1, the X-axis movement unit 63 is driven to move the blowing nozzle 34 so that the nozzle is positioned right under the opening 19. That is, the cleaning nozzle 32 is switched to the blowing nozzle 34.

In a blowing step, the Y-axis movement unit 62 inserts the blowing nozzle 34 into the container 1 via the lower opening 19, and allows the jetting section 112 to be opposed to the vicinity of the upper end wall portion 12. Subsequently, the cutoff valve 105 is opened, and the compressor 101 is driven to jet the compressed air from the jetting section 112. At this time, while the Y-axis movement unit 62 moves the jetting section 112 downwards, the compressed air is jetted to drain the inner wall of the container 1 in order from the upper end wall portion 12, the trunk portion 11 and the lower end wall portion 12. In consequence, liquid droplets attached to the inner wall of the container 1 are scratched off.

After end of the blowing step, the cutoff valve 105 is closed. Moreover, the driving of the compressor 101 is stopped to stop feeding the air to the blowing nozzle 34. After extracting the blowing nozzle 34 from the container 1, the X-axis movement unit 63 moves the drying nozzle 36 so that the nozzle is positioned right under the opening 19. That is, the blowing nozzle 34 is switched to the drying nozzle 36.

In a drying step, the Y-axis movement unit 62 inserts the drying nozzle 36 into the container 1 via the lower opening 19, and allows the jetting section 132 to be opposed to the center in the container 1. Subsequently, the cutoff valve 125 is opened to drive the hot air generation unit 121, and the hot air at a predetermined temperature (e.g., 80° C.) is jetted from the jetting section 132. In consequence, the inside of the container 1 including the inner wall of the container 1 dries. It is to be noted that during the drying step, the Y-axis movement unit 62 may be driven to move the jetting section 132 upwards and/or downwards.

When the drying is completed, the cutoff valve 125 is closed. Moreover, the driving of the hot air generation unit 121 is stopped to stop feeding the air to the drying nozzle 36. The drying nozzle 36 is extracted from the container 1. In consequence, a series of treatments performed by the cleaning device 30 end. Furthermore, when the container 1 is finally removed from the support mechanism 31 and the valve assembly and the like are screwed into the mouthpiece 3 of the container 1, the container 1 is mounted on, for example, the fuel cell system.

As described above, according to the cleaning device 30 of the present embodiment, the nozzles 32, 34 and 36 having the jetting functions for the cleaning, blowing and drying are successively switched to slide and switch the cutoff valves (85, 105 and 125) corresponding to the jetting functions. In consequence, the series of treatments can automatically and continuously be performed, and a cleaning efficiency of the container 1 can be improved.

It is to be noted that the container 1 made of the resin is a target, but when the container 1 or the like is made of steel, the container can be cleaned and dried using steam at a comparatively high temperature. In addition, when the cleaning method is adopted as described in the present embodiment, the container 1 made of the resin can appropriately be cleaned without using any steam. If the temperature of the compressed air of the blowing step can be set to such a predetermined temperature as to also dry the container 1, the drying step may be omitted. That is, the blowing nozzle 34 can also serve as the drying nozzle 36.

Moreover, to vertically move the nozzles 32, 34 and 36 of the jetting functions, for example, the pipes 91, 111 and 131 being moved may slidably be supported at the lower plate 54 of the support mechanism 31. Furthermore, the container 1 provided with the mouthpieces 3 is cleaned, but the container 1 may be cleaned before the mouthpieces 3 are attached to the container. In this case, a mouth part of the container 1 (a container mouth part) as an insertion port of the nozzles 32, 34 and 36 having the jetting functions is an opening of the end wall portion 12 to which the mouthpiece 3 should be attached.

Furthermore, the nozzles 32, 34 and 36 each having the jetting function may be switched without being extracted from the opening 19 of the container 1. That is, at an initial stage of the cleaning step, all or two of the three nozzles 32, 34 and 36 may be inserted into the container 1. After the end of each step, the nozzle may be switched to the nozzle of the subsequent function in the container 1.

### Second Embodiment

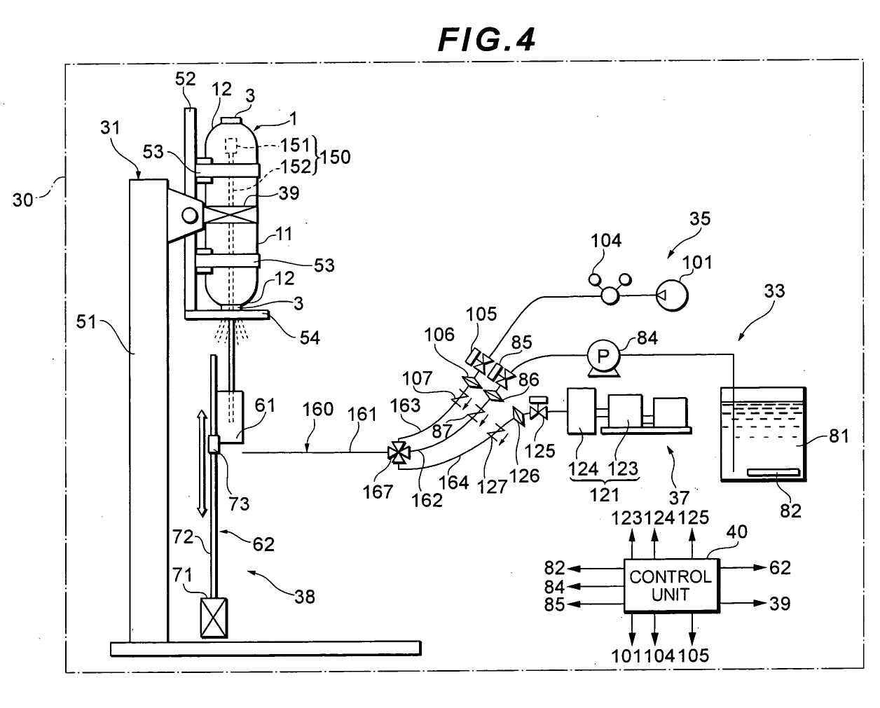

Next, a different respect of a cleaning device 30 according to a second embodiment will mainly be described with reference to FIG. 4. A large difference from the first embodiment lies in that various fluids such as a cleaning liquid, compressed air and hot air are jetted by a single nozzle 150.

Specifically, the single nozzle 150 as a jetting member has a single common jetting section 151 having jetting ports and a single common pipe 152 which communicates with the jetting section 151. A flexible hose 160 has a single common hose section 161, and three independent and individual hose sections 162, 163 and 164 corresponding to three fluids.

Ends of the three individual hose sections 162, 163 and 164 on one side are connected to the cleaning tank 81, the compressor 101 and the hot air generation unit 121, respectively. The other ends of the three individual hose sections 162, 163 and 164 are connected to input ports of a switch valve 167 of a four-way valve system. One remaining output port of the switch valve 167 is connected to the common hose section 161. The switch valve 167 is connected to the control unit 40, and selectively switches an input port of the control unit.

Here, in the present embodiment, a “switching unit” described in claims of the present invention is a unit which switches a type of the fluid to be jetted from the nozzle 150 to switch to another function. The “switching unit” mainly corresponds to the control unit 40 and the switch valve 167, and conceptually includes constituting units (cutoff valves 85, 105 and 125, a pump 84, compressors 101, 123, etc.) provided at mechanisms 33, 35 and 37 of jetting functions. It is to be noted that a movement mechanism 38 does not have to include an X-axis movement unit 63.

An operation in a case where a series of cleaning treatments are performed by the cleaning device 30 of the present embodiment will briefly be described.

First, in a cleaning step, the common hose section 161 is allowed to communicate with the individual hose section 162 by the switch valve 167. While moving the nozzle 150, the cleaning liquid is jetted in a container 1. After end of the cleaning step, the switch valve 167 is switched to stop feeding the cleaning liquid, the common hose section 161 is allowed to the individual hose section 163, and compressed air can be blown to the nozzle 150. Moreover, a blowing step is executed. When this cleaning step shifts to the draining step, the nozzle 150 does not have to be extracted from the container 1.

After end of the draining step, the switch valve 167 is similarly switched to stop blowing the compressed air, and the common hose section 161 can be allowed to communicate with the individual hose section 164 to blow hot air to the nozzle 150. Furthermore, a drying step is executed. At this time, the nozzle 150 does not have to be extracted from the container 1.

As described above, according to the cleaning device 30 of the present embodiment, the type of the fluid to be jetted from the nozzle 150 can successively be switched to perform the treatments without extracting the nozzle 150 from the container 1. In consequence, while the number of components is reduced, the series of treatments can automatically and continuously be performed, and a cleaning efficiency of the container 1 can be improved.

### Third Embodiment

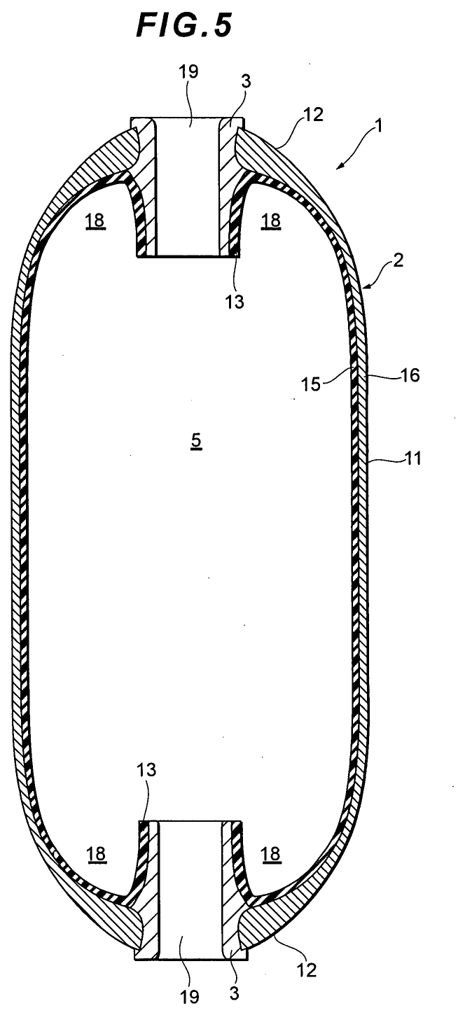

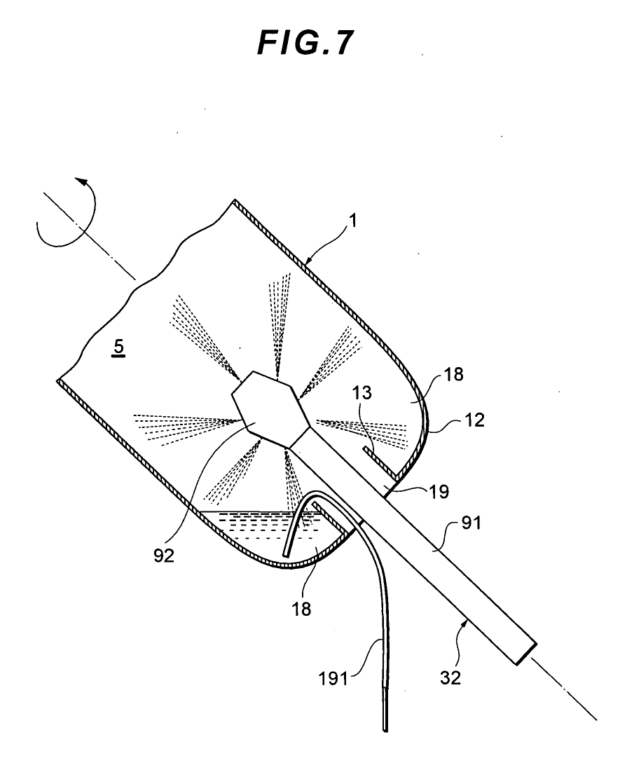

Next, a different respect of a cleaning device 30 according to a third embodiment will mainly be described with reference to FIGS. 5 to 8. The embodiment is different from the first embodiment in that a shape of a container 1 is provided with protruding portions 13 as returning portions and that the container 1 is tilted, supported and rotated by the cleaning device 30. It is to be noted that in FIG. 7, a constitution of the container 1 is shown in a simplified manner.

FIG. 5 is a sectional view of the container 1. The container 1 includes the protruding portions 13, 13 which are formed at end wall portions 12, 12 and which protrude into a container main body 2. Each protruding portion 13 is provided at a mouth part of a liner 15 to which mouthpieces 3 are attached so as to turn back, and has a substantially cylindrical shape along an axis in an axial direction of the container 1. A donut-like space 18 is formed between an outer peripheral surface of each protruding portion 13 and an inner surface of the liner 15. The protruding portions 13 may be referred to as so-called structural returning portions, and function to secure strength of the liner 15 and further strength of the container 1.

It is to be noted that another structure of the container 1 is the same as that of the first embodiment. The container 1 is provided with a pair of protruding portions 13, 13, but one of them may be omitted. Furthermore, the protruding portions 13 are formed at the liner 15. However, needless to say, the present invention is not limited to this example. When the liner 15 is constituted in the same manner as in the first embodiment and the mouthpieces 3 are constituted so as to protrude into the container 1, the protruding portions of the mouthpieces 3 form the protruding portions 13.

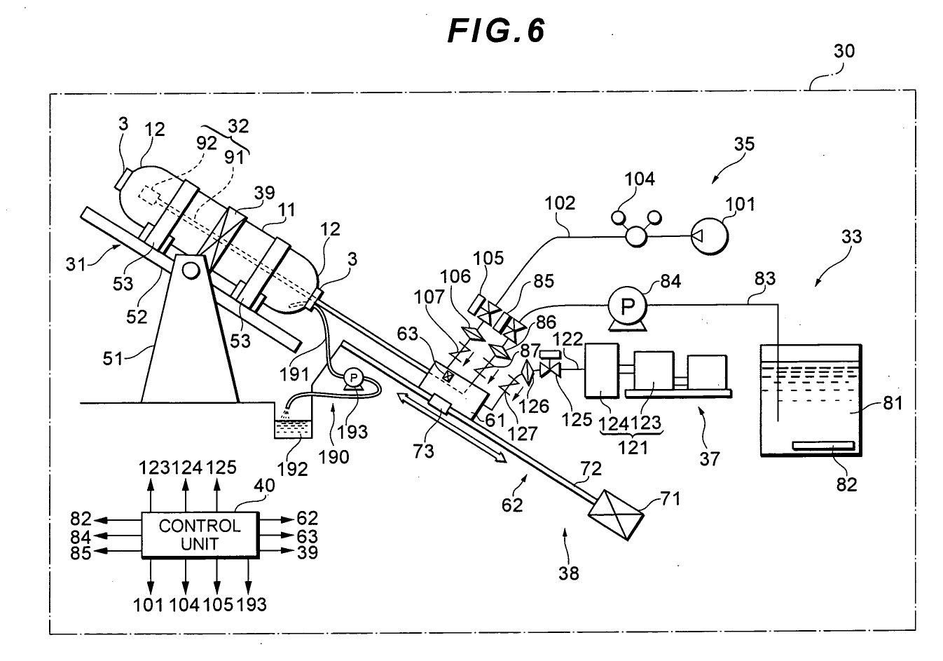

FIG. 6 is a system diagram schematically showing the cleaning device 30. The cleaning device 30 has a support mechanism 31, a cleaning mechanism 33, a blowing mechanism 35, a drying mechanism 37, a movement mechanism 38, a rotation mechanism 39 and a control unit 40 in the same manner as in the first embodiment, and these mechanisms, the control unit 40 and the like constitute a switching unit which switches functions of nozzles 32, 34 and 36.

The support mechanism 31 supports the container 1 in a tilted state in which an opening 19 of the mouthpiece 3 of the container 1 is opened obliquely downwards. During treatments, a plug (not shown) is connected to the upper mouthpiece 3 of the container 1, and an axial direction of the container 1 supported by the support mechanism 31 tilts from a vertical direction so as to intersect with the vertical direction. At this time, a tilt angle of the container 1 in the axial direction may be smaller than 90 degrees (i.e., a supported state with a horizontal posture) in the vertical direction, preferably 30 to 60 degrees. For example, from a viewpoint of suppressing a height of the supported container 1, it is preferable that the angle is 35 degrees. It is to be noted that in the present embodiment, the lower plate 54 is omitted.

The rotation mechanism 39 is shown in a simplified manner. The mechanism rotates the container 1 supported by the support mechanism 31 around an axis of the container in the same manner as in the first embodiment. The rotation mechanism 39 is driven in synchronization with, for example, the driving of the cleaning mechanism 33 and the blowing mechanism 35 during a series of treatments, but may synchronously be driven even during the driving of the drying mechanism 37.

The movement mechanism 38 has a Y-axis movement unit 62 which moves the three nozzles 32, 34 and 36 having each jetting function provided at a support base 61 in the axial direction of the container 1 and an X-axis movement unit 63 which moves the three nozzles 32, 34 and 36 in a direction crossing this axial direction at right angles. The same modification as that of the first embodiment may be applied to the movement mechanism 38. It is to be noted that, although not described in detail, pipes 91, 111 and 131 of the nozzles 32, 34 and 36 of the cleaning mechanism 33, the blowing mechanism 35 and the drying mechanism 37 tilt in the same direction as the axial direction of the container 1.

The cleaning device 30 of the present embodiment further includes a suction mechanism 190 which sucks a cleaning liquid accumulated in the container 1 without being discharged.

The suction mechanism 190 includes a suction tube 191 which passes through the opening 19 of the mouthpiece 3 and whose one end is positioned in the space 18 of the container 1, a waste liquid receiving portion 192 at which the other end of the suction tube 191 is positioned, and a suction pump 193 interposed at the suction tube 191. The suction pump 193 is connected to the control unit 40. When the suction pump 193 is driven, the cleaning liquid accumulated in the space 18 of the container 1 is sucked via the suction tube 191, and discharged to the waste liquid receiving portion 192.

Next, an operation of the cleaning device 30 will be described. In a cleaning step, the Y-axis movement unit 62 inserts the cleaning nozzle 32 into the container 1 tilted at the predetermined angle obliquely from below via the opening 19, and allows a jetting section 92 to be opposed to the vicinity of the upper end wall portion 12. Moreover, while the Y-axis movement unit 62 obliquely moves the jetting section 92 downwards in the same manner as in the first embodiment, the cleaning liquid regulated at a predetermined temperature is jetted. In consequence, the inner wall of the container 1 is cleaned in order from the upper end wall portion 12, a trunk portion 11 and the lower end wall portion 12.

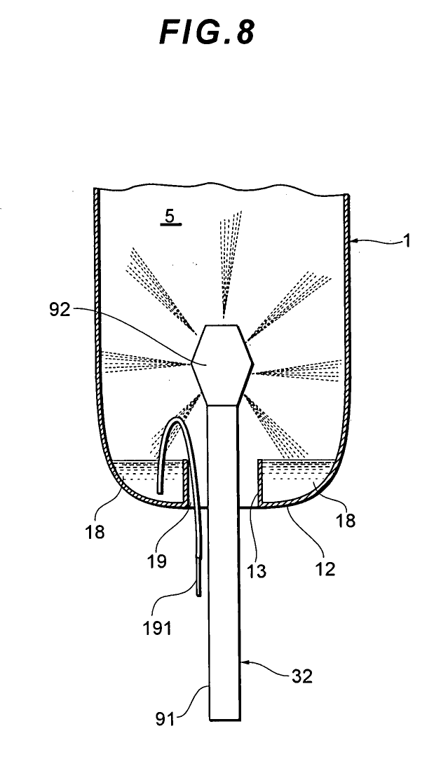

During the cleaning, a part of the jetted cleaning liquid naturally flows downwards from the opening 19 of the container 1 without being discharged, and is accumulated at the space 18 in the vicinity of the opening 19 (see FIGS. 7 and 8). When the container 1 is not tilted as in a comparative example of FIG. 8, the cleaning liquid accumulates to a height of the protruding portion 13 at maximum in the whole space 18. Even if the jetting section 92 jets the cleaning liquid to the inner wall of the end wall portion 12 of the container 1 in such a state, the cleaning liquid is obstructed by the cleaning liquid accumulated in the space 18. Therefore, the cleaning liquid from the jetting section 92 cannot directly collide with the inner wall of the end wall portion 12, and this part is insufficiently cleaned.

On the other hand, in the constitution of the present embodiment shown in FIG. 7, the cleaning liquid accumulates at a portion of the space 18 below an axis of the container 1. That is, when the cleaning liquid accumulates in the space 18, the liquid is concentrated on one side of the space 18. Therefore, the cleaning liquid from the jetting section 92 can directly be applied to a portion of the inner wall of the end wall portion 12 in which any cleaning liquid is not accumulated, and this portion can be cleaned.

Moreover, in the present embodiment, when the container 1 is rotated around the axis by the rotation mechanism 39 during the cleaning, the portion of the space 18 where the cleaning liquid resides relatively moves with respect to the end wall portion 12 of the container 1. In consequence, any dead angle from the jetting section 92 is eliminated, and the cleaning liquid from the jetting section 92 can directly be applied to all portions of the inner wall of the end wall portion 12. Therefore, the inner wall of the container 1 can evenly be cleaned.

After end of the cleaning step, the feeding of the liquid to the cleaning nozzle 32 is stopped. Before or after extracting the cleaning nozzle 32 from the container 1, the suction tube 191 is inserted into the container 1 from the opening 19 of the container 1. Moreover, one end of the suction tube 191 is inserted into the portion of the space 18 where the cleaning liquid accumulates on the only one side, and the suction pump 193 is driven to suck this cleaning liquid into the waste liquid receiving portion 192. In consequence, the cleaning liquid is removed from the space 18 of the container 1. It is to be noted that it is preferable that a unit to insert the suction tube 191 into the container 1 is provided at the suction mechanism 190.

Subsequently, in the same manner as in the first embodiment, the container is drained by the blowing nozzle 34, this nozzle 34 is switched to the drying nozzle 36, and the container is dried by the drying nozzle 36. In consequence, a series of treatments of the container 1 ends. Therefore, according to the cleaning device 30 of the present embodiment, even in a structure of the container 1 in which the protruding portion 13 protrudes into the container 1 and the cleaning liquid accumulates, the jetted liquid (the cleaning liquid) can be applied to the inner wall of the container 1 without any dead angle. In consequence, a series of cleaning treatments can automatically and continuously be performed without any fluctuation of cleanness of the container 1.

It is to be noted that even in a blowing step, while the tilted container 1 is rotated, compressed air may be jetted. In this case, even if liquid droplets are excessively blown off by the compressed air to accumulate in the space 18, the compressed air can be applied to the inner wall of the container 1 without any dead angle. Even after the blowing step, the cleaning liquid of the space 18 may be sucked and removed by the suction mechanism 190.

### Fourth to Ninth Embodiments

A cleaning device 30 according to fourth to ninth embodiments suitable for cleaning a container 1 shown in FIG. 5 will hereinafter be described. In description of each embodiment, the same constituting units or structures as those of the first embodiment are denoted with the same reference numerals as those of the first embodiment, and description thereof is appropriately omitted. The fourth to ninth embodiments have a characteristic that treatment members such as the above-mentioned nozzles are constituted to perform predetermined treatments in a container in accordance with a shape of the container.

Specifically, a treatment member for a wiping treatment having a suction function will be described in the fourth embodiment, a treatment member for a cleaning treatment will be described in the fifth embodiment, and a treatment member for a drying treatment will be described in a sixth embodiment. A treatment member for a permeation inhibiting treatment will be described in the seventh embodiment, and a treatment member for a suction treatment will mainly be described in the eighth and ninth embodiments. It is to be noted that, in the fifth to ninth embodiments, the same structure as that of the fourth embodiment is denoted with the same reference numerals as those of the fourth embodiment, and description thereof is omitted.

### Fourth Embodiment

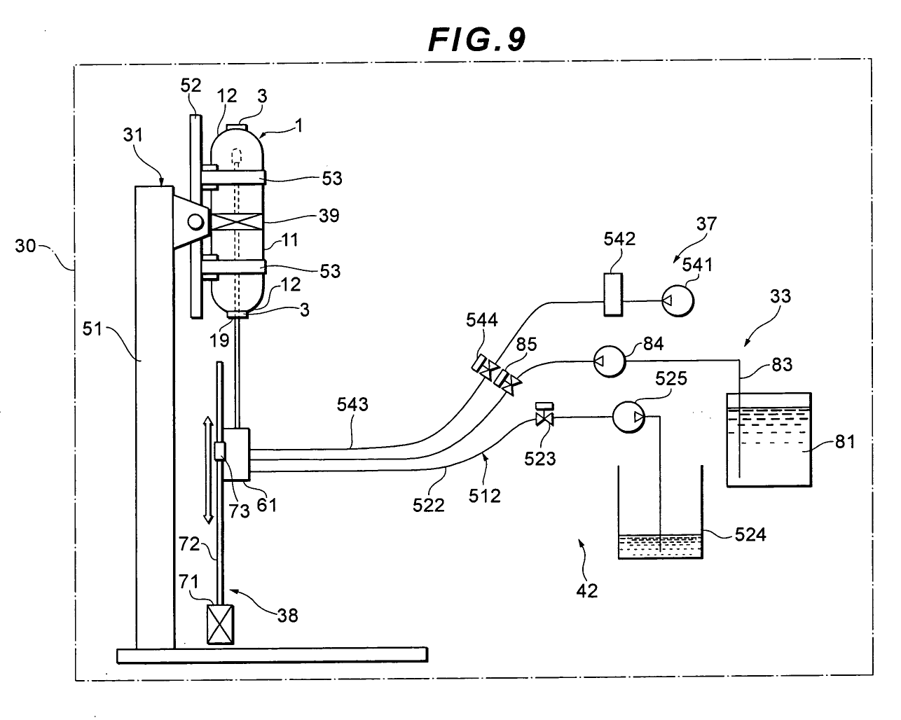

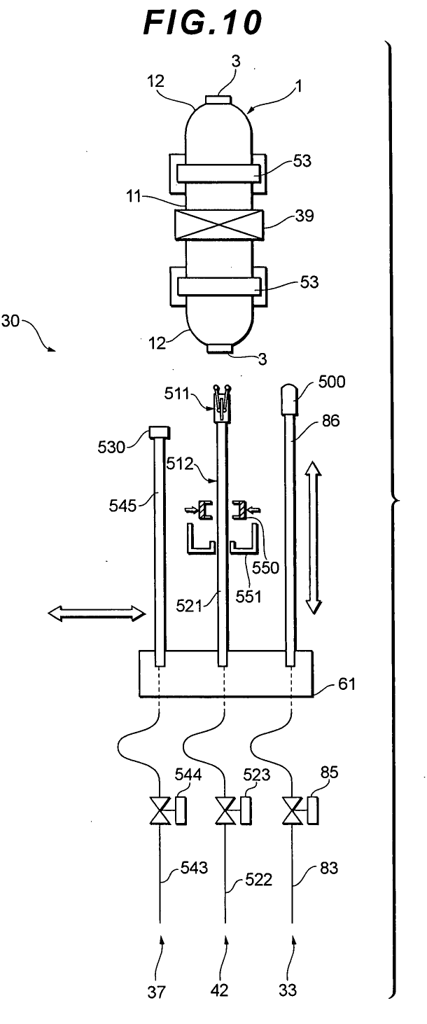

FIG. 9 is a system diagram schematically showing a constitution of a cleaning device 30. FIG. 10 is a simplified front view of FIG. 9, and is a diagram showing a relation between three treatment members 500, 511 and 530 and a container 1.

The cleaning device 30 executes a series of treatments including cleaning with a cleaning liquid, wiping after the cleaning and drying with hot air with respect to the inside of the container 1 to clean an inner surface of the container 1.

The cleaning device 30 includes a support mechanism 31, a cleaning mechanism 33, a wiping mechanism 42, a drying mechanism 37, a movement mechanism 38, a rotation mechanism 39 and a control unit (not shown) which generally controls these mechanisms (33, 42, 37, 38 and 39).

The support mechanism 31 supports the container 1 in a state (an upright state) in which a mouthpiece 3 is directed downwards. The support mechanism 31 has a stand 51, a support member 52 and holding mechanisms 53, 53 as described above. During a series of treatments, an upper mouthpiece 3 is connected to a plug (not shown). On the other hand, an opening 19 of the lower mouthpiece 3 is opened downwards.

The cleaning mechanism 33 has the nozzle 500 as a treatment member which performs a cleaning treatment in the container 1, and supplies a cleaning liquid as a fluid for cleaning to the nozzle 500. The cleaning mechanism 33 has a cleaning tank 81, a cleaning hose 83, a pump 84 and a cutoff valve 85 in the same manner as described above, and has a pipe section 86 which communicates with the nozzle 500. The cleaning mechanism 33 jets the cleaning liquid from the nozzle 500 inserted into the container 1 to wash away matters and the like attached to an inner wall of the container 1.

The wiping mechanism 42 has a sponge unit 511 as the treatment member which performs a wiping treatment in the container 1, and a suction unit 512 connected to the sponge unit 511. The sponge unit 511 is folded, is inserted into the container 1, is then expanded so as to enlarge in an umbrella state, and wipes off the remaining cleaning liquid attached to the inner wall of the container 1. Detailed constitution of the sponge unit 511 will be described later.

The suction unit 512 sucks the cleaning liquid wiped by the sponge unit 511 to remove this cleaning liquid from the container 1. The suction unit 512 has a suction pipe section 521 connected to the sponge unit 511, a flexible hose 522 for suction connected to the suction pipe section 521 at a support base 61, a cutoff valve 523 which opens and closes the hose 522 for suction, a recovery tank 524 in which one end of the hose 522 for suction is positioned to recover the sucked cleaning liquid, and a suction pump 525 which feeds the cleaning liquid under pressure to the recovery tank 524. When the suction pump 525 is driven, a suction force is applied to the sponge unit 511, and the cleaning liquid wiped by the sponge unit 511 is recovered in the recovery tank 524.

The drying mechanism 37 has a nozzle 530 as the treatment member which performs a drying treatment in the container 1, and supplies a fluid for drying to the nozzle 530. The drying mechanism 37 jets the fluid for drying from the nozzle 530 inserted into the container 1 to dry the inner wall and the inside of the container 1. As the fluid for drying, for example, hot air may be used.

The drying mechanism 37 heats air taken by a compressor 541 with a heater 542, and supplies this heated air to a pipe section 545, which communicates with the nozzle 530, via a hose 543 for drying. The mechanism is provided with a cutoff valve 544 which opens and closes the hose 543 for drying. The heater 542 regulates air at a predetermined temperature of, for example, 120° C., preferably 70 to 80° C. in accordance with a characteristic of a material of a liner 15.

The movement mechanism 38 moves the three treatment members (the nozzle 500, the sponge unit 511 and the nozzle 530) in an axial direction of the container 1, and the three treatment members are detachably inserted into the container 1 individually. The movement mechanism 38 includes, for example, the support base 61, a motor 71, a ball screw 72 and a ball nut 73 as described above, and further includes an X-axis movement unit (not shown) (denoted with 63 in FIGS. 2 and 3). It is to be noted that the movement mechanism 38 may be constituted to relatively move the three treatment members (the nozzle 500, the sponge unit 511 and the nozzle 530) with respect to the container 1 along the axial direction of the container 1.

The rotation mechanism 39 is connected to the control unit, and appropriately rotates the container 1 around an axis of the container during a series of treatments of the container 1. It is to be noted that the rotation mechanism 39 may be constituted to rotate at least one of the container 1 and the treatment member (500, 511 or 530) around the axis of the container 1. The control unit (ECU) controls the cleaning mechanism 33, the wiping mechanism 42 and the drying mechanism 37. Moreover, in relation to this control, the control unit controls the movement mechanism 38 and the rotation mechanism 39 to continuously perform a series of treatments of the container 1.

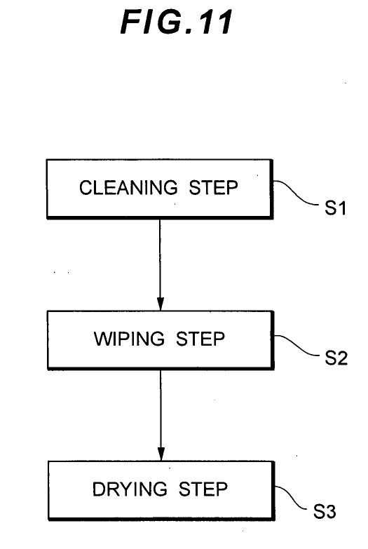

FIG. 11 is a flow chart of a series of treatments to be performed by the cleaning device 30. For example, in a cleaning step (S1), the cleaning liquid is jetted from the nozzle 500 inserted into the vicinity of an upper end wall portion 12 of the container 1 via the opening 19. During jetting of this cleaning liquid, the movement mechanism 38 moves the nozzle 500 downwards, and the rotation mechanism 39 rotates the container 1. In consequence, the whole region of the inner wall of the container 1 is cleaned to remove dirt. After the cleaning, the cleaning mechanism 33 is controlled to cut off the passed cleaning liquid, and the nozzle 500 is extracted from the container 1.

In a wiping step (S2), the sponge unit 511 is inserted into the container 1 from the opening 19. Driving of the wiping mechanism 42 is started, that is, the cutoff valve 523 is opened to drive the suction pump 525. While the inner surface of the container 1 is wiped with the sponge unit 511, the suction force is applied. At this time, while the movement mechanism 38 moves the sponge unit 511 downwards, the rotation mechanism 39 rotates the container 1. In consequence, the cleaning liquid remaining in the container 1 is recovered.

After recovering the cleaning liquid, the wiping mechanism 42 is controlled to stop a suction function, and the sponge unit 511 is extracted from the container 1. Subsequently, the sponge unit 511 is opposed to a draining unit 550 of a pressing system. Moreover, the remaining cleaning liquid which has not been sucked by sponges 561 (described later) of the sponge unit 511 is taken away by the draining unit 550, and the taken cleaning liquid is allowed to flow down to a drain catch 551 disposed below the draining unit.

In a drying step (S3), the nozzle 530 of the drying mechanism 37 is inserted into the container 1 from the opening 19. Moreover, the compressor 541 and the heater 542 are driven, and the hot air is jetted from the nozzle 530. During the jetting of this hot air, the nozzle 530 is moved downwards by the movement mechanism 38, and the container 1 is rotated by the rotation mechanism 39 to dry the inside of the container 1. After drying, the drying mechanism 37 is controlled to cut off passing of the hot air, and the nozzle 530 is extracted from the container 1. According to the above steps, a series of treatments performed by the cleaning device 30 end.

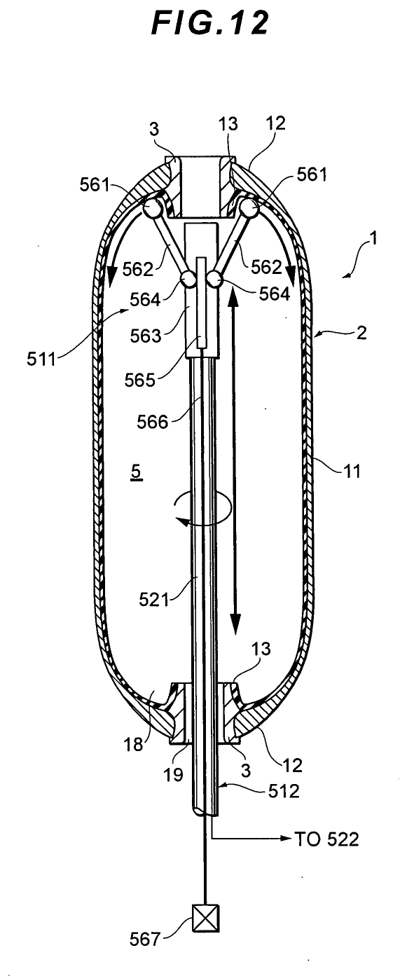

Next, the sponge unit 511 as the treatment member will be described in detail with reference to FIGS. 12 to 14.

The sponge unit 511 is inserted into the container 1 along the axial direction of the container 1. The sponge unit 511 includes the sponges 561, holding arms 562 which hold the sponges 561 at tip end portions thereof, a base 563 which rotatably supports base end portions of the holding arms 562, pinions 564 provided along an axis of a rotation support of the holding arms 562 and secured to the base end portions of the holding arms 562, a rack 565 which engages with the pinion 564, a connection rod 566 having one end thereof connected to a base end of the rack 565 and a actuator 567 connected to the other end of the connection rod 566.

For example, pairs of sponges 561, holding arms 562 and pinions 564 are provided, respectively, and a pair of pinions 564, 564 engage with opposite sides of the rack 565 in a longitudinal direction. The rack 565 is supported by the base 563 so that the rack can slide in the axial direction of the container 1.

The connection rod 566 is provided along the suction pipe section 521. The actuator 567 includes, for example, a motor provided at the support base 61. When the motor 567 rotates forwards and backwards, the rack 565 reciprocates via the connection rod 566. In consequence, a pair of holding arms 562 rotate in a vertical plane via the pair of pinions 564, 564.

The sponges 561 are made of a rubber, a synthetic resin or the like, and wipe off (suck) the cleaning liquid attached to the inner surface of the container 1. That is, the sponges 561 function as operating sections which directly come in contact with the inner surface of the container 1 to perform the wiping treatment. The sponge 561 is formed into a spherical form as a whole in accordance with shapes of inner surfaces of the container 1, for example, the shape of the inner surface of the end wall portion 12 and the shape of the inner surface of a trunk portion 11.

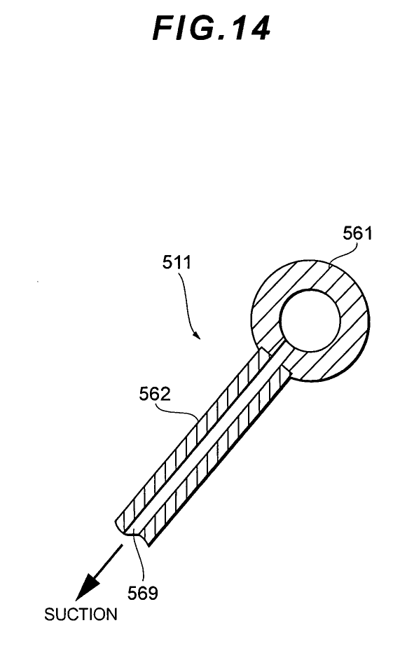

Each of the holding arms 562 is formed into a tubular shape, and a suction passage 569 is formed in the tubular arm (see FIG. 14). One end of the suction passage 569 is connected to the sponge 561, and the other end thereof communicates with the suction pipe section 521 of the suction unit 512. In consequence, when the suction pump 525 of the suction unit 512 is driven, the suction force is applied to the sponge 561 via the suction pipe section 521 and the suction passage 569. The sponges 561 wipe the inside of the container 1 to suck the cleaning liquid stored in the container with the suction force. The cleaning liquid with which the sponges 561 are impregnated is discharged from the sponges 561 to the suction passage 569 and removed with the suction force.

In the sponge unit 511 constituted as described above, the holding arms 562 rotate about 180 degrees in the vertical plane so that the sponges 561 can come in contact with the inner surfaces of the upper end wall portion 12, the trunk portion 11 and the lower end wall portion 12 and can pass through the opening 19. That is, the sponge unit 511 is brought into a first state in which the sponge unit is a structure having a diameter smaller than an inner diameter of the opening 19 or a second state in which the unit is a structure having a diameter larger than the inner diameter of the opening 19, depending on rotary positions of the holding arms 562.

Specifically, when the holding arms 562 rotate to close around the base 563 as a support point and the holding arms 562 are positioned to extend in the axial direction of the container 1, the sponge unit 511 comes in the first state in which the unit can pass through the opening 19 (can be inserted or extracted). Such a first state may be referred to as a closed state. Alternatively, since the sponges 561 and the holding arms 562 are folded with respect to the base 563, the state may be referred to as a folded state.

On the other hand, when the holding arms 562 rotate from this first state so as to open around the base 563 as the support point, the sponges 561 are positioned externally from an edge portion of the opening 19 in a diametric direction, and shifts to a second state in which the sponge unit 511 cannot pass through the opening 19 (cannot be inserted or extracted). That is, the positions of the sponges 561 in the diametric direction of a container main body 2 can be regulated. As the first state shifts to the second state, the sponges 561 come close to the inner surface of the container 1.

This second state includes a fully opened state in which the holding arms 562 rotate about 90 degrees from the first state and the sponges 561 can come in contact with the inner surface of the trunk portion 11, and a partially opened state (a half opened state) in which the holding arms 562 rotate from the fully opened state as much as a predetermined angle that is less than 90 degrees and the sponges 561 can come in contact with the inner surface of the end wall portion 12. In other words, such a second state may be an opened state or an expanded state because the sponges 561 and the holding arms 562 are expanded with respect to the base 563.

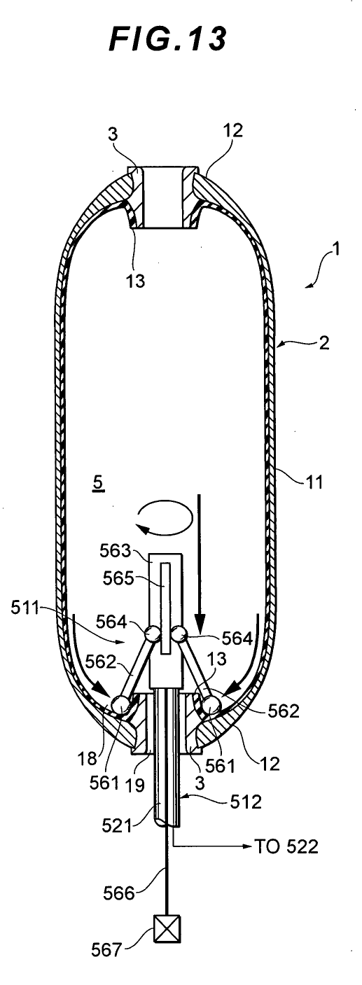

Here, an operation of the sponge unit 511 in the wiping step (S2) shown in FIG. 11 will be described with reference to FIGS. 12 and 13.

First, the folded sponge unit 511 is inserted into the container 1 from the opening 19 so as to dispose the sponge unit 511 to be opposed to the upper end wall portion 12. It is to be noted that, when the unit is folded during insertion, the sponges 561 may be positioned above the base 563 instead of positioning the sponges below the base. In consequence, the sponges 561 can quickly be positioned at the upper end wall portion 12.

Next, the actuator 567 is driven to slightly rotate the holding arms 562, and the sponge unit 511 is shifted to the second state. Subsequently, as shown in FIG. 12, the sponges 561 are positioned between an outer wall surface of a protruding portion 13 and an inner surface of an inner portion of the end wall portion 12. In this state, while the container 1 or the sponge unit 511 is rotated around the axis, the suction unit 512 is driven to suck, into the sponges 561, the cleaning liquid attached to the outer wall surface of the protruding portion 13 and the inner surface of the inner portion of the end wall portion 12.

After the operation of this part is performed for a predetermined time, the sponges 561 are moved along the inner surface of the end wall portion 12, and the sponges 561 are slid downwards along the inner surface of the container 1 with which the sponges 561 come in contact. This operation is performed while the sponge unit 511 is moved downwards and the holding arms 562 are rotated by a predetermined angle in synchronization with the movement. Moreover, after the wiping treatment of the whole region of the inner surface of the upper end wall portion 12, the sponges 561 are further expanded to come in contact with the trunk portion 11. Moreover, while the suction unit 512 is similarly continued to be driven and the container 1 is relatively rotated around the axis, the sponges 561 are moved downwards. After the wiping treatment of the whole region of the inner surface of the trunk portion 11, the holding arms 562 are slightly rotated, and the sponges 561 perform the wiping treatment along the inner surface of the lower end wall portion 12.

Moreover, as shown in FIG. 13, the sponges 561 are moved to the vicinity of the lower protruding portion 13, and the remaining cleaning liquid of the lower space 18 is sucked by the sponges 561. In consequence, it is possible to appropriately suck and remove the cleaning liquid which does not naturally flow down from the opening 19 and remains in the space 18 owing to a returning structure of the protruding portion 13. While the cleaning liquid attached to the inner surface of the inner portion of the lower end wall portion 12 and the outer wall surface of the protruding portion 13 is sucked by the sponges 561, the wiping function is performed. In consequence, the wiping treatment of the whole region of the inner surface of the lower end wall portion 12 is completed.

Subsequently, the driving of the suction unit 512 is stopped. Moreover, before and after this stopping, the sponge unit 511 is slightly moved upwards, and the holding arms 562 are rotated and brought into the folded state (the first state). At this time, conversely to an inserting operation, it is preferable that the sponges 561 are positioned below the base 563. Finally, the sponge unit 511 is moved downwards and extracted from the container 1 via the opening 19. The sponges 561 are arranged so as to be opposed to the draining unit 550 shown in FIG. 10, and the cleaning liquid which can be absorbed by the sponges 561 is substantially completely removed by the draining unit 550.

As described above, according to the cleaning device 30 of the present embodiment, the inside of the container 1 can appropriately be subjected to a series of treatments of the cleaning, wiping and drying with good operability. Especially, the treatment member for the wiping treatment (the sponge unit 511) can be structured so as to expand from the folded state. Therefore, the sponge unit 511 can appropriately be inserted into the container 1 from the opening 19. Moreover, the sponges 561 can directly come in contact with the inner surface of the container 1. Therefore, the inner surface of the container 1 can evenly and quickly be wiped, and operability of the cleaning device can be improved.

It is to be noted that the arbitrary number of the sponges 561 may be mounted on the sponge unit 511. However, if the number of the sponges 561 is increased, the inner surface of the container can further quickly be wiped. The sponges 561 do not have to be connected to the suction unit 512, but it is preferable to perform both the wiping and the suction as described above. Furthermore, even when the sponge unit 511 is brought into the first state (the folded state), the inner surface of the container 1 may be wiped by the sponges 561. For example, when the upper end wall portion 12 is not provided with any protruding portion 13, the inner surface of the upper end wall portion 12 may be wiped with the folded and inserted sponges 561.

### Fifth Embodiment

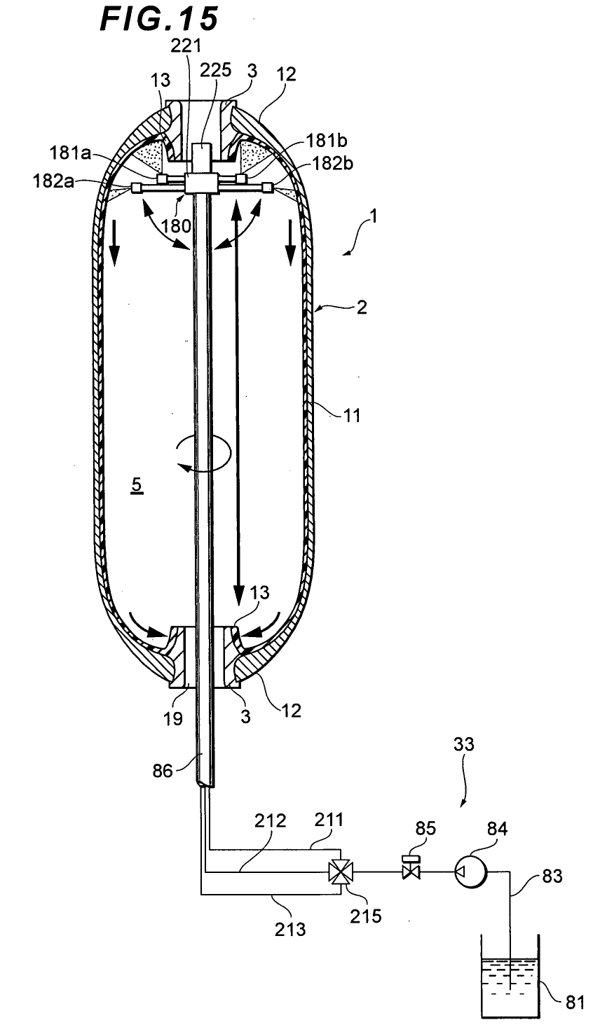

Next, different respects of a cleaning device 30 according to a fifth embodiment will mainly be described with reference to FIGS. 15 to 17. The embodiment is different from the fourth embodiment in that a structure of a nozzle (500) as a treatment member for a cleaning treatment is changed.

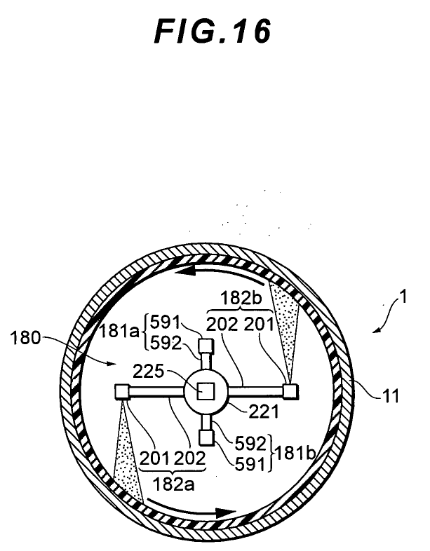

The nozzle of the fifth embodiment is constituted so as to be deformable between a first state (a folded state, a closed state) in which the nozzle can pass through an opening 19 and a second state (an expanded state, an opened state) in which the nozzle is a structure having a diameter larger than that of the opening 19 in the same manner as in a sponge unit 511 as a treatment member for a wiping treatment. It is to be noted that, as shown in FIGS. 15 and 16, the treatment member of the fifth embodiment corresponds to a nozzle assembly 180 including four nozzles 181a, 181b, 182a and 182b, and the nozzle assembly 180 is inserted into a container 1 along an axial direction of the container 1.

As shown in FIGS. 15 and 16, the four nozzles 181a, 181b, 182a and 182b are arranged at a pitch of 90 degrees. Two nozzles 181a, 181b arranged so as to face each other are preferably constituted so as to jet a cleaning liquid to inner surfaces of upper and lower end wall portions 12, 12. The two remaining nozzles 182a, 182b arranged so as to face each other are preferably constituted so as to jet the cleaning liquid to an inner surface of a trunk portion 11.

Each of the nozzles 181a, 181b has a jetting section 591 having a jetting port to jet the cleaning liquid, and a tubular arm section 592 including the jetting section 591 at a tip end portion thereof. The jetting sections 591, 591 come close to the inner surfaces of the upper and lower end wall portions 12, 12 of the container 1 to jet the cleaning liquid to the inner surfaces of the end wall portions 12. That is, the jetting sections 591, 591 function as operating sections which perform the cleaning treatment of the inner surfaces of the upper and lower end wall portions 12, 12.

The nozzles 181a, 181b are provided with a jetting port having an upward jetting directivity and a jetting port having a downward jetting directivity for the upper and lower end wall portions 12, 12. Therefore, each of the arm sections 592, 592 is constituted of, for example, a double tube structure, and has two passages which communicate with two types of jetting ports. As described later, when the two passages are switched, the nozzles 181a, 181b selectively jet the cleaning liquid upwards or downwards. It is to be noted that FIG. 15 shows one example of the upward jetting directivity, and the downwards jetting directivity is omitted.

Each of the nozzles 182a, 182b has a jetting section 201 having a jetting port which jets the cleaning liquid and a tubular arm section 202 including the jetting section 201 at a tip end portion thereof. The jetting sections 201, 201 come close to the inner surface of the trunk portion 11 to jet the cleaning liquid to this surface. That is, the jetting sections 201, 201 function as operating sections which perform the cleaning treatment of the inner surface of the trunk portion 11. The arm sections 202, 202 are provided with passages which communicate with the jetting ports.

The two passages of the arm section 592 and one passage of the arm section 202 described above communicate with individual hoses 211, 212 and 213 as a part of the cleaning hose 83 via a triple tube disposed in the pipe section 86. The other end of each of the three hoses 211, 212 and 213 is connected to an output port of a switch valve 215 including, for example, a four-way valve. An input port of the switch valve 215 is connected to the cleaning hose 83 on an upstream side, and the hose on the upstream side is connected to a cutoff valve 85, a pump 84 and a cleaning tank 81 in order. When the switch valve 215 switches, the cleaning liquid can selectively be supplied to the jetting port for the upper end wall portion 12, the jetting port for the lower end wall portion 12 and the jetting port for the trunk portion 11.

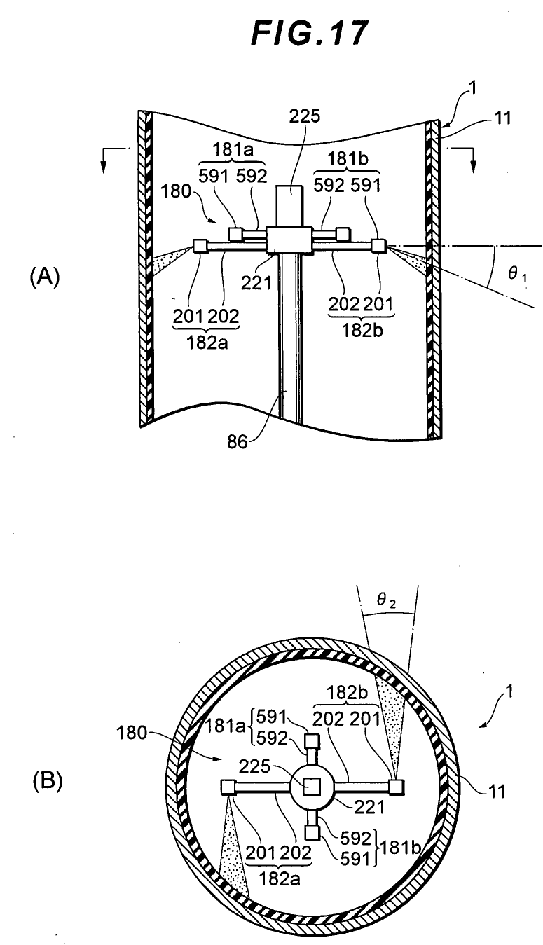

FIG. 17 is a diagram showing jetting directivities of the nozzles 182a, 182b for the trunk portion 11.

As shown in FIG. 17(A), the nozzles 182a, 182b have an jetting directivity obliquely below a reference plane so that a jetting direction of the cleaning liquid tilts below the plane (hereinafter referred to as the reference plane) crossing the axial direction of the container 1 at right angles. Preferably, a jetting angle θ₁ from the reference plane is an angle of dip of five to 30 degrees. When each nozzle is set to this jetting directivity, the jetted cleaning liquid forms a spiral flow. Therefore, cleanness of the inner surface of the trunk portion 11 can be improved.

As shown in FIG. 17(B), the nozzles 182a, 182b are constituted so as to be capable of jetting the cleaning liquid over a predetermined range along a peripheral direction of the trunk portion 11. It is preferable that in this predetermined range, a jetting angle θ₂ at the reference plane is 45 degrees or less. When the container 1 or the nozzles 182a, 182b rotate around an axis of the container 1, the cleaning liquid from the nozzles 182a, 182b collide with the whole region of the trunk portion 11 in the peripheral direction.

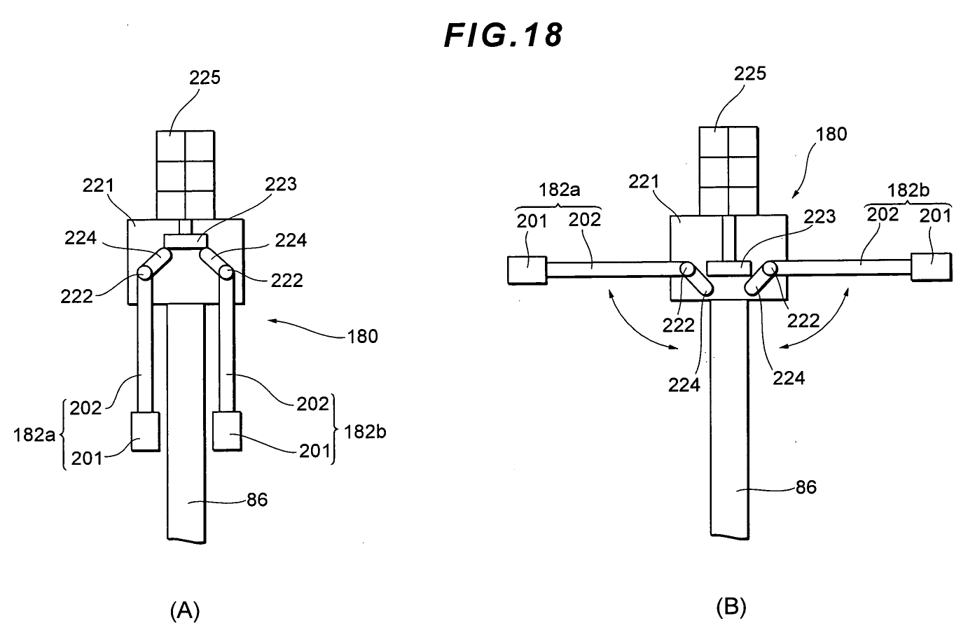

FIG. 18 is a diagram showing opening/closing (deformation) of the nozzles 182a, 182b. The arm sections 202, 202 are rotatably supported by a single common base 221 via hinges 222, 222. An upper portion of the common base 221 is provided with an air cylinder 225 (an actuator). A piston rod 223 of the air cylinder 225 comes in contact with input portions 224, 224 of the arm sections 202, 202.

When the air cylinder 225 is driven, the piston rod 223 moves forwards and backwards. In consequence, the arm sections 202, 202 rotate in a vertical plane including the hinges 222, 222 as support points. According to such a constitution, positions of the jetting sections 201, 201 in the diametric direction of a container main body 2 are regulated.

Although not shown, the nozzles 181a, 181b are similarly configured to be open and close. That is, when the air cylinder 225 is driven, the arm sections 592, 592 rotate in the vertical plane including the hinges as the support points supported by the common base 221 described above. In this case, two air cylinders 225 may be arranged so as to individually rotate the arm sections 592, 592 and the arm sections 202, 202. However, in the present embodiment, one air cylinder 225 is disposed, and four arm sections 592, 592, 202 and 202 are simultaneously rotated.

As shown in FIG. 18(A), when the arm sections 202, 202 are positioned so as to extend in the axial direction of the container 1, the nozzle assembly 180 comes in a first state as a structure having a diameter smaller than that of the opening 19. In other words, the first state may be referred to as a folded state or a closed state in the same manner as in the fourth embodiment.

As shown in FIG. 18(B), when the arm sections 202, 202 having the first state rotate about 90 degrees around the hinges 222, 222 as the support points supported by the common base 221, the jetting sections 201, 201 are positioned externally from an edge portion of the opening 19 in the diametric direction, and the state shifts to a second state in which the nozzle assembly 180 cannot pass through the opening 19 (cannot be inserted or extracted). In other words, this second state may be referred to as an expanded state or an opened state in the same manner as in the fourth embodiment. The jetting sections 201, 201 for the trunk portion 11 come closer to the inner surface of the trunk portion 11 in the second state than in the first state.

It is to be noted that positions of the jetting sections 201, 201 for the trunk portion 11 and the jetting sections 591, 591 for the end wall portion 12 deviate in the axial direction of the container 1 before the sections are expanded. As shown in FIGS. 15 and 16, each arm section 202 for the trunk portion 11 is constituted to be longer than the arm section 592 for the end wall portion 12. A reason for this setting is that, while the jetting sections 201, 201 easily come close to the inner surface of the trunk portion 11, the jetting sections 591, 591 deviate externally from a vertex (inner portions) of the end wall portion 12 in the diametric direction, and are not positioned at the vertex.

Here, operations of the nozzles 181a, 181b, 182 and 182b in a cleaning step (S1) shown in FIG. 11 will briefly be described.

First, the folded nozzle assembly 180 is inserted into the container 1 from the opening 19, and opposed to the upper end wall portion 12. Next, the air cylinder 225 is driven to rotate four arm sections 592, 592, 202 and 202, and the nozzle assembly 180 is shifted to the expanded state. In consequence, a state shown in FIG. 15 is obtained.

Subsequently, the cutoff valve 85 is opened to start driving the pump 84. Moreover, the switch valve 215 is switched, and the cleaning liquid is jetted from upwardly directed jetting ports of the nozzles 181a, 181b. In consequence, the cleaning liquid is jetted toward the upper end wall portion 12. At this time, for example, the rotation mechanism 39 rotates the container 1 or the nozzle assembly 180 around the axis of the container 1 to clean the whole inner surface of the end wall portion 12.

After elapse of a predetermined time, the switch valve 215 is switched, and the cleaning liquid is jetted from the nozzles 182a, 182b to perform the cleaning treatment of the inner surface of the trunk portion 11. The cleaning of the trunk portion 11 may be started after end of the cleaning of the upper end wall portion 12 or during the cleaning of the upper end wall portion 12. Moreover, the container 1 or the nozzle assembly 180 are rotated around the axis to allow the cleaning liquid to spirally collide with the inner surface of the trunk portion 11, the nozzle assembly 180 is moved downwards, and the cleaning of the whole inner surface of the trunk portion 11 is finally completed.

After the end of the cleaning of the trunk portion 11, when the nozzle assembly 180 is positioned in the vicinity of the lower end wall portion 12, the switch valve 215 is switched to jet the cleaning liquid from downwardly directed jetting ports of the nozzles 181a, 181b. In consequence, the cleaning liquid is jetted toward the lower end wall portion 12. At this time, in the same manner as described above, the container 1 or the nozzle assembly 180 is rotated around the axis of the container 1, and the whole inner surface of the lower end wall portion 12 is cleaned. In consequence, the whole region of an inner wall of the container 1 is cleaned to remove dirt.

After the cleaning, the driving of the pump 84 is stopped to close the cutoff valve 85. Moreover, before or after this operation, the air cylinder 225 is driven to return the nozzle assembly 180 to the folded state. Furthermore, the folded nozzle assembly 180 is extracted from the container 1 via the opening 19, and the step shifts to the next wiping step.

As described above, according to the cleaning device 30 of the fifth embodiment, since the nozzles (the nozzle assembly 180) for the cleaning treatment can be expanded from the folded state, the nozzles can appropriately be inserted into the container 1 from the opening 19. Since the jetting ports of the nozzles can come close to the inner surface of the container 1, a cleaning function can be improved. Furthermore, since the cleaning liquid jetted to the trunk portion 11 can form a spiral flow, a dirt removing performance can easily be improved.

It is to be noted that the nozzle assembly 180 is provided with the arbitrary number of the nozzles. A rack and pinion may be used in opening and closing the nozzles as in the fourth embodiment.

### Sixth Embodiment

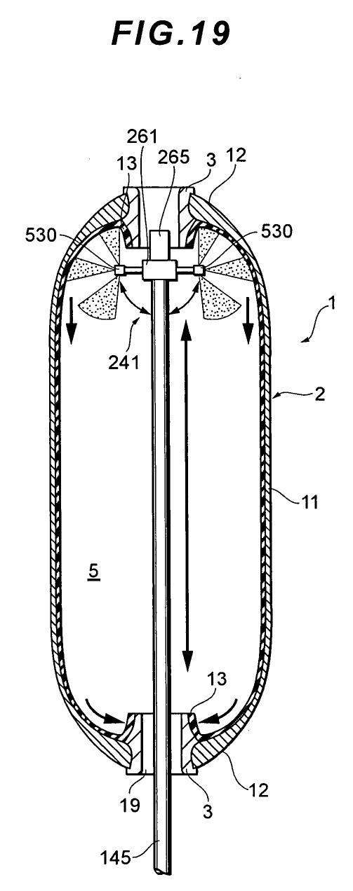

Next, different respects of a cleaning device 30 according to a sixth embodiment will mainly be described with reference to FIGS. 19 to 21. The embodiment is different from the fourth embodiment in that structures of nozzles (530) as treatment members for a drying treatment are changed.

The nozzles 530 of the sixth embodiment are deformable between a first state (a folded state, a closed state) in which the nozzles can pass through an opening 199 and a second state (an expanded state, an opened state) as a structure having a diameter larger than that of the opening 19 in the same manner as in nozzles (181a, 181b, 182a and 182b) for a cleaning treatment.

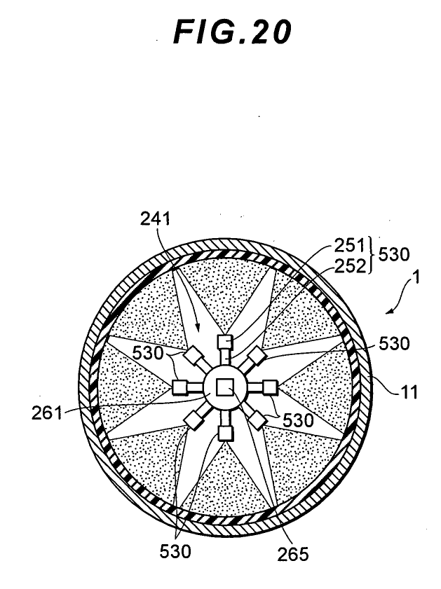

As shown in FIG. 20, the treatment member of the sixth embodiment is a nozzle assembly 241 including eight nozzles 530. The nozzle assembly 241 is inserted into a container 1 along an axial direction of the container 1. Eight nozzles 530 are arranged radially centering on an axis of the container 1 at a pitch of 45 degrees.

Each of the nozzles 530 has a jetting section 251 which jets hot air and a tubular arm section 252 including the jetting section 251 at a tip end portion thereof. The jetting section 251 has a jetting port having a jetting directivity of an outwardly upward direction, a jetting port having a jetting directivity of a lateral direction and a jetting port having a jetting directivity of an outwardly downward direction. The arm section 252 is provided with a passage which communicate with three jetting ports having different jetting directivities, and this passage communicate with a hose 543 for drying (see FIG. 9) via a pipe section 545.

The jetting port having the outwardly upward directivity is capable of jetting the hot air so as to allow the hot air to directly collide with mainly an upper end wall portion 12. The jetting port having the lateral directivity is capable of jetting the hot air so as to allow the hot air to directly collide with mainly a trunk portion 11. The jetting port having the outwardly downward directivity is capable of jetting the hot air so as to allow the hot air to directly collide with mainly a lower end wall portion 12.

Therefore, as shown in FIG. 19, the jetting sections 251 function as operating sections to jet the hot air in multiple directions including an obliquely upward direction, a lateral direction and an obliquely downward direction and perform the drying treatment of an inner surface of the container 1. It is to be noted that in the same manner as in the jetting directivity of the fifth embodiment, the jetting port of the lateral directivity may be set so as to slant downwards from a plane where a jetting direction of the hot air crosses the axial direction of the container 1 at right angles.

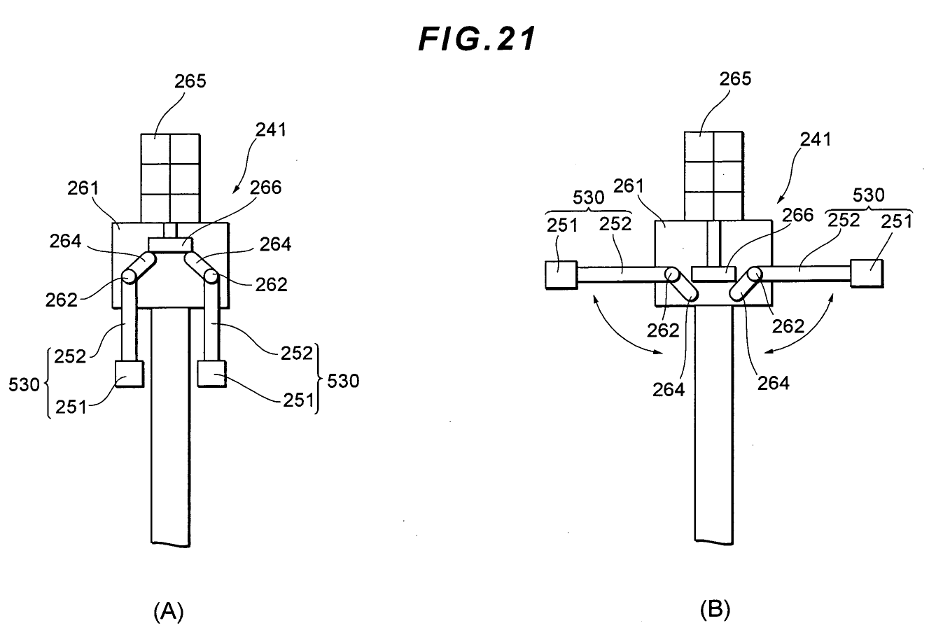

FIG. 21 is a diagram showing opening and closing of two nozzles 530.

Each of the nozzles 530 has an opening and closing structure (a folded structure) in the same manner as in the nozzle 181a of the fifth embodiment, and the arm section 252 is rotatably constituted so as to open and close around a common base 261 as a support point.

Specifically, the arm sections 252 are rotatably supported by the common base 261 via hinges 262, and input portions 264 of the arm sections 252 come in contact with a piston rod 266 as an output portion of an air cylinder 265. When the air cylinder 265 is driven, the arm sections 252 rotate around the hinges 262 as support points in a vertical plane via the piston rod 266.

As shown in FIG. 21(A), when the arm sections 252 are positioned so as to extend in the axial direction of the container 1, the nozzle assembly 241 comes in a first state as a structure having a diameter smaller than an inner diameter of the opening 19. In other words, the first state may be referred to as a folded state or a closed state in the same manner as in the above embodiments.

As shown in FIG. 21(B), when the nozzles 530 having the first state rotate about 90 degrees so as to expand, the jetting sections 251 are positioned externally from an edge portion of the opening 19 in a diametric direction so as to come close to the inner surface of the trunk portion 11 as compared with the first state. That is, the nozzle assembly 241 shifts to a second state in which the nozzle assembly cannot pass through the opening 19 (cannot be inserted or extracted). In other words, this second state may be referred to as an expanded state or an opened state in the same manner as in the above embodiments.

Here, operations of the nozzles 530 in a drying step (S3) shown in FIG. 11 will briefly be described.

First, the folded nozzle assembly 241 is inserted into the container 1 from the opening 19, and opposed to the upper end wall portion 12. Next, the air cylinder 265 is driven to rotate all of eight arm sections 252, and the nozzle assembly 241 is shifted to the expanded state. In consequence, a state shown in FIG. 19 is obtained.

Subsequently, a cutoff valve 544 is opened to drive a compressor 541 and a heater 542, and the hot air is jetted from the nozzles 530 in multiple directions. In consequence, the hot air is jetted toward a vertex of the upper end wall portion 12, a boundary portion between the end wall portion 12 and the trunk portion 11 and the like. Moreover, the nozzle assembly 241 is moved downward to finally dry the whole inner surface of the trunk portion 11 and the whole inner surface of the lower end wall portion 12.

It is to be noted that during jetting of this hot air, the driving of the air cylinder 265 may be controlled so as to regulate the nozzle assembly 241 having the second state into a half opened state or a fully opened state. For example, in a case where the hot air is to be jetted toward protruding portions 13, the nozzle assembly 241 may be brought into the half opened state. During the jetting of the hot air, the nozzle assembly 241 may appropriately be moved up and down, and the container 1 may be rotated by the rotation mechanism 39. A temperature of the hot air may be regulated into 70 to 80° C. in relation to a material (a resin) of the container 1 as described above.

After drying the whole inner surface of the container 1, the driving of the compressor 541 and the heater 542 is stopped to close the cutoff valve 544. Moreover, before and after this stopping, the air cylinder 265 is driven to return the nozzle assembly 241 to the folded state. Moreover, when the folded nozzle assembly 241 is extracted from the container 1 via the opening 19, a series of treatments of the container 1 performed by the cleaning device 30 end.

As described above, according to the cleaning device 30 of the sixth embodiment, since the nozzles 530 for the drying treatment are structured to be expandable from the folded state, the nozzles can appropriately be inserted into the container 1 from the opening 19. Since the nozzles 530 can be expanded in the container 1, the jetting ports of the nozzles 530 can come close to the inner surface of the container 1, and the whole inner surface of the container 1 can uniformly and quickly be dried.

It is to be noted that the nozzle assembly 241 is provided with the arbitrary number of the nozzles 530. A rack and pinion may be used in opening and closing the nozzles 530 as in the fourth embodiment.

### Seventh Embodiment

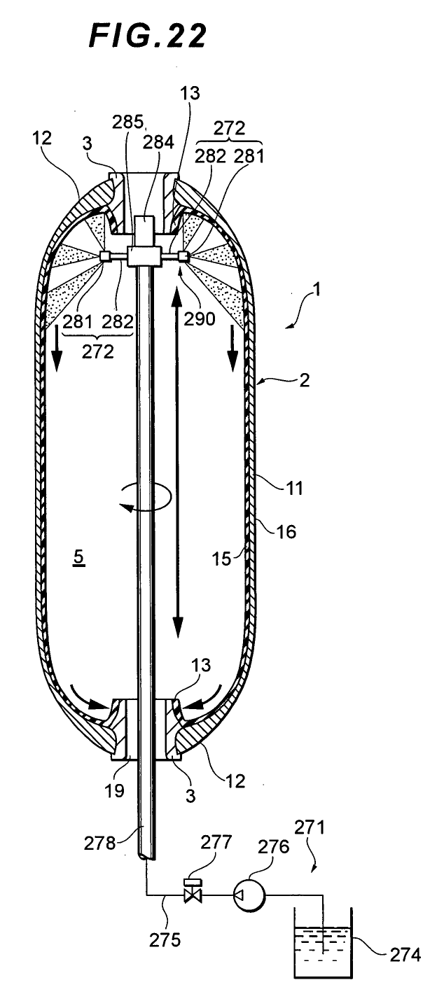

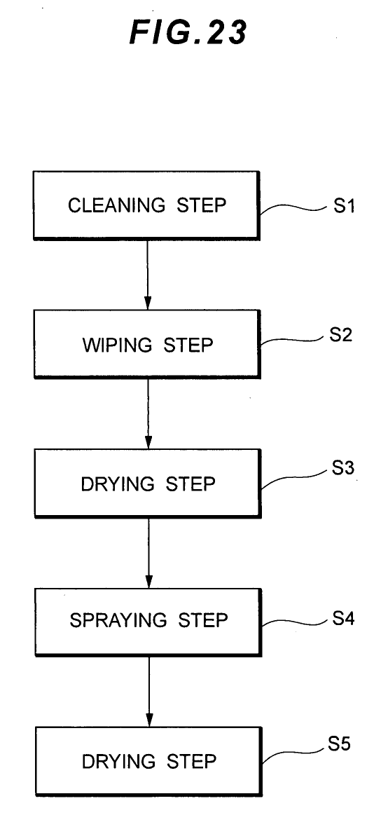

Next, different respects of a cleaning device 30 according to a seventh embodiment will mainly be described with reference to FIGS. 22 and 23. The embodiment is different from the fourth embodiment in that a spraying mechanism 271 which sprays a gas permeation inhibitor to an inner surface of a container 1 is provided at the cleaning device 30, and a structure of a treatment member of this spraying mechanism 271 is devised.

As shown in FIG. 22, the spraying mechanism 271 has nozzles 272 as treatment members which perform a permeation inhibiting treatment in the container 1, and supplies the gas permeation inhibitor to the nozzles 272. The spraying mechanism 271 sprays the gas permeation inhibitor from the nozzles 272 inserted into the container 1 to form a gas permeation inhibiting layer on an inner wall of the container 1, that is, an inner surface of a resin liner 15. It is to be noted that, although not shown, the cleaning device 30 is provided with various unit constitutions such as a support mechanism 31 which supports the container 1, a movement mechanism 38 which relatively moves the nozzles 272 and a rotation mechanism 39 which relatively rotates the container 1 as shown in FIG. 9.

The spraying mechanism 271 has a tank 274 in which a predetermined amount of the gas permeation inhibitor is stored, a hose 275 having flexibility, a pump 276 which feeds the gas permeation inhibitor under pressure from the tank 274 to the nozzles 272 and a cutoff valve 277 which opens and closes the hose 275. One end of the hose 275 is connected to the inside of the tank 274, and the other end thereof is connected to a pipe section 278 which communicate with the nozzles 272.

The gas permeation inhibitor is formed by forming a resin such as polyamide or polyester mixed with a gas impermeable material into a solution. Here, the gas impermeable material is a material having a gas permeability lower than that of the resin liner 15 as a resin base material of the container 1, or a gas adsorptivity higher than that of the liner. The gas impermeable material of the gas container 1 for storing a hydrogen gas may be constituted of a material having a hydrogen adsorptive performance, and examples of the material include a hydrogen occlusion alloy, carbon particles, an active carbon fiber, active carbon powder, and a carbon nano tube and a flat ceramic.

Only one type of these gas impermeable materials may be used, or two or more types of the materials may arbitrarily be combined for use. When the inner surface of the resin liner 15 is coated with the gas permeation inhibitor including such a gas impermeable material, the hydrogen gas which is to permeate a reinforcing layer 16 from the resin liner 15 is adsorbed. In consequence, permeation of the hydrogen gas is inhibited.

On the other hand, the gas impermeable material may be constituted of a material which does not have any hydrogen adsorbing performance, for example, metal material powder such as aluminum powder. When the inner surface of the resin liner 15 is coated with the gas permeation inhibitor including the gas impermeable material formed of such aluminum powder or the like, the hydrogen gas in the resin liner 15 is to permeate the reinforcing layer 16 from the resin liner 15 so as to avoid the gas impermeable material. The aluminum powder or the like functions so as to lengthen a permeation path of the hydrogen gas in this manner. In consequence, a permeation amount of the hydrogen gas per unit time is reduced. It is to be noted that as the gas impermeable material, a mixture of the hydrogen occlusion alloy or the like having a hydrogen adsorbing performance and the aluminum powder or the like which does not have any hydrogen adsorbing performance may be used.

The nozzles 272 are constituted in the same manner as in the nozzles 530 of the sixth embodiment, and each of the nozzles has a spraying section 281 which sprays the gas permeation inhibitor and a tubular arm section 282 including the spraying section 281 at a tip end portion thereof. The spraying section 281 is provided with spraying ports having three spraying directivities of an outwardly upward direction, a lateral direction and an outwardly downward direction. The spraying section 281 functions as an operating section to perform the permeation inhibiting treatment of the inner surface of the container 1.

The arm section 282 is provided with a passage which communicates with the spraying ports of the spraying section 281, and this passage communicates with the hose 275 via the pipe section 278. The arm section 282 is constituted to be openable and closable so as to rotate around a common base 285 as a support point, when an air cylinder 284 is driven. According to the above constitution, the nozzles 272 are deformed between a first state (a folded state, a closed state) in which the nozzles can pass through an opening 19 and a second state (an expanded state, an opened state) as a structure having a diameter larger than that of the opening 19 in the same manner as in the sixth embodiment.

Therefore, a nozzle assembly 290 including, for example, eight nozzles 272 is inserted into the container 1 and extracted from the container 1 in the first state. When the air cylinder 284 is driven so as to expand the spraying sections 281 as shown in FIG. 22, the nozzle assembly 290 which has shifted to the second state preferably sprays the gas permeation inhibitor from the spraying sections 281 to the inner surface of the container 1.

FIG. 23 is a flow chart of a series of treatments to be performed by the cleaning device 30 according to the seventh embodiment. In the series of treatments to be performed by the cleaning device 30, subsequent to a cleaning step (S1), a wiping step (S2) and a drying step (S3) described above, a spraying step (S4) is performed by the spraying mechanism 271.

In the spraying step (S4), the folded nozzle assembly 290 is inserted into the container 1 from the opening 19, and the nozzle assembly 290 is shifted to the expanded state in the vicinity of an upper end wall portion 12. Subsequently, the cutoff valve 277 is opened to drive the pump 276, and the gas permeation inhibitor is sprayed from the nozzles 272 in the multiple directions. At this time, if necessary, the movement mechanism 38 and the rotation mechanism 39 are driven to vertically move or rotate the nozzles 272 and the container 1 so that the whole region of the inner surface of the resin liner 15 (the upper end wall portion 12, a lower end wall portion 12, a trunk portion 11 and upper and lower protruding portions 13, 13) is uniformly coated with the gas permeation inhibitor.

It is to be noted that during spraying of this gas permeation inhibitor, the air cylinder 284 may be controlled so as to regulate the nozzle assembly 290 having the second state into the half opened state or the fully opened state. For example, to spray the gas permeation inhibitor toward the protruding portions 13 or the like, the nozzle assembly 290 may be brought into the half opened state.

After end of the spraying step, the driving of the pump 276 is stopped to close the cutoff valve 277, and the nozzle assembly 290 returned to the folded state is extracted from the container 1 via the opening 19. In the next drying step (S5), the gas permeation inhibitor with which the container 1 is coated is dried using a drying mechanism 37 used in the drying step S3 again. In consequence, the gas permeation inhibiting layer is formed on the inner surface of the resin liner 15, and a series of treatments by the cleaning device 30 end. Finally, the container 1 is removed from the support mechanism 31, and the container 1 is mounted on, for example, a fuel cell system.

As described above, according to the seventh embodiment, the gas permeation inhibiting layer can be formed on the inner surface of the container 1 by effectively using the cleaning device 30. Especially, subsequently to the cleaning and drying of the container 1, the permeation inhibiting treatment is performed to form the gas permeation inhibiting layer on the inner surface of the clean container 1. Therefore, it is possible to improve a close contact property between the inner surface of the container 1 and the gas permeation inhibiting layer. Since the permeation inhibiting treatment can continuously be performed subsequently to the cleaning and drying of the container 1, equipments and steps can be simplified as a whole.

Furthermore, since the nozzles 272 are of a foldable system (an opening and closing structure system), the nozzles 272 can appropriately be inserted into the container 1 from the opening 19. The nozzles 272 can be expanded so that the spraying sections 281 can appropriately come close to the inner surface of the container 1, and the gas permeation inhibiting layer can be formed without any unevenness. Furthermore, in the container 1, the permeation of the gas can appropriately be inhibited over a long period. It is to be noted that an inner surface of the gas permeation inhibiting layer may further be coated with a protective layer. The protective layer may be formed of, for example, the same resin as that of the gas permeation inhibitor formed into the solution.

### Eighth Embodiment

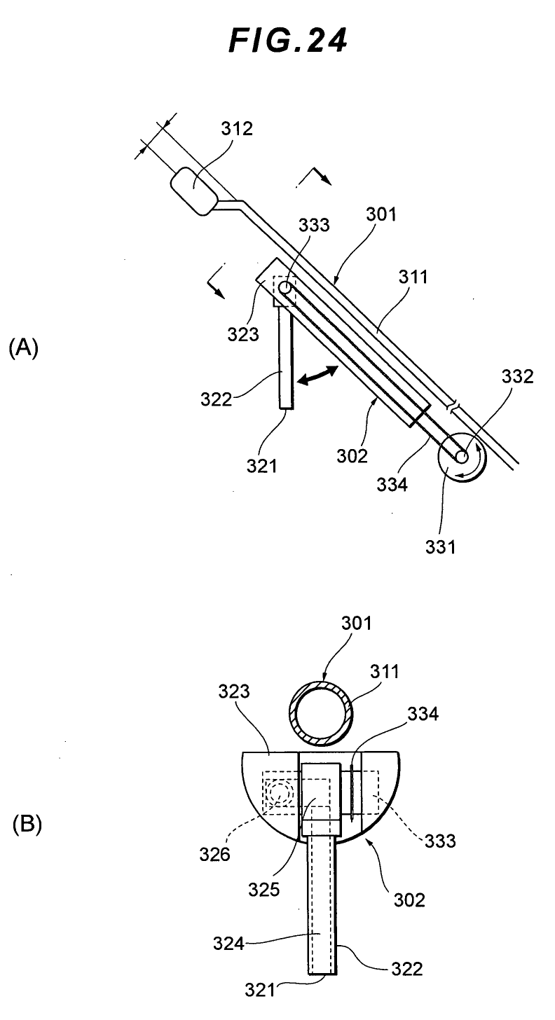

Next, different respects of a cleaning device 30 according to an eighth embodiment will mainly be described with reference to FIGS. 24 to 31. The embodiment is different from the fourth embodiment in that after a cleaning step (see FIG. 11: S1), a container 1 is not subjected to a wiping step (FIG. 11: S2), and a suction treatment is performed to such residuals from the container 1 while performing a blowing treatment to drain an inner surface of the container 1.

FIG. 24 shows a blowing nozzle 301 which performs the blowing treatment and a suction nozzle 302 which performs the suction treatment.

The blowing nozzle 301 includes a pipe section 311 through which a fluid for blowing flows and an jetting section 312 provided at a tip end portion of the pipe section 311. As the fluid for blowing, an inactive gas such as nitrogen may be used, but compressed air is used in the present embodiment.

The jetting section 312 has jetting ports (not shown) which jet the compressed air to an inner wall of the container 1. That is, the jetting section 312 performs the blowing treatment to jet the compressed air to an inner surface of the container 1 and blow off a cleaning liquid attached to the inner surface of the container 1. Positions and jetting directivities of the jetting ports may be set so that any deal angle is not generated at the inner surface of the container 1.

The pipe section 311 is made of a hard resin. The compressed air is supplied from a base end side of the pipe section 311 to the jetting section 312 by a blowing mechanism (not shown) incorporated in the cleaning device 30. The blowing mechanism may include, for example, a compressor which takes in air, a hose which connects the compressor to the pipe section 311 and a cutoff valve which opens and closes the hose (see FIGS. 2 and 3).

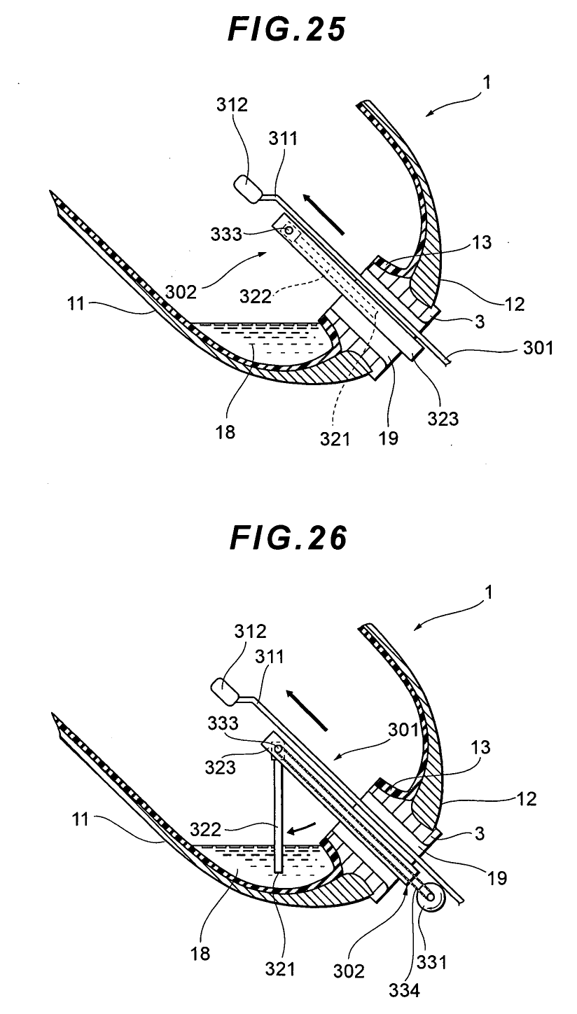

In the present embodiment, the container 1 is tilted and supported so that an opening 19 opens obliquely downwards (see FIG. 25). Therefore, the whole blowing nozzle 301 is tilted along a tilted axial direction of the container 1, and the blowing nozzle 301 is inserted or extracted with respect to the inside of the container 1 from the opening 19 by a movement mechanism 38 described in the fourth embodiment. During this insertion or extraction, the blowing nozzle 301 and the suction nozzle 302 simultaneously pass through the opening 19. At this time, a shape of the blowing nozzle 301 can be devised so as to secure a clearance in the opening 19. Specifically, the pipe section 311 extends eccentrically with respect to an axis of the container 1. Moreover, the jetting section 312 is positioned along the axis of the container 1 so that the compressed air evenly collides with the inner surface of the container 1.

The suction nozzle 302 has a straw section 322 having a suction port 321 at a tip end thereof, a base section 323 which rotatably supports a shaft portion 333 on the side of a base end of the straw section 322, and a pipe section 326 which is disposed in the base section 323 and which communicate with a suction passage 324 of the straw section 322 via a communication passage 325. The straw section 322 function as an operating section which performs the suction treatment to suck residuals from the container 1 with respect to the inside an the inner surface of the container 1.

The pipe section 326 is made of a hard resin. The pipe section 326 and the base section 323 extend in parallel with an extending direction of the pipe section 311 of the blowing nozzle 301. In a state in which the suction nozzle 302 and the blowing nozzle 301 are inserted into the container 1, a predetermined clearance is formed between these nozzles and an inner peripheral wall of a mouthpiece 3. It is to be noted that the suction nozzle 302 and the blowing nozzle 301 are constituted to be movable in the axial direction of the container 1 by the movement mechanism 38 described in the fourth embodiment, and the nozzles are constituted to be movable in the axial direction of the container 1 independently of each other.

The end of the pipe section 326 is connected to a suction mechanism (not shown) incorporated in the cleaning device 30. When this suction mechanism is driven, a suction force is applied to the suction port 321. The suction mechanism may include, for example, a suction pump, a hose connected to the pipe section 326, a cutoff valve which opens and closes the hose and a recovery tank which recovers the sucked cleaning liquid in the same manner as in the suction unit 512 of the fourth embodiment.

Moreover, the suction nozzle 302 has a rotary actuator 331 such as a motor, and a wire 334 extended between an output portion 332 of the rotary actuator 331 and a shaft portion 333 of the straw section 322. The rotary actuator 331 is driven to draw around the wire 334, and the straw section 322 rotates around the shaft portion 333 as a support point. In this case, the straw section 322 is constituted to be rotatable between a state (see FIG. 25) in which the straw section is stored in the base section 323 and a state (see FIG. 24(A)) in which the straw section is exposed (protruded) from the base section 323 to extend in a vertical direction.

That is, when the straw section 322 rotates to a position where the straw section is stored in the base section 323, the suction nozzle 302 (the treatment member) shifts to a first state (a closed state, a folded state) in which the suction nozzle can pass through the opening 19 of the container 1. When the straw section 322 rotates from this first state, the suction nozzle 302 shifts to a second state (an opened state, an expanded state) in which the nozzle cannot pass through the opening 19. In the second state in which the straw section 322 extends in a vertical direction and the suction port 321 opens downwards, the suction nozzle 302 sucks residuals from the container 1 via the suction port 321.

Here, the blowing treatment and the suction treatment will be described with reference to FIGS. 25 to 30.

First, it is assumed that the container 1 is tilted and supported by a support mechanism 31 described in the fourth embodiment so that the opening 19 opens obliquely downwards. At this time, a tilt angle of the container 1 in the axial direction is 30 to 60 degrees from a horizontal direction. For example, from a viewpoint of suppressing a height of the supported container 1, an angle of 35 degrees is preferable. In this state, the container 1 is subjected to the cleaning step.

After the cleaning step, in the container 1, the cleaning liquid which has not been naturally discharged from the opening 19 is accumulated in a space 18 in a concentrated manner, because a structure of a protruding portion 13 and the container 1 are tilted. In a state in which residuals are accumulated in this manner, as the next treatments, the blowing treatment by the blowing nozzle 301 and the suction treatment by the suction nozzle 302 are performed.

As shown in FIG. 25, together with the suction nozzle 302 having the first state in which the straw section 322 is stored, the blowing nozzle 301 is inserted into the container 1 from the opening 19. Subsequently, as shown in FIG. 26, the suction nozzle 302 and the blowing nozzle 301 are inserted as much as such a length that the straw section 322 is extracted from the base section 323, that is, at a position where the straw section 322 is not caught by the protruding portion 13. Subsequently, the rotary actuator 331 outside the container 1 is driven to rotate the straw section 322 in the vertical direction. In consequence, the suction nozzle 302 shifts to the second state so that the straw section 322 comes close to the inner surface of the container 1.

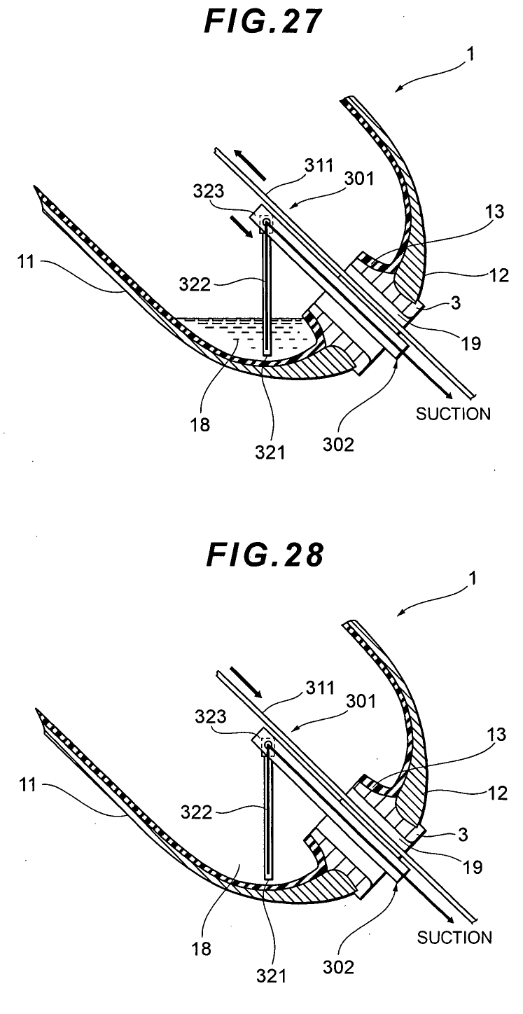

Subsequently, as shown in FIG. 27, the blowing nozzle 301 and the suction nozzle 302 are slightly moved in an extracting direction so that the suction port 321 of the straw section 322 is positioned at a lowermost portion of the container 1. In consequence, the position of the suction port 321 of the straw section 322 is subtly regulated in a diametric direction of the container 1, and the suction port 321 is opposed to a portion of an end wall portion 12 of the container 1 having the smallest height level. Since the straw section 322 is made of the hard resin as described above, the suction port 321 is securely positioned at a bottommost portion of the end wall portion 12.

Subsequently, a position of the suction nozzle 302 is fixed, and suction of residuals by the suction nozzle 302 is started. Moreover, the only blowing nozzle 301 is inserted to an innermost portion of the container 1 by the movement mechanism 38. At this time, the blowing treatment by the blowing nozzle 301 is not started yet. Furthermore, when the blowing nozzle 301 reaches the vicinity of the upper end wall portion 12, the blowing nozzle 301 starts jetting the compressed air.

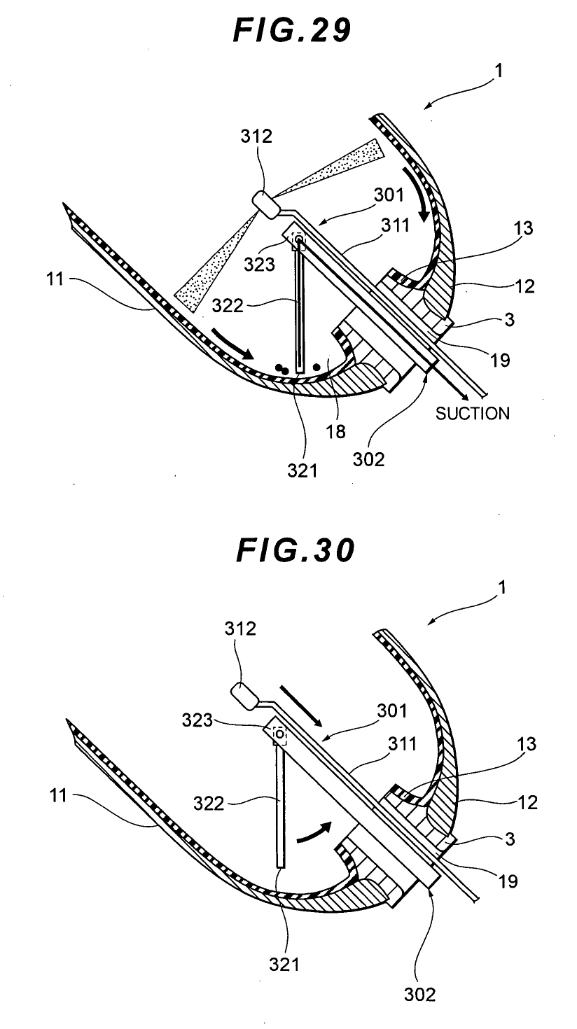

Subsequently, as shown in FIG. 28, while continuing the suction by the suction nozzle 302, the only blowing nozzle 301 that is jetting the compressed air is moved in the extracting direction. In consequence, the container 1 is successively drained from the inner surface of the upper end wall portion 12 to the inner surface of a trunk portion 11. Moreover, as shown in FIG. 29, when the blowing nozzle 301 reaches the lower end wall portion 12, the greater part of the residuals in the space 18 is discharged from the suction nozzle 302 to the recovery tank. Therefore, the compressed air from the blowing nozzle 301 can directly collide with the inner surface of the lower end wall portion 12, and the inner surface of the lower end wall portion 12 is appropriately drained. At this time, cleaning liquid droplets scratched off to the space 18 by the blowing nozzle 301 are sucked and removed by the suction nozzle 302.

It is to be noted that when the greater part of the residuals is removed from the space 18 (e.g., FIG. 29), the straw section 322 is rotated, the suction nozzle 302 is synchronously moved in an inserting or extracting direction, and the suction port 321 may be moved along the inner surface of the lower end wall portion 12. In consequence, the cleaning liquid droplets which have dropped down to the end wall portion 12 can further be removed. During at least one of the suction treatment and the blowing treatment, the container 1 may be rotated around the axis, and at least one of the suction nozzle 302 and the blowing nozzle 301 may be rotated around the axis of the container 1.

When the blowing of the whole inner surface of the container 1 is completed and the residuals in the container 1 are eliminated (e.g., after elapse of about 30 seconds after the blowing nozzle 301 reaches a lowermost end), the suction and air blowing end. Subsequently, as shown in FIG. 30, an operation reverse to that during the insertion is performed. That is, the suction nozzle 302 is slightly moved in the inserting direction (to an inner part), the straw section 322 is stored, and the suction nozzle 302 which has shifted to the first state is extracted from the container 1 via the opening 19 together with the blowing nozzle 301. In consequence, a blowing step and a suction step end, and a series of treatments by the cleaning device 30 shift to, for example, the next drying step (FIG. 11: S3).

As described above, according to the eighth embodiment, after the cleaning of the container 1, while the inner surface of the container 1 is subjected to draining and blowing, the residuals in the container 1 can be sucked and removed. Especially, since the suction nozzle 302 is of a folded system (an opening and closing structure system), the suction nozzle 302 can appropriately be inserted into the container 1 from the opening 19. The suction nozzle 302 is expanded so that the suction port 321 can appropriately come close to the inner surface of the container 1. In consequence, the cleaning liquid remaining in the space 18 can securely be discharged from the container 1.

It is to be noted that the blowing nozzle 301 may be structured to be foldable and expandable in the same manner as in the suction nozzle 302 and the nozzles of the fourth to seventh embodiments. In this case, the jetting section 312 of the blowing nozzle 301 may function as an operating section which performs the blowing treatment of the inner surface of the container 1.

### Ninth Embodiment

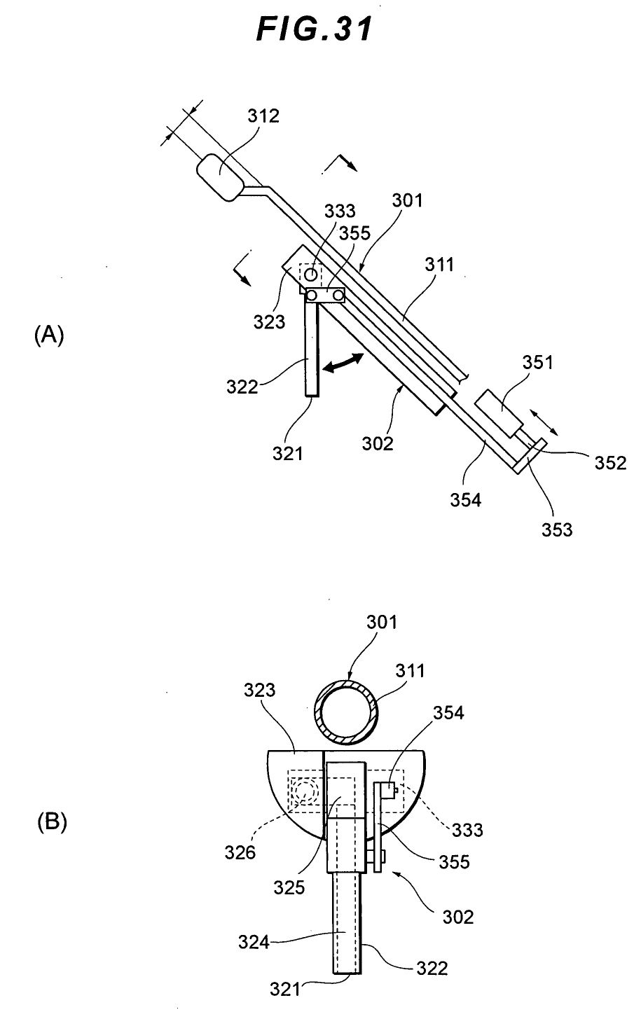

Next, different respects of a cleaning device 30 according to a ninth embodiment will mainly be described with reference to FIG. 31. The embodiment is different from the eighth embodiment in that as a driving source for rotating a straw section 322, an air cylinder 351 is used instead of a rotary actuator 331.

The air cylinder 351 is disposed outside a container 1, and a plate 353 is attached to an output portion 352 of the air cylinder 351. The plate 353 is connected to one end of a driving bar 354 which extends in parallel with an axial direction of the container 1, and the other end of the driving bar 354 is connected to the straw section 322 by a link 355.

According to such a constitution, when the air cylinder 351 is driven, the straw section 322 rotates around a shaft portion 333 as a support point via the plate 353, the driving bar 354 and the link 355. In consequence, the suction nozzle 302 is structured to be foldable and expandable in the same manner as in the eighth embodiment. It is to be noted that since another respect is the same as that of the eighth embodiment, detailed description thereof is omitted.

It is to be noted that in the above fourth to ninth embodiments, the treatment member which performs various predetermined treatments (cleaning, wiping, drying, permeation inhibiting, blowing and suction) is expanded from a folded state by use of a driving source such as the air cylinder or the rotary actuator. However, needless to say, these sources do not have to be used. For example, the treatment member may be constituted to be foldable and expandable in accordance with a pressure of a fluid to be supplied to the treatment member or in a mechanically structural manner. For example, when supply pressures of a cleaning liquid, hot air, a gas permeation inhibitor and compressed air to various treatment members are increased, or when a suction pressure to various treatment members is increased, various treatment members may be expanded.

### Tenth to Fourteenth Embodiments

A cleaning device 30 according to tenth to fourteenth embodiments suitable for cleaning a container 1 shown in FIG. 5 will hereinafter be described. In description of each embodiment, the same constituting units or structures as those of the first embodiment are denoted with the same reference numerals as those of the first embodiment, and description thereof is appropriately omitted. The tenth to fourteenth embodiments have a characteristic that nozzles as treatment members are constituted to perform predetermined treatments in the container in accordance with a shape of the inside of the container. Specifically, the nozzle is constituted so that a jetting directivity of a fluid can be changed in accordance with a position of the nozzle in an axial direction of the container 1. It is to be noted that in and after the eleventh embodiment, the same part as that of a structure of the tenth embodiment is denoted with the same reference numerals of the tenth embodiment, and description thereof is omitted.

### Tenth Embodiment

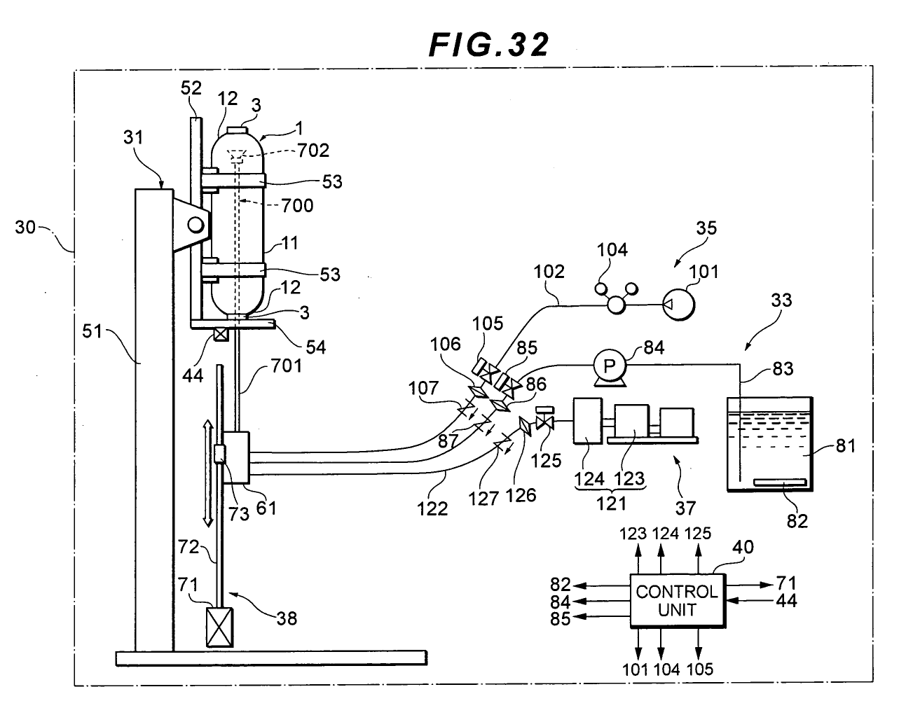

FIG. 32 is a system diagram schematically showing a constitution of a cleaning device 30, and is a diagram showing that a nozzle 700 as a jetting member (a treatment member) is inserted into a container 1.

The cleaning device 30 includes a support mechanism 31, a cleaning mechanism 33, a blowing mechanism 35, a drying mechanism 37, a movement mechanism 38 and a control unit 40 which generally controls these mechanisms (33, 35, 37 and 38) in the same manner as in the first embodiment, and further includes a position detecting unit 44 which detects a position of the nozzle 700. The cleaning device 30 executes a series of treatments including cleaning with a cleaning liquid, draining with compressed air and drying with hot air by use of the nozzle 700 with respect to the inside of the container 1 supported by the support mechanism 31.

The support mechanism 31 supports the container 1 in a state in which a mouthpiece 3 is directed downwards. The support mechanism 31 has a stand 51, a support member 52, holding mechanisms 53, 53 and a lower plate 54 as described above. During a series of treatments, an upper mouthpiece 3 of the container 1 is connected to a plug (not shown). On the other hand, the lower mouthpiece 3 of the container 1 is opened downwards. It is to be noted that, although not shown, a rotation mechanism which rotates the container 1 around an axis of the container may be disposed between the pair of holding mechanisms 53, 53 or the like. In consequence, during driving of at least one of the cleaning mechanism 33, the blowing mechanism 35 and the drying mechanism 37, the container 1 can be rotated.

Predetermined fluids to be jetted by the nozzle 700 are the cleaning liquid, compressed air and hot air. To individually jet these three fluids, three nozzles 700 independent of one another are prepared. The three nozzles 700 are connected to the cleaning mechanism 33, the blowing mechanism 35 and the drying mechanism 37, and are switched in cleaning, draining and drying steps during a series of treatments. It is to be noted that FIG. 32 shows only one nozzle 700.

The nozzle 700 includes a pipe 701 through which the predetermined fluid flows, and a jetting section 702 which is disposed at a tip end portion of the pipe 701 and which jets the predetermined fluid. The jetting section 702 is constituted so that a jetting directivity of the fluid with respect to an inner wall of the container 1 can be varied as described later. The pipe 701 is formed of a hard material and extends in an axial direction of the container 1. The pipe 701 and the jetting section 702 are constituted so as to pass through an opening 19 of the mouthpiece 3. In a state in which these components are inserted into the container 1, a predetermined gap is formed between the pipe 701 and the mouthpiece 3. The used cleaning liquid discharged from this gap is stored in a drain pan.

The cleaning mechanism 33 has a cleaning tank 81, a heater 82, a cleaning hose 83, a pump 84, a cutoff valve 85, a pipe section 86 and a cutoff valve 87 in the same manner as in the first embodiment and the like. One end of the cleaning hose 83 is connected to the pipe 701 of the nozzle 700 at a support base 61.

The blowing mechanism 35 has a compressor 101, a blowing hose 102, a pressure regulator 104, a cutoff valve 105, a filter 106 and a check valve 107 in the same manner as in the first embodiment and the like. One end of the blowing hose 102 is connected to the pipe 701 at the support base 61.

The drying mechanism 37 has a hot air generation unit 121 having a compressor 123 and a heater 124, and a drying hose 122 connected to the pipe 701 at the support base 61 in the same manner as in the first embodiment. The drying hose 122 is provided with a cutoff valve 125, a filter 126 and a check valve 127.

The movement mechanism 38 includes, for example, the support base 61, a motor 71, a ball screw 72 and a ball nut 73 described above, and the support base 61 is connected to the ball nut 73 and further supports the nozzle 700. The nozzle 700 is constituted to be movable along the axial direction of the container 1 by the movement mechanism 38.

It is to be noted that the motor 71 may be constituted of another actuator such as an air cylinder, a helical rail may be used instead of the ball screw 72 and the ball nut 73, and a rack and pinion constitution may be used. Instead of moving the nozzle 700, the nozzle 700 is fixedly arranged, and the container 1 may be moved in the axial direction of the container with respect to this nozzle. That is, the movement mechanism 38 may be constituted so that the nozzle 700 is relatively moved along the axial direction of the container 1 with respect to the container 1.

The position detecting unit 44 detects a position of the jetting section 702 of the nozzle 700 in the axial direction of the container 1. The position detecting unit 44 detects the position of the jetting section 702 in accordance with, for example, a position of the pipe 701 with respect to the container 1 in the axial direction. Various sensors may be applied to the position detecting unit 44. It is assumed that the position detecting unit 44 uses, for example, displacement of the pipe 701, and the mechanism may be constituted of an optical sensor such as a linear encoder, a laser type sensor in which diffraction or interference of laser light is utilized, a magnetic sensor using a magnetic scale or the like. Alternatively, the position detecting unit 44 may be constituted of a tachogenerator, an encoder or the like which detects the number of rotations of the motor 71 of the movement mechanism 38, or a camera or the like which recognizes a predetermined portion of the pipe 701 or the jetting section 702. The position detecting unit 44 is connected to the control unit 40, and a detection result of the position detecting unit is input into the control unit 40.

Although not shown, the control unit 40 (ECU) has a CPU, an ROM, an RAM and an input/output interface, and these components are connected to one another via a bus. While the control unit 40 successively switches the nozzles 700 of jetting functions, the control unit drives and controls the cleaning mechanism 33, the blowing mechanism 35 and the drying mechanism 37 as supplying means so that the fluids are jetted in the container 1. In this case, the control unit controls the movement mechanism 38 or the mechanisms (33, 35 and 37) for supplying various fluids based on the detection result of the position detecting unit 44.

For example, in the cleaning step, while the nozzle 700 inserted into the container 1 in the vicinity of the end wall portion 12 from the opening 19 is moved downwards by the movement mechanism 38, the cleaning liquid at a predetermined temperature is jetted from the nozzle 700. In consequence, the whole region of the inner wall of the container 1 is cleaned to remove dirt. After cleaning, the blowing mechanism 35 is controlled to cut off passing of the cleaning liquid. In turn, while the compressed air is jetted from the nozzle 700 by the blowing mechanism 35, the nozzle 700 is moved downwards by the movement mechanism 38. In consequence, the cleaning liquid attached to the inner wall of the container 1 is scratched off and drained.

After the draining, the passing of the compressed air is cut off by the cutoff valve 105 or the like, and the hot air is then jetted from the nozzle 700 by the drying mechanism 37. In consequence, the inside of the container 1 including the inner wall of the container 1 is dried. When the nozzle 700 is extracted from the opening 19, a series of cleaning treatments by the cleaning device 30 end. Finally, when the container 1 is removed from the support mechanism 31 and a valve assembly or the like is screwed into the mouthpiece 3 of the container 1, the container 1 is mounted on, for example, a fuel cell system.

As described above, the jetting directivity of the nozzle 700 of the present embodiment is variably constituted so that any dead angle of the fluid to be jetted to the inner wall of the container 1 is not generated. Moreover, a timing to vary the jetting directivity of the nozzle is controlled based on the detection result of the position detecting unit 44. The jetting directivity of the nozzle 700 will hereinafter be described in detail.

It is to be noted that the nozzle 700 for air blowing will mainly be described hereinafter. However, detailed descriptions of the nozzle 700 for the cleaning liquid and the nozzle 700 for the hot air are omitted. Needless to say, the jetting directivity of this nozzle for air blowing may be applied to the nozzle 700 for the cleaning liquid and the nozzle 700 for the hot air.

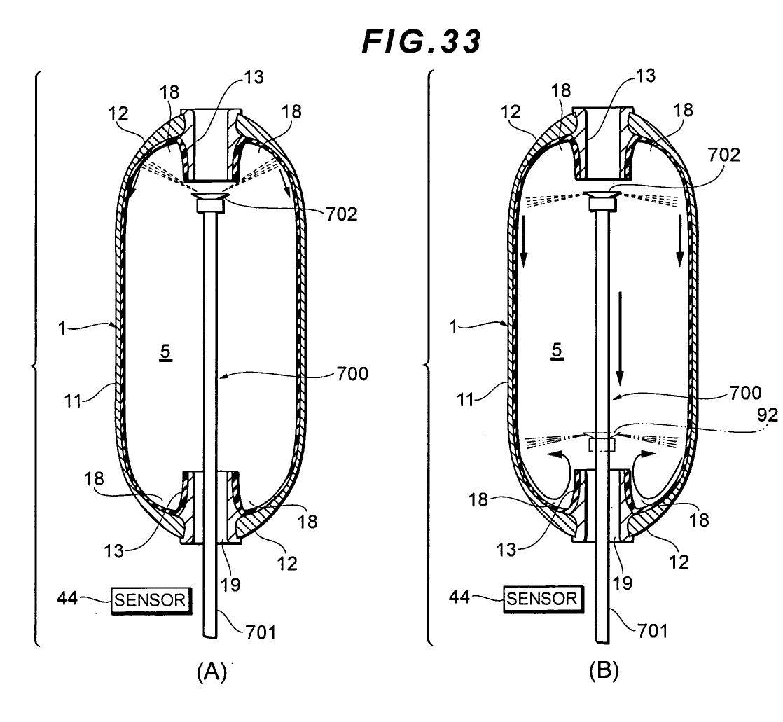

FIG. 33 is a sectional view showing the jetting directivity of the nozzle 700.

The nozzle 700 is constituted so that the jetting directivity of the compressed air can be varied in accordance with the position of the nozzle 700 in the container 1. This jetting directivity may be set so that any deal angle is not generated at the inner wall of the container 1. The jetting directivity is changed based on the detection result of, for example, a sensor as the position detecting unit 44.

As shown in FIG. 33(A), when the jetting section 702 is opposed to an upper end wall portion 12 of the container 1, the nozzle 700 has, for example, an upward jetting directivity. In consequence, since the compressed air can directly be applied to the inner wall of the end wall portion 12 and an end surface of the mouthpiece 3 as inner portions of the container 1, the cleaning liquid attached to these portions can securely be scratched off. Owing to this jetting directivity, the compressed air flows along the inner wall of the end wall portion 12 to also collide with a wall surface of the protruding portion 13. Therefore, the cleaning liquid attached to the wall surface of the protruding portion 13 can be scratched off.

It is to be noted that at a position shown in FIG. 33(A) where the jetting section 702 is opposed to the vicinity of the upper end wall portion 12 of the container 1, a distance between the end wall portion 12 and the jetting section may be, for example, 30 to 40 mm. In a state in which the jetting section 702 is stopped at this position for an only predetermined time, the compressed air may be jetted, and the predetermined time may be set to 15 to 30 seconds.

As shown in FIG. 33(B), in a case where the jetting section 702 is opposed to a trunk portion 11, the nozzle 700 has, for example, a jetting directivity to a lateral direction (a horizontal direction). It is preferable that this jetting directivity is slightly downward from the lateral direction so as to scratch off the cleaning liquid attached to the inner wall of the trunk portion 11 downwards. Since the compressed air can directly be applied to the inner wall of the trunk portion 11 owing to this conical jetting directivity, the cleaning liquid attached to this wall can securely be scratched off. It is to be noted that while the jetting section 702 having the jetting directivity shown in FIG. 33(B) is moved downwards at a predetermined speed, the compressed air may be jetted, and a predetermined speed may be, for example, 300 to 500 mm/min.

Furthermore, as shown by a two-dot chain line in FIG. 33(B), in a case where the jetting section 702 is opposed to a lower end wall portion 12 of the jetting section 702, the nozzle 700 may have the same jetting directivity as that in a case where the nozzle is opposed to the trunk portion 11. Owing to this jetting directivity, the compressed air flows along the lower end wall portion 12 from a lower portion of the trunk portion 11 to collide with the wall surface of the protruding portion 13. Therefore, since the turbulent compressed air is present in a space 18, the cleaning liquid attached to the inner wall of the lower end wall portion 12 can be scratched off. Here, a position where the jetting section 702 is opposed to the lower end wall portion 12 of the container 1 may be a position where a distance from the end wall portion 12 is 100 mm. In a state in which the jetting section 702 is stopped for a predetermined time at this time, the compressed air may be jetted, and the predetermined time may be, for example, 30 seconds.

It is to be noted that, even in a case where the jetting section 702 is opposed to the lower end wall portion 12 of the container 1, such a jetting directivity that the compressed air directly strikes on the inner wall of this end wall portion 12 may be set to the nozzle 700. An example will hereinafter be described in which the jetting directivity of the nozzle 700 remains to be the same between the lower end wall portion 12 and the trunk portion 11.

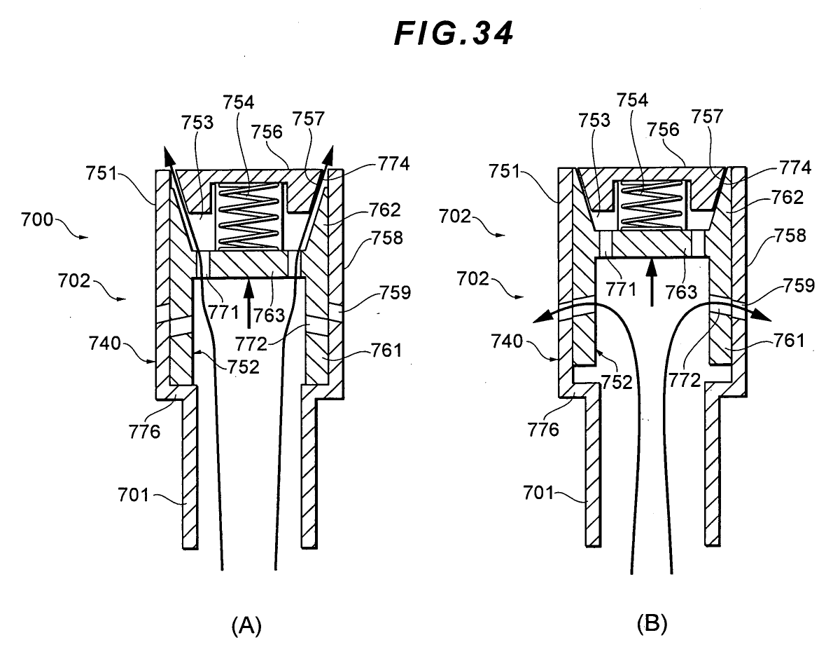

FIG. 34 is a schematic sectional view of the jetting section 702 of the nozzle 700, and is a diagram showing an example in which the jetting directivity of the nozzle 700 shown in FIG. 33 is changed.

In the jetting section 702, switching means 740 is incorporated as changing means for changing the jetting directivity, and the switching means 740 switches the jetting directivity in accordance with a supply pressure of the compressed air. The switching means 740 includes a housing 751 connected to the pipe 701, a piston 752 slidably stored in the housing 751, and a spring 754 interposed in a space 753 between a tip end side of the housing 751 and a tip end surface of the piston 752. The housing 751, the piston 752 and the spring 754 are arranged concentrically with the axis of the container 1.

A tip end surface 756 of the housing 751 is provided with an annular first jetting port 757 which is concentric with the axis of the container 1. A peripheral surface 758 of a tip end portion of the housing 751 is provided with an annular second jetting port 759 over a peripheral direction of the peripheral surface 758.

The first jetting port 757 opens upwards, and has an upward jetting directivity shown in FIG. 33(A). The second jetting port 759 opens obliquely downwards, and has a slightly downward jetting directivity from the horizontal direction as shown in FIG. 33(B). It is to be noted that the first and second jetting ports 757, 759 are formed to be annular, but the ports may be formed of a plurality of jetting ports scattered in the peripheral direction, respectively.

The piston 752 includes an cylindrical peripheral wall portion 761 which slides on an inner wall of the housing 751, a cylindrical inverted tapered portion 762 arranged at a tip end side of the peripheral wall portion 761, and a bottom wall portion 763 arranged internally from the peripheral wall portion 761 so as to close one cylindrical end of the peripheral wall portion 761. A force of the spring 754 which urges the piston 752 downwards is applied to an end surface (a tip end surface) of the bottom wall portion 763 on a surface side, and a pressure of the compressed air is applied to an end surface of the bottom wall portion 763 on a back side. Therefore, the piston 752 moves up and down in the housing 751 based on a balance between the urging force of the spring 754 and the supply pressure of the compressed air.

The bottom wall portion 763 is provided with an annular first communication port 771 so as to surround an abutment portion of the spring 754, and the first communication port 771 allows the space 753 leading to the first jetting port 757 to communicate with the inside of the pipe 701. The peripheral wall portion 761 is provided with a second communication port 772 which selectively communicate with the second jetting port 759. The second communication port 772 is formed which corresponds to the second jetting port 759, and opens obliquely downwards. It is constituted that the inverted tapered portion 762 can be matched with a tapered portion 774 formed at a tip end portion of the housing 751 and tapered downwards.

As shown in FIG. 34(B), when the supply pressure of the compressed air increases and becomes larger than the urging force of the spring 754, the piston 752 moves upwards against the urging force of the spring 754. The inverted tapered portion 762 is then matched with the tapered portion 774 to close the first jetting port 757. At this time, the second jetting port 759 is matched with the second communication port 772 to communicate with the second communication port, and the jetting section 702 conically jets the compressed air from the second jetting port 759. It is to be noted that at this time, the inverted tapered portion 762 fits between the tapered portion 774 and a tip end peripheral wall of the housing 751, and an upper movement end position of the piston 752 is regulated.

On the other hand, as shown in FIG. 34(A), when the supply pressure of the compressed air decreases and becomes smaller than the urging force of the spring 754, the piston 752 moves downwards owing to the urging force of the spring 754. The inverted tapered portion 762 then comes away from the tapered portion 774 to open the first jetting port 757. In consequence, since the compressed air is introduced from the first communication port 771 to the first jetting port 757 through the space 753, the jetting section 702 jets the compressed air upwards from the first jetting port 757. At this time, a position of the second communication port 772 deviates from the second jetting port 759 in the axial direction, and the second jetting port 759 is closed by the peripheral wall portion 761. It is to be noted that at this time, the lower end portion of the peripheral wall portion 761 abuts on a bottom portion 776 of the housing 751, and a lower movement end position of the piston 752 is regulated.

The switching means 740 constituted as described above switches the jetting port which jets the compressed air to the first jetting port 757 or the second jetting port 759 in accordance with the supply pressure of the compressed air. When the jetting port is switched to this jetting port 757 or 759, the jetting directivity of the jetting section 702 is switched. In this case, the supply pressure of the compressed air can be controlled by controlling the blowing mechanism 35 with the control unit 40.

Specifically, the number of rotations of the compressor 101 of the blowing mechanism 35 is controlled to control the supply pressure of the compressed air. This will be described in relation to the position detecting unit 44. In a case where it is detected by the position detecting unit 44 that the jetting section 702 is opposed to the vicinity of upper end wall portion 12 (FIG. 33(A)), the control unit 40 reduces the number of the rotations of the compressor 101 so that the supply pressure of the compressed air is smaller than the urging force of the spring 754. In consequence, it is set that the compressed air can be jetted from the first jetting port 757.

On the other hand, in a case where it is detected by the position detecting unit 44 that the jetting section 702 is opposed to the trunk portion 11 or the lower end wall portion 12 (FIG. 33(B)), the control unit 40 increases the number of the rotations of the compressor 101 so that the pressure of the compressed air is larger than the urging force of the spring 754. In consequence, it is set that the compressed air can be jetted from the second jetting port 759.

As described above, according to the cleaning device 30 of the present embodiment, since the supply pressure of the compressed air is switched in consideration of the position of the jetting section 702 in the container 1, a blowing direction of the compressed air jetted from the nozzle 700 can be switched. In consequence, without generating any deal angle in the container 1 including the upper and lower end wall portions 12, 12, the trunk portion 11 and the protruding portions 13 of the container 1, the inside of the container 1 can evenly be drained by the nozzle 700. Therefore, draining fluctuations of the container 1 can be suppressed. This also has a significance that two or more nozzles 700 having different jetting directivities do not have to be prepared.

It is to be noted that the supply pressure can be switched not only in accordance with the detection result of the position detecting unit 44 but also by management with a timer. For example, after a predetermined time (e.g., 15 to 30 seconds) from start of the driving of the compressor 101, the number of the rotations of the compressor 101 may be increased to switch the supply pressure of the compressed air.

### Eleventh Embodiment

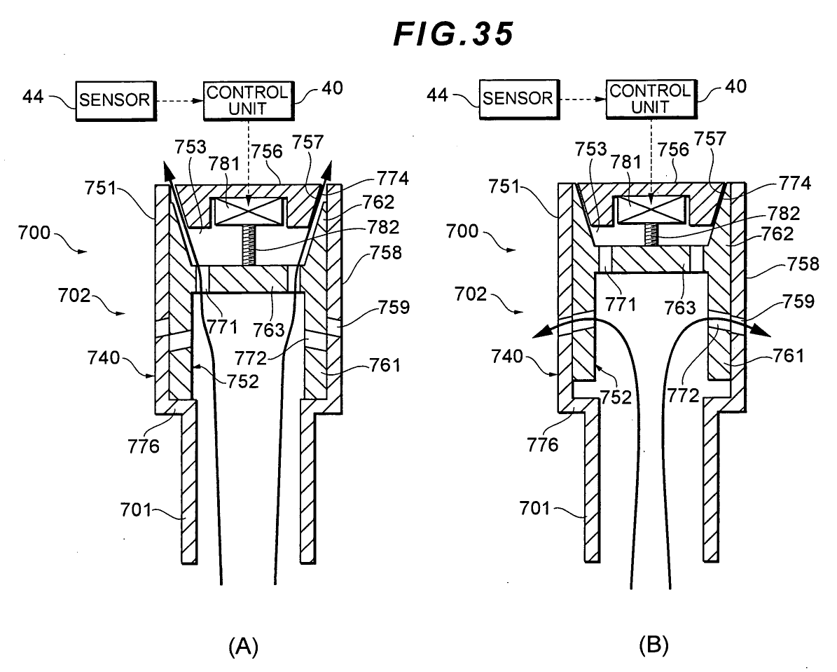

Next, different respects of a nozzle 700 according to an eleventh embodiment will mainly be described with reference to FIG. 35. The embodiment is different from the tenth embodiment in that a jetting directivity of a jetting section 702 is changed by electric driving and that, in accordance with this change, a constitution of switching means 740 as changing means is partially changed.

In the switching means 740, a space 753 is not provided with the spring 754 of the tenth embodiment. Instead, the switching means 740 includes an actuator 781 for changing the jetting directivity and a power transmitting section 782 which connects an output portion of the actuator 781 to a bottom wall portion 763 of a piston 752. The actuator 781 and the power transmitting section 782 are arranged in the space 753. It is to be noted that another constitution of the switching means 740 is the same as that of the tenth embodiment.

The actuator 781 can be constituted of a solenoid, a motor, an air cylinder or the like, and moves the piston 752 upwards and downwards via the power transmitting section 782. The actuator 781 is connected to a control unit 40. The control unit 40 controls the actuator 781 based on a detection result of a position detecting unit 44, and an amount of the piston 752 to be operated by the actuator 781 is set.

When the actuator 781 is controlled to move the piston 752 upwards and downwards, the jetting port which jets compressed air can be switched to either a first jetting port 757 or a second jetting port 759. For example, as shown in FIG. 35(A), when the amount of the piston 752 to be operated downwards is set to be large, the jetting port is switched to the first jetting port 757. On the other hand, as shown in FIG. 35(B), when the amount of the piston 752 to be operated upwards is set to be large, the jetting port is switched to the second jetting port 759. The jetting directivity of the jetting section 702 is switched in this manner.

According to the present embodiment, even if a supply pressure of the compressed air is not controlled, the actuator 781 can be controlled so as to switch a blowing direction of the compressed air to be jetted from the nozzle 700. Therefore, the inside of a container 1 can evenly be drained even with the nozzle 700 of the present embodiment.

### Twelfth Embodiment

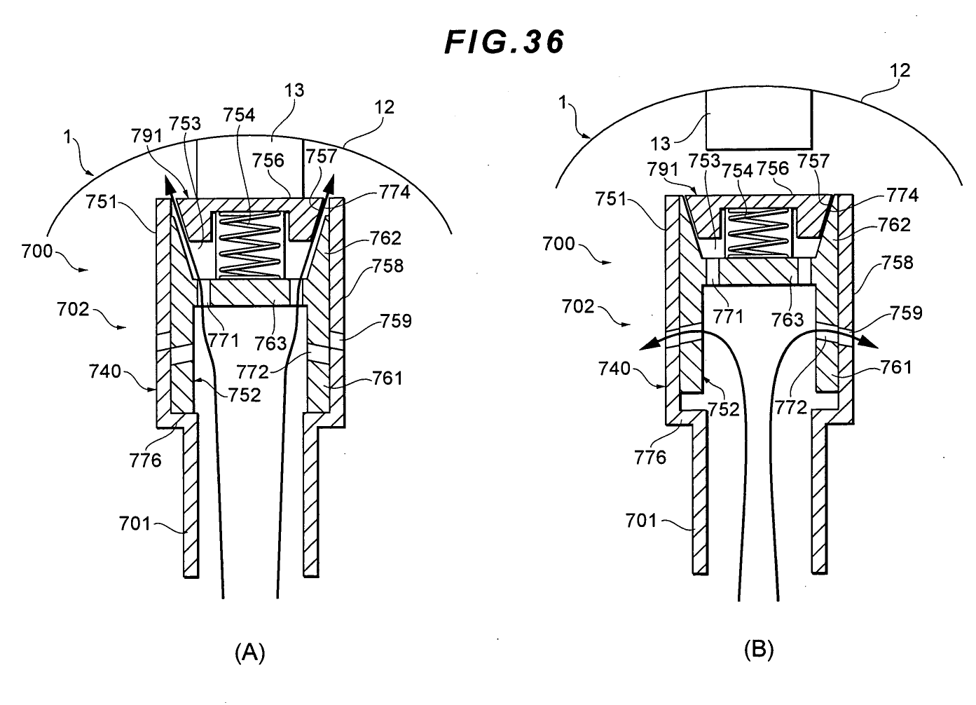

Next, different respects of a nozzle 700 according to a twelfth embodiment will mainly be described with reference to FIG. 36. The embodiment is different from the tenth embodiment in that a jetting directivity of a jetting section 702 is changed in a mechanically structural manner and that, in accordance with this change, a constitution of switching means 740 as changing means is partially changed.

The switching means 740 has a housing 751, a piston 752 and a spring 754 in the same manner as described above, but the spring 754 is disposed in a space 753 between the piston 752 and a second piston 791. The second piston 791 constitutes changing means of the present invention together with the switching means 740, and is incorporated together with the switching means 740 in the jetting section 702.

The second piston 791 is a member having a tip end surface 756 and a tapered portion 774 described in the first embodiment, and defines a first jetting port 757 between the second piston and a tip end portion of the housing 751. The second piston 791 functions as a contact portion which can come in contact with an upper end wall portion 12 of a container 1, and the jetting directivity is changed in accordance with a contact relation between the second piston 791 and the end wall portion 12.

For example, as shown in FIG. 36(B), when the second piston 791 comes away from the end wall portion 12, the piston 752 is pulled toward the second piston 791 by the spring 754. In consequence, an inverted tapered portion 762 is matched with the tapered portion 774 to close the first jetting port 757, and compressed air is jetted from a second jetting port 759. At this time, movement of the piston 752 with respect to the housing 751 is regulated by a lock mechanism (not shown) disposed between the piston 752 and the housing 751.

On the other hand, as shown in FIG. 36(A), when the second piston 791 comes in contact with the end wall portion 12, the second jetting port 759 is closed by the piston 752, and the compressed air is jetted from the opened first jetting port 757. This jetting directivity can be switched as follows.

For example, the jetting section 702 is moved upwards from the state shown in FIG. 36(B) to bring the second piston 791 into contact with a protruding portion 13. The jetting section 702 is moved upwards from this contact state so as to press the piston 752 downwards via the second piston 791 and the spring 754 to cancel the lock mechanism (not shown). Subsequently, the piston 752 is pressed downwards so as to further move the jetting section 702 upwards. When the piston 752 abuts on a bottom portion 776 of the housing 751, the movement of the piston 752 with respect to the housing 751 is regulated by another lock mechanism (not shown). In consequence, the state shown in FIG. 36(A) is obtained. It is to be noted that the jetting section 702 can be moved upwards and downwards by a movement mechanism 38 described above.

According to the present embodiment, even if a supply pressure of the compressed air or an actuator is not controlled, a predetermined mechanical structure can simply be incorporated in the nozzle 700 to switch a blowing direction of the compressed air to be jetted from the nozzle 700. Therefore, even according to the nozzle 700 of the present embodiment, the inside of the container 1 can evenly be drained.

### Thirteenth Embodiment

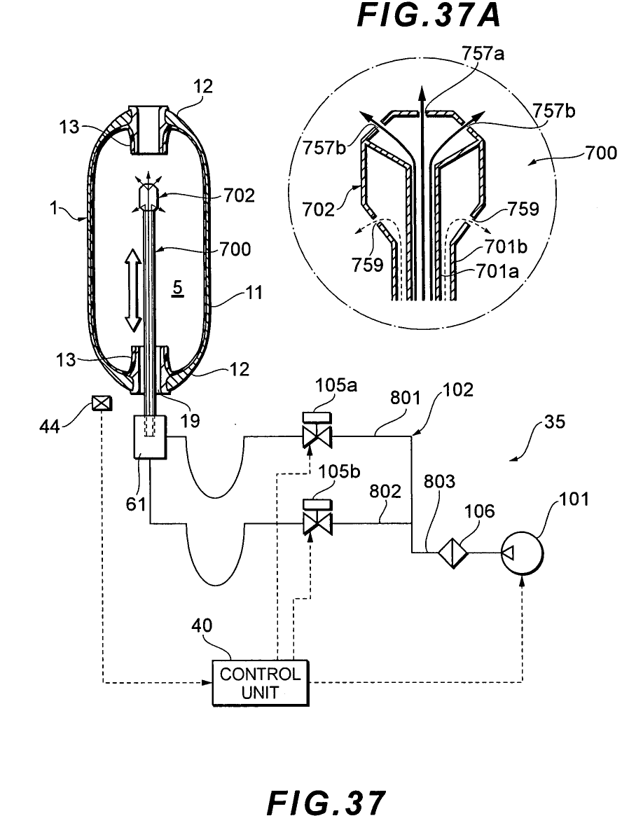

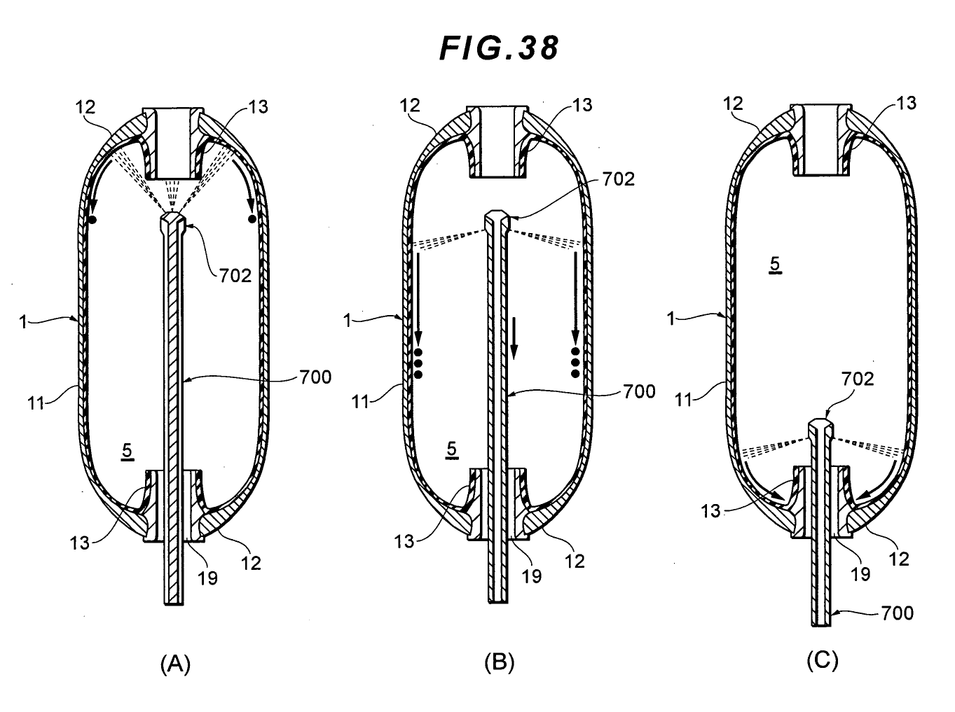

Next, different respects of a cleaning device 30 according to a thirteenth embodiment will mainly be described with reference to FIGS. 37 and 38. Main different respects from the tenth embodiment lie in that a nozzle 700 is formed into a double tube structure to impart a variable jetting directivity to the nozzle 700 and that, in accordance with this structure, a blowing mechanism 35 is partially changed. It is to be noted that in FIG. 37, a support mechanism 31, a cleaning mechanism 33, a drying mechanism 37 and a movement mechanism 38 shown in FIG. 32 are omitted.

A double tube of the nozzle 700 consisted of an inner pipe portion 701a forming an inner channel and an outer pipe portion 701b forming an outer channel. The inner pipe portion 701a and the outer pipe portion 701b are made of a hard material, and form mutually independent channels. The inner pipe portion 701a and the outer pipe portion 701b are concentrically arranged along an axis of a container 1. The inner pipe portion 701a extends longer than the outer pipe portion 701b. The inner pipe portion 701a and the outer pipe portion 701b are provided with a jetting section 702 disposed at a terminal end portion in a flow direction of compressed air.

The jetting section 702 is provided with first jetting ports 757a, 757b which communicate with the inner pipe portion 701a, and second jetting ports 759 which communicate with the outer pipe portion 701b. The one jetting port 757a of the first jetting ports opens just above at an upper portion of the jetting section 702, and has a jetting directivity capable of jetting the compressed air just above. The other jetting port 757b of the first jetting ports opens obliquely upwards in the upper portion of the jetting section 702 so as to surround the jetting port 757a, and has a jetting directivity capable of jetting the compressed air obliquely upwards.

According to such a jetting directivity, as shown in FIG. 38(A), the jetting port 757a jets the compressed air toward an upper end wall portion 12 of the container 1, more precisely toward end surfaces of a mouthpiece 3 and a protruding portion 13. As shown in FIG. 38(A), the jetting port 757b jets the compressed air toward the upper end wall portion 12 of the container 1, more precisely toward a peripheral surface of the protruding portion 13 and the end wall portion 12 provided in the vicinity of this peripheral surface.

It is to be noted that the jetting port 757a may include one opening or a plurality of openings. The jetting port 757b may be formed into one annular opening centering on the axis of the container 1, or may be formed of a plurality of openings scattered around the center.

Positions of the second jetting ports 759 deviate from the first jetting ports 757a, 757b in an axial direction of the container 1. Moreover, the second jetting ports have jetting directivities different from those of the first jetting ports 757a, 757b. The second jetting ports 759 open obliquely downwards in a lower portion of the jetting section 702, and have a jetting directivity capable of jetting the compressed air slightly below a horizontal direction. According to this conical jetting directivity, as shown in FIG. 38(B), the second jetting ports 759 jet the compressed air toward a trunk portion 11 of the container 1 so as to scratch off a cleaning liquid downwards.

It is constituted that the blowing mechanism 35 corresponds to the nozzle 700 having the double tube structure. Specifically, a blowing hose 102 of the blowing mechanism 35 includes a first hose portion 801 having one end which communicates with the inner pipe portion 701a, a second hose portion 802 which communicates with the outer pipe portion 701b, and a common hose portion 803 connected to a combined portion between the other end of the first hose portion 801 and the other end of the second hose portion 802.

A filter 106 is interposed halfway along the common hose portion 803, and a start end of the common hose portion 803 is connected to a compressor 101. The first hose portion 801 and the second hose portion 802 communicate with the inner pipe portion 701a and the outer pipe portion 701b at a support base 61, respectively. The first hose portion 801 and the second hose portion 802 are provided with electromagnetic cutoff valves 105a, 105b, respectively.

The two cutoff valves 105a, 105b are connected to a control unit 40. When the two cutoff valves 105a, 105b are switched and controlled, a channel of the compressed air to be introduced into the nozzle 700 is switched, and the jetting directivity of the nozzle 700 is changed. That is, the two cutoff valves 105a, 105b and the control unit 40 constitute switching means for switching two channels (the inner pipe portion 701a and the outer pipe portion 701b).

A series of operations of the blowing mechanism 35 will briefly be described.

First, the nozzle 700 is inserted into the container 1 via an opening 19, and the jetting section 702 is opposed to the vicinity of the upper end wall portion 12 on an inner side. A distance between the jetting section 702 and the end wall portion 12 may be set to, for example, 30 to 40 mm as described in the tenth embodiment. Here, the compressor 101 is driven. Moreover, the only cutoff valve 105a on the side of the first hose portion 801 is opened to jet the compressed air from the first jetting ports 757a, 757b, for example, for about 15 to 30 seconds (see FIG. 38(A)).

Subsequently, the cutoff valve 105a is closed. Moreover, the cutoff valve 105b on the side of the second hose portion 802 is opened to jet the compressed air from the second jetting port 759. At this time, the nozzle 700 is moved downwards at a speed of, for example, about 300 to 500 mm/min, and the trunk portion 11 is drained along the longitudinal direction (see FIG. 38(B)).

Moreover, when the jetting section 702 reaches a position about 100 mm above a lower end wall portion 12, the movement of the jetting section 702 is stopped to successively jet the compressed air from the second jetting port 759 for about 30 seconds (see FIG. 38(C)). Finally, when the whole region of the inner wall of the container 1 ends, the cutoff valve 105b is closed. Moreover, the driving of the compressor 101 is stopped to shift to the next drying step.

As described above, according to the present embodiment, when the channel of the compressed air to be supplied is switched by the two cutoff valves 105a, 105b, a blowing direction of the compressed air to be jetted from the nozzle 700 can be switched. Therefore, even according to the nozzle 700 of the present embodiment, the inside of the container 1 can evenly be drained.

It is to be noted that the two cutoff valves 105a, 105b may be switched based on a detection result of a position detecting unit 44 or with a timer. In a case where the timer is used, after opening, for example, the cutoff valve 105a, for example, for about 15 to 30 seconds, this valve may be closed to open the cutoff valve 105b.

It is to be noted that, instead of the constitution provided with the two cutoff valves 105a, 105b, for example, an electromagnetic three-way valve (a switching valve) may be disposed at the combined portion between the first hose portion 801 and the second hose portion 802, and the channel of the compressed air to be supplied may be switched by switching control of the three-way valve. The nozzle 700 has the double tube structure. However, needless to say, the nozzle may be provided with a multiple tube structure such as a triple tube structure. In consequence, more jetting ports having different jetting directivities can be provided. Furthermore, such a structure of the nozzle 700 and the constitution of the blowing mechanism 35 may similarly be applied to the cleaning mechanism 33 and the drying mechanism 37, but detailed description thereof is omitted herein.

### Fourteenth Embodiment

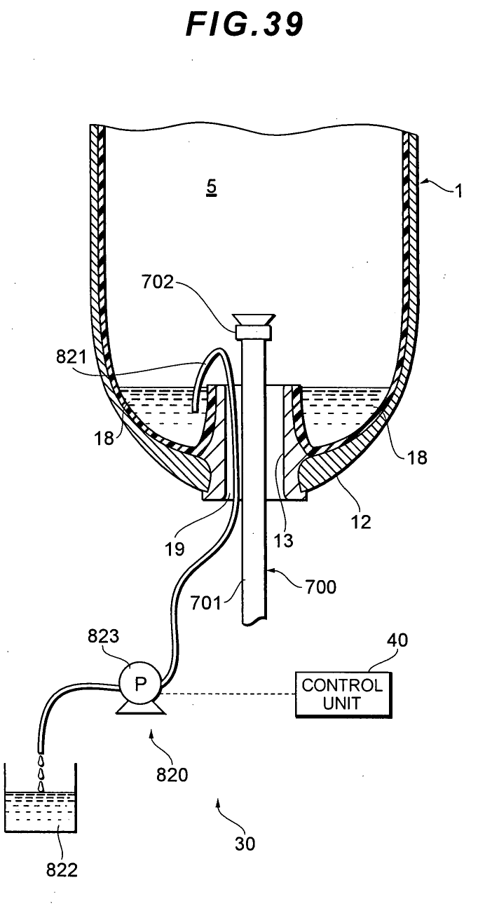

Next, different respects of a cleaning device 30 according to a fourteenth embodiment will mainly be described with reference to FIG. 39. The embodiment is different from the tenth to thirteenth embodiments in that the cleaning device 30 is provided with a suction mechanism 820. The suction mechanism 820 can be applied to all of the tenth to thirteenth embodiments, but an example in which the mechanism is applied to the tenth embodiment will be described herein.

As described above, since a container 1 is provided with a protruding portion 13, a part of a cleaning liquid jetted in a cleaning step naturally flows down from an opening 19 of the container 1 without being discharged, and is accumulated in a space 18 provided in the vicinity of this opening 19 in some case. The suction mechanism 820 is configured to discharge this accumulated cleaning liquid.

The suction mechanism 820 includes a tube 821 for suction which extends through the opening 19 of the container 1 and whose one end is positioned in a space 18 of the container 1 described above, a drain receiving section 822 where the other end of the tube 821 for suction is positioned and a suction pump 823 interposed at the tube 821 for suction.

The suction pump 823 is connected to a control unit 40. When the suction pump 823 is driven, the cleaning liquid accumulated in the space 18 of the container 1 is sucked via the tube 821 for suction, and discharged to the drain receiving section 822. Therefore, the cleaning liquid accumulated in the space 18 can appropriately be removed by the suction mechanism 820.

Here, a timing to drive the suction pump 823 in a series of treatments may be set to a time during the cleaning step when the cleaning liquid is jetted from the nozzle 700, a time after the cleaning step when feeding of the cleaning liquid to the nozzle 700 is stopped, a time during a draining step when compressed air is jetted from the nozzle 700 or a time after the draining step when feeding of the compressed air to the nozzle 700 is stopped.

### [Modification]

Unlike the above tenth to fourteenth embodiment, a position of a jetting section 702 of a nozzle 700 may be changed by changing means in order to change a jetting directivity of the nozzle 700. That is, the changing means for externally operating the jetting section 702 in a container 1 may be disposed, and this changing means may rotates, for example, the jetting section 702 to change a position of a jetting port with respect to an inner wall of the container 1 from an upper direction (a vertical direction) to a lateral direction (a horizontal direction).

Moreover, in the tenth to fourteenth embodiments, the container 1 made of a resin is a target. However, when the container 1 or the like is made of steel, the container can be cleaned and dried using a steam at a comparatively high temperature. Needless to say, when a cleaning method is used as in the tenth to fourteenth embodiments, the container 1 made of the resin can appropriately be cleaned without using any steam. If a temperature of compressed air as a fluid for blowing can be set to a predetermined temperature at which the container 1 is also dried, a drying time using a fluid for drying can be reduced, or any fluid for drying does not have to be used.

### INDUSTRIAL APPLICABILITY

A container 1 cleaned by a cleaning device 30 and a cleaning method according to the present invention described above is preferable for use in a vehicle or the like on which a fuel cell system has been mounted. The container 1 of the present invention may preferably be applied to a transport vehicle other than a car, for example, an airplane, a ship or the like in which a fluid stored in the container 1 is used as a power source. When air is used as a cleaning fluid, it is preferably possible to remove residuals attached to an inner surface of a developer storage container or a powder container in which another powder material is stored.

1. A cleaning device for a container comprising:
a jetting member which jets a fluid in the container;
a movement unit which relatively moves the jetting member with respect to the container so that the jetting member is inserted into the container from a mouth part of the container; and
a switching unit which switches the jetting member from one function to another functions
wherein the container is a tank in which a high-pressure combustible gas is stored.

2.-8. (canceled)

9. A cleaning device for a container in which the container including a protruding portion provided at a mouth part of the container and protruding into the container is cleaned, comprising:
a support unit to support the container in a state in which the mouth part is opened downwards and in which an axial direction of the container is tilted from a vertical direction;
a rotation unit which rotates the container supported by the support unit around an axis of the container; and
a jetting member which is inserted into the container from the mouth part and which jets a fluid in the container in synchronization with the rotation unit.

10. The cleaning device for the container according to claim 9, further comprising:
a movement unit which relatively moves the jetting member along the axial direction of the container with respect to the container supported by the support unit.

11. The cleaning device for the container according to claim 9, wherein the jetting member includes at least one of a nozzle for a cleaning fluid which jets the cleaning fluid,
a nozzle for removing the cleaning fluid which jets a fluid to remove the cleaning fluid from an inner wall of the container, and
a nozzle for drying which jets hot air to dry the inner wall of the container.

12. The cleaning device for the container according to claim 11, further comprising:
a switching unit which switches the nozzle for the cleaning fluid, the nozzle for removing the cleaning fluid and the nozzle for drying in order during a series of treatments of the container.

13.-22. (canceled)

23. A cleaning method for a container including a protruding portion provided at a mouth part of the container, the protruding portion protruding into the container, the cleaning method comprising:
a rotation step of rotating the container in an axial direction of the container in a tilt state in which the mouth part is opened downwards; and
a jetting step of jetting a fluid from a jetting member inserted into the container during the rotation step.

24.-25. (canceled)

26. A tank which is cleaned using the cleaning method for the container according to claim 23.

27.-36. (canceled)

37. A cleaning device for a container comprising:
a jetting member inserted into the container from a mouth part of the container and configured to jet a fluid in the container in accordance with a shape of the inside of the container; and
changing device to change a jetting directivity of the fluid in accordance with a position of the jetting member in an axial direction of the container.

38. The cleaning device for the container according to claim 37, wherein the jetting member has at least two jetting ports having different jetting directivities, and
the changing device has a switching device to switch the at least two jetting ports to switch the jetting directivity.

39. The cleaning device for the container according to claim 38, wherein the switching device has an actuator which switches the at least two jetting ports.

40.-41. (canceled)

42. The cleaning device for the container according to claim 38, further comprising:
supplying device to supply the fluid to the jetting member,
wherein the switching device is incorporated in the jetting member and switches the at least two jetting ports in accordance with a pressure of the fluid to be supplied by the supplying device.

43.-44. (canceled)

45. The cleaning device for the container according to claim 37, wherein the jetting member has at least two jetting ports having different jetting directivities, and
at least two channels which supply the fluids to the at least two jetting ports, respectively, independently of each other,
and the changing has a switching device to switch the at least two channels in accordance with a position of the jetting member in the axial direction of the container.

46.-47. (canceled)

48. The cleaning device for the container according to claim 37, wherein the changing device changes the jetting directivity so that the jetting member has different jetting directivities in a case where the jetting member is positioned close to at least one of opposite end portions of the container and a case where the jetting member is positioned close to a trunk portion of the container.

49. The cleaning device for the container according to claim 48, further comprising:
a support device to set the container in a state in which the mouth part of the container is directed downwards,
wherein the changing device changes the jetting directivity to an upward directivity in a case where the jetting member is opposed to a position of an upper end portion of the container, and the changing device changes the jetting directivity to a directivity in a horizontal direction or slightly below the horizontal direction in a case where the jetting member is opposed to a position of the trunk portion.

50.-57. (canceled)

58. A cleaning method for a container, the method using a treatment member having an operating section for operating a predetermined treatment of an inner surface of the container, comprising:
an insertion step of inserting the treatment member provided with the folded operating section into the container from a mouth part of the container;
an expansion step of expanding the operating section in the container after the insertion step; and
a treatment step of allowing the operating section to perform the predetermined treatment of the inner surface of the container after the expansion step.

59. (canceled)

60. The cleaning method for the container according to claim 58, wherein the predetermined treatment is at least one of a cleaning treatment of jetting a fluid for cleaning in the container,
a blowing treatment of jetting a fluid for blowing in the container,
a drying treatment of jetting a fluid for drying in the container,
a wiping treatment of wiping the inner surface of the container,
a permeation inhibiting treatment of spraying a gas permeation inhibitor to the inner surface of the container, and
a suction treatment of sucking residuals from the container.

61. (canceled)

62. The cleaning method for the container according to claim 60, wherein the treatment step simultaneously performs the blowing treatment and the suction treatment.

63. A cleaning method for a container, the method jetting a fluid to clean the inside of the container, comprising:
an insertion step of inserting a jetting member into the container from a mouth part of the container; and
a jetting step of jetting the fluid from the jetting member in the container after the insertion step,
the jetting step being performed while changing a jetting directivity of the fluid in accordance with a position of the jetting member in an axial direction of the container.

64. (canceled)
